(19) United States
(12) Patent Application Publication
(10) Pub. No.: US 2007/0247711 A1
(43) Pub. Date: Oct. 25, 2007

(54) Method of Producing Optical Film and Anti-Reflection Film Optical Film, Anti-Reflection Film, Polarizing Plate and Image Display Device Comprising Same

(75) Inventors: Shigeaki Ohtani, Minami-Ashigara-shi (JP); Yuuichi Fukushige, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/659,709

(22) PCT Filed: Aug. 30, 2005
(86) PCT No.: PCT/JP05/16193

§ 371 Date: Feb. 8, 2007

(30) Foreign Application Priority Data
Sep. 6, 2004 (JP) 2004-258475

(51) Int. Cl. G02B 1/11; B05D 7/24; G02B 5/30

(52) U.S. Cl. 359/485; 427/487; 428/409

(57) ABSTRACT

A method of producing an optical film comprising at least two ionizing radiation-curing layers on a transparent substrate, the method comprising: Step 1 of irradiating a layer A, which comprises two or more kinds of polymerization initiators having different absorption ends at a longer wavelength side in wavelength range of sensitivity to which they are sensitive, with an ionizing radiation having a wavelength to which at least one kind (a) of the polymerization initiators is not substantially sensitive and at least one kind (b) of the polymerization initiators is sensitive; and Step 2 of spreading a coating solution for layer B comprising at least one polymerization initiator (c) over the layer A after Step A and then irradiating the coating solution for layer B with an ionizing radiation having a wavelength to which the polymerization initiators (a) and (c) are sensitive.

### TECHNICAL FIELD

The present invention relates to an optical film excellent in scratch resistance and more particularly to an anti-reflection film having a low reflectance and an excellent scratch resistance and a production method of providing same at reduced cost. More particularly, the invention relates to an optical film to be used in an image display device such as liquid crystal display device and a method of producing same.

### BACKGROUND ART

A display device such as cathode ray tube display device (CRT), plasma display (PDP), electroluminescence display (ELD) and liquid crystal device (LCD) comprises various functional optical films such as protective film for polarizing plate, retardation plate, reflective plate, viewing angle widening film, optical compensation film, anti-glare film, brightness enhancing film, color correction film, color separation film, ultraviolet or infrared cut film, antistatic film and anti-reflection film. Among these optical films, the anti-reflection film is disposed on the outermost surface of the display to reduce the reflectance using a principle of optical interference for the purpose of preventing the contrast drop or reflection of image due to reflection of external light in the display device. It is thus very likely that the anti-reflection film can be scratched. Therefore, it has been an important assignment to provide the anti-reflection film with an excellent scratch resistance.

Such an anti-reflection film can be prepared by forming a low refractive layer having a proper thickness on the outermost layer, optionally a high refractive layer, a middle refractive layer, a hard coat layer, etc. between the low refractive layer and the support (substrate). In order to realize a low refractive index, the low refractive layer is preferably made of a material having as low a refractive index as possible. The anti-reflection film is also required to have a high scratch resistance because it is disposed on the outermost layer of the display. In order to realize a high scratch resistance for thin films having a thickness of about 100 nm, these thin films need to have a sufficient strength itself and a sufficient adhesion to the underlying layer.

In order to reduce the refractive index of a material, the material may comprise fluorine atoms incorporated therein or may have a reduced density (voids). However, all these approaches are disadvantageous in that the resulting film exhibits an impaired strength and adhesion and a reduced scratch resistance. Thus, it has been a difficult assignment to attain both high refractive index and high scratch resistance.

JP-A-11-189621, JP-A-11-228631 and JP-A-2000-313709 disclose an approach which comprises incorporating a polysiloxane structure in a fluorine-containing polymer to enhance the friction coefficient of the surface of the film and hence the scratch resistance. Such an approach is somewhat effective for the improvement of scratch resistance but leaves something to be desired in the effect of providing a film essentially short of strength and interface adhesion with a sufficient scratch resistance when used alone.

On the other hand, JP-A-2002-156508 discloses that when a photosetting resin is cured in a low oxygen concentration, a cured film having a raised hardness can be obtained. However, since the upper limit of nitrogen concentration at which the anti-reflection film can be efficiently produced in web form is limited, a satisfactory hardness cannot be attained.

Further, JP-A-11-268240, JP-A-60-90762, JP-A-59-112870, JP-A-4-301456, JP-A-3-67697 and JP-A-2003-300215 disclose a detailed approach for replacement with nitrogen. However, these approaches require the use of a large amount of nitrogen to reduce the oxygen concentration to an extent such that such a thin layer as low refractive layer is sufficiently cured, adding to cost to disadvantage.

Moreover, JP-B-7-51641 discloses a method which comprises irradiating a web wound on a hot roll with ionizing radiation. This method, too, leaves something to be desired in the effect of sufficiently curing such a special thin film as low refractive layer.

### DISCLOSURE OF THE INVENTION

An aim of the invention is to provide a functional optical film to be used in various display devices and more particularly a method of producing an anti-reflection film having an enhanced scratch resistance while attaining sufficient anti-reflection properties at reduced cost and an anti-reflection film obtained by the production method. Another aim of the invention is to provide a polarizing plate comprising the anti-reflection film and an image display device comprising same.

The inventors made extensive studies. As a result, it was found that the aforementioned aims of the invention are accomplished by a method of producing the following anti-reflection film and an anti-reflection film obtained by the method.

(1) A method of producing an optical film comprising at least two ionizing radiation-curing layers on a transparent substrate, the method comprising:

Step 1 of irradiating a layer A, which comprises two or more kinds of polymerization initiators having different absorption ends at a longer wavelength side in wavelength range of sensitivity to which they are sensitive, with an ionizing radiation having a wavelength to which at least one kind (a) of the polymerization initiators is not substantially sensitive and at least one kind (b) of the polymerization initiators is sensitive; and

Step 2 of spreading a coating solution for layer B comprising at least one polymerization initiator (c) over the layer A after Step A and then irradiating the coating solution for layer B with an ionizing radiation having a wavelength to which the polymerization initiators (a) and (c) are sensitive.

(2) The method of producing an optical film as defined in Clause (1), wherein the irradiation with ionizing radiation at Steps 1 and 2 is effected in an oxygen concentration of 3% by volume or less.

(3) The method of producing an optical film as defined in Clause (1) or (2), wherein the irradiation with ionizing radiation is effected through a wavelength cut filter in at least one of the step 1 and step 2.

(4) The method of producing an optical film as defined in any one of Clauses (1) to (3), wherein the irradiation with ionizing radiation in step 2 is effected in an oxygen concentration of 3% by volume or less at a membrane surface temperature of 60° C. or more.

(5) A method of producing an optical film as defined in any one of clauses (1) to (4), wherein the irradiation with ionizing radiation of the Step 2 is effected in an oxygen concentration of 3% by volume or less, and simultaneously or continuously, heating is performed at in an oxygen concentration of 3% by volume or less.

(6) The method of producing an optical film as defined in any one of Clauses (1) to (5), wherein there is further provided a coating step of spreading a coating solution over the surface of a web which is being continuously running while being supported on a backup roll through the slot of the forward end lip with the land of the forward end lip of the slot die being close thereto and the coating solution is spread using a coating device arranged such that the length of the land of the forward end lip of the slot die on the forward thereof in the web running direction is from not smaller than 30 μm to not greater than 100 μm and the gap between the forward end lip on the side thereof opposite the forward side and the web is from not smaller than 30 μm to 120 μm greater than the gap between the forward end lip on the forward side thereof and the web when the slot die is set at the coating position.

(7) The method of producing an optical film as defined in Clause (6), wherein the viscosity of the coating solution during spreading is 2.0 mPa·sec or less and the amount of the coating solution to be spread over the surface of the web is from 2.0 to 5.0 ml/m².

(8) The method of producing an optical film as defined in Clause (6) or (7), wherein the coating solution is spread at a rate of 25 m/min or more over the surface of a web which is being continuously running.

(9) The method of producing an optical film which is an anti-reflection film comprising at least one low refractive layer, as defined in any one of Clauses (1) to (8), wherein the layer B is one of said at least one low refractive layer.

(10) An optical film or anti-reflection film obtainable by a method defined in any one of Clauses (1) to (9).

(11) The anti-reflection film as defined in Clause (10), wherein the low refractive layer comprises a fluorine-containing polymer represented by the following general formula (1): 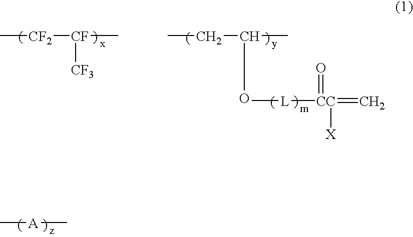
wherein L represents a C₁-C₁₀ connecting group; m represents 0 or 1; X represents a hydrogen atom or methyl group; A represents a repeating unit derived from an arbitrary vinyl monomer which may be a single component or may be composed of a plurality of components; and x, y and z each represent the molar percentage of the respective constituent component and satisfy the relationships 30≦x≦60, 5≦y≦70 and 0≦z≦65, respectively.

(12) The anti-reflection film as defined in Clause (10) or (11), wherein the low refractive layer comprises a particulate hollow silica incorporated therein.

(13) A polarizing plate comprising two protective films, wherein one of the two protective films is an anti-reflection film defined in any one of Clauses (10) to (12).

(14) An image display device comprising an anti-reflection film defined in any one of Clauses (10) to (12) or a polarizing plate defined in Clause (13) as an outermost surface of display.

### BRIEF DESCRIPTION OF THE DRAWINGS

FIG. 1 is a schematic diagram illustrating an embodiment of the coating device to be used in the invention;

FIG. 2 is a schematic diagram illustrating an embodiment of the die coater which can be preferably used in the invention;

FIG. 3A is an enlarged view of the die coater of FIG. 2;

FIG. 3B is a schematic sectional view illustrating a related art slot die;

FIG. 4 is a perspective view illustrating the slot due to be used at the coating step embodying the production method of the invention and its periphery;

FIG. 5 is a sectional view diagrammatically illustrating the relationship between the pressure reducing chamber of FIG. 4 and the web; and

FIG. 6 is another sectional view diagrammatically illustrating the relationship between the pressure reducing chamber of FIG. 4 and the web.

W denotes a web; 1 denotes a web roll; 2 denotes a winding roll; 100, 200, 300, 400 denote film-making units; 101 denotes a first coating station; 102 denotes a first drying zone; 103 denotes a first curing device; 201 denotes a second coating station; 202 denotes a second drying zone; 203 denotes a second curing device; 301 denotes a third coating station; 302 denotes a third curing device; 303 denotes a third curing device; 401 denotes a fourth coating station; 402 denotes a fourth drying zone; 403 denotes a fourth curing device; 10 denotes a coater; 11 denotes a backup roll; 13 denotes a slot die; 14 denotes a coating solution; 14a denotes a bead form; 14b denotes a coat layer; 15 denotes a pocket; 16 denotes a slot; 16a denotes a slot opening; 17 denotes a forward end lip; 18 denotes a land; 18a denotes an upstream lip land; 18b denotes a downstream lip land; I_{UP} denotes a length of upstream lip land 18a; I_{LO} denotes a length of downstream lip land 18b; LO denotes an overbite length; G_{L} denotes a gap between forward end lip 17 and web W; 30 denotes a slot die (related art); 31a denotes an upstream lip land (related art); 31b denotes a downstream lip land (related art); 32 denotes a pocket (related art); 33 denotes a slot (related art); 40 denotes a pressure reducing chamber; 40a denotes a back plate; 40b denotes a side plate; 40c denotes a screw; G_{B} denotes a gap between a back plate 40a and a web W; and G_{S} denotes a gap between a side plate 40b and a web W.

### BEST MODE FOR CARRYING OUT THE INVENTION

In the optical film according to the invention, the transparent substrate has various functional layers provided thereon. Examples of these functional layers include antistatic layer, cured resin layer (transparent hard coat layer), anti-reflection layer (composed of high refractive layer, middle refractive layer and low refractive layer), bonding-aid layer, anti-glare layer, optical compensation layer, alignment layer, and liquid crystal layer. These layers may be provided in combination.

As a representative example of the optical film produced according to the invention, an anti-reflection film comprising an anti-reflection layer (hereinafter occasionally referred to as “anti-reflection membrane”) will be described in detail hereinafter. In the present specification, in the case where the numerical values indicate physical values, properties or the like, the term “(value 1) to (value 2)” as used herein is meant to indicate “not smaller than (value 1) to not greater than (value 2)”.

<Layer Configuration of Anti-Reflection Film>

The anti-reflection film produced according to the invention comprises a hard coat layer described later provided on a transparent substrate (hereinafter occasionally referred to as “substrate film”) as necessary. A laminated anti-reflection film arranged taking into account the refractive index, film thickness, number of layers, order or layer lamination, etc. such that the reflectance decreases due to optical interference is provided on the hard coat layer. The simplest configuration of the anti-reflection layer is mere provision of only a low refractive layer on the substrate. In order to further reduce the reflectance, it is preferred that the anti-reflection layer be formed by a high refractive layer having a higher refractive index than that of the substrate and a low refractive layer having a lower refractive index than that of the substrate in combination. Examples of the layer configuration include two layers, i.e., high refractive layer and low refractive layer laminated in this order on the substrate and three layers having different refractive indexes, i.e., middle refractive layer (layer having a higher refractive index than that of the substrate or the hard coat layer and a lower refractive index than that of the high refractive layer), high refractive layer and low refractive layer laminated in this order on the substrate. Also is provided the lamination of more anti-reflection layers. Preferred among these proposals is the lamination of middle refractive layer, high refractive layer and low refractive layer on a substrate having a hard coat layer from the standpoint of durability, optical properties, cost, productivity, etc. The anti-reflection film according to the invention may have functional layers such as anti-glare layer and antistatic layer.

Preferred examples of the configuration of the anti-reflection film produced according to the invention will be given below.

Substrate film/low refractive layer;

Substrate film/anti-glare layer/low refractive layer;

Substrate film/hard coat layer/anti-glare layer/low refractive layer;

Substrate film/hard coat layer/high refractive layer/low refractive layer;

Substrate film/hard coat layer/middle refractive layer/high refractive layer/low refractive layer;

Substrate film/anti-glare layer/high refractive layer/low refractive layer;

Substrate film/anti-glare layer/middle refractive layer/high refractive layer/low refractive layer;

Substrate film/anti-static layer/hard coat layer/middle refractive layer/high refractive layer/low refractive layer;

Antistatic layer/substrate film/hard coat layer/middle refractive layer/high refractive layer/low refractive layer;

Substrate film/antistatic layer/anti-glare layer/middle refractive layer/high refractive layer/low refractive layer;

Antistatic layer/substrate film/anti-glare layer/middle refractive layer/high refractive layer/low refractive layer;

Antistatic layer/substrate film/anti-glare layer/high refractive layer/low refractive layer/high refractive layer/low refractive layer;

The anti-reflection film produced according to the invention is not specifically limited to these layer configurations so far as it can reduce its reflectance when optically interfered. The high refractive layer may be a light-diffusing layer having no anti-glare properties. The antistatic layer is preferably a layer comprising electrically-conductive polymer particles or metal oxide particles (e.g., SnO₂, ITO) incorporated therein and may be provided by spreading, atmospheric plasma treatment or the like.

<Step of Curing Layer>

The optical film according to the invention comprises at least two ionizing radiation-curing layers provided on a transparent substrate. In accordance with the method of producing the optical film of the invention, a layer A comprising two or more polymerization initiators having different absorption ends at the longer wavelength side in the wavelength range of sensitivity to which they are sensitive is cured using a process comprising:

Step 1 of irradiating the layer A with an ionizing radiation having a wavelength to which at least one (a) of the polymerization initiators is not substantially sensitive and at least one (b) of the polymerization initiators is sensitive; and

Step 2 of spreading a coating solution for layer B comprising at least one polymerization initiator (c) over the layer A after Step A and then irradiating the coating solution for layer B with an ionizing radiation having a wavelength to which the polymerization initiators (a) and (c) are sensitive.

The term “not substantially sensitive” as used herein is meant to indicate that the ratio of amount of double bonds reduced by irradiation with ionizing radiation at Steps 1 and to amount of double bonds reduced by irradiation with ionizing radiation at Steps 1 and 2 is 30% or less. This ratio is preferably 10% or less, more preferably 3% or less.

For the measurement of the amount of double bonds, an infrared absorption measurement method as described in “Kobunshi Bunseki Handobukku (Handbook of Polymer Analysis)”, compiled by Polymer Analysis Research Group, The Japan Society for Analytical Chemistry, may be employed. In some detail, a layer sample to be measured is prepared by spreading the coating solution over a polyethylene terephthalate or triacetyl cellulose, drying the coat layer, and then irradiating the coat layer with ionizing radiation under predetermined conditions. The sample is then rubbed with KBr powder. The KBr powder thus mixed with the sample is then subjected to fine mixing with the sample in a mortar. The sample is then measured for infrared absorption. As the measuring instrument there is used a Type AVATAR 360 FT-IR apparatus (produced by NIKORE Co., Ltd.). The measurement is conducted by an integrated number of 40. The ratio of height of peak at 1,720 cm⁻² attributed to ester component to height of peak at 810 cm⁻¹ attributed to double bond is then determined.

The aforementioned measurement was made on Sample (A) which had not been irradiated with ionizing radiation, Sample (B) which had been irradiated with ionizing radiation at Step 1 and Sample (C) which had been irradiated with ionizing radiation at Steps 1 and 2. The ratio of amount of double bonds reduced by irradiation with ionizing radiation at Steps 1 and 2 to amount of double bonds reduced by irradiation with ionizing radiation at Step 1 was then determined by the following numerical formula (1):
((A)−(B))/((A)−(C)) (1)

By exposing the polymerization initiator in the layer A to light during the curing of the layer B, the resulting optical film is little subject to effects such as inhibition of curing by oxygen, making it possible to cure the layer sufficiently and thus enhance the hardness and the scratch resistance.

For example, there may be used a method of curing using a process comprising Step 1 of irradiating the hard coat layer (corresponding to layer A) containing a polymerization initiator (a) sensitive to near ultraviolet rays and a polymerization initiator (b) sensitive to only ultraviolet rays and Step 2 of spreading a low refractive layer coating solution containing a polymerization initiator (c) sensitive to only ultraviolet rays over the hard coat layer and then irradiating the coat layer with ultraviolet rays.

As the polymerization initiators sensitive to different wavelengths there are preferably selected from the following compounds.

Preferred examples of the polymerization initiator sensitive to near ultraviolet range include compounds having an absorption end up to near 400 nm such as phosphine oxides, e.g., 2,4,6-trimethylbenzoyldiphenyl phosphine oxide {“DAROCUR TPO” (trade name); produced by Ciba Specialty Chemicals Co., Ltd.}, phenylenebis(2,4,6-trimethylbenzoyl)-phosphine oxide {“IRGACURE 819” (trade name); produced by Ciba Specialty Chemicals Co., Ltd.}, bis(2,6-dimethoxybenzoyl)-2,4,4-trimethyl-penthylphosphine oxide, thioxanthones, e.g., 2,4-diethylthioxanthone, 2-chlorothioxanthone and 1-chloro-4-propoxythioxantone, ketones, e.g., N-methyl acrydone, bis(dimethylaminophenyl)ketone and 2-benzyl-2-dimethylamino-1-(4-morpholinophenyl)-butane-1-one {“IRGACURE 369” (trade name); produced by Ciba Specialty Chemicals Co., Ltd.} and oximes, e.g., 1,2-octanedione-1-[4-(phenylthio)-2,2-(O-benzoyloxim). Particularly preferred among these polymerization initiators are phosphine oxides because the resulting optical film is little colored and undergoes much decoloration after irradiation.

As the polymerization initiator which is sensitive to wavelength different from that of the aforementioned polymerization initiator and can be used in combination with the aforementioned polymerization initiator there may be used a polymerization initiator having absorption mainly in the ultraviolet range. Examples of such a polymerization initiator include known polymerization initiators such as acetophenones, e.g., 2,2-dimethoxy-1 2-diphenylethane-1-one {“IRGACURE 651” (trade name): produced by Ciba Specialty Co., Ltd.}, 1-hydroxycyclohexyl-phenylketone {“IRGACURE 184” (trade name); produced by Ciba Specialty Chemicals Co., Ltd.}, 2-hydroxy-2-methyl-1-phenylpropane-1-one, benzophenone, 2-methyl-1-[4-(methylthio)phenyl]-2-morpholinopropane-1-one {“IRGACURE 907” (trade name); produced by Ciba Specialty Co., Ltd.}, benzoins, benzophenones, ketals and anthraquinones. Further, preferred examples of the polymerization initiator include active halogens such as 2-methoxyphenyl-4,6-bistrichloromethyl-s-triazine {“MP-Triazine” (trade name); produced by Sanwa Chemical Co., Ltd.}.

The amount of the polymerization initiator based on the amount of the curable composition is preferably from not smaller than 1% by mass to not greater than 10% by mass. When the amount of the polymerization initiator is not smaller than the above defined lower limit, the reaction can sufficiently proceed to attain a desired hardness. When the amount of the polymerization initiator is not greater than the upper limit, the resulting cured layer (hereinafter referred to as “film”) is little subject to disadvantages such as coloring and hardness change in the depth direction. Therefore, the polymerization initiator is preferably used in an amount falling within the above defined range.

In the case where the aforementioned polymerization initiator having absorption in near ultraviolet range and the aforementioned polymerization initiator having absorption in ultraviolet range are used in combination, the ratio of the two polymerization initiators (near ultraviolet range: ultraviolet range) is not specifically limited so far as it falls within the above defined range.

The amount of the polymerization initiator (a) contained in the layer A that absorbs ultraviolet rays (ionizing radiation) having a wavelength in which the layer B is cured is preferably as much as possible so far as there arises no problems with coloring and hardness.

The layer A is preferably subjected to Step 1 after the spreading and drying of the coating solution for layer A comprising a curable composition. As the ionizing radiation to be used in Step 1 there may be properly selected depending on the kind of the polymerization initiator and curable composition used. For example, in the case where the layer A is irradiated with light in near ultraviolet range, there can be used light obtained by filtering radiation from a lamp that mainly emits light in the wavelength range of from 400 to 480 nm {lamp having a radiation peak in the range of from 400 to 480 nm, e.g., heat cathode ray tube fluorescent lamp comprising a fluorescent material having a radiation peak in the wavelength range of from 400 to 480 nm (preferably 420 nm±20 nm)} or light from a metal halide lamp having a wide radiation wavelength distribution through a short wavelength filter so that light on the shorter wavelength side (e.g., 380 nm or less) is cut. The dose of near ultraviolet rays is preferably from 30 to 1,000 mJ/cm², more preferably from 50 to 700 mJ/cm².

As the radiation to be used in the curing of the coat layer obtained by spreading the coating solution for layer B containing a curable composition and then preferably drying the coat layer at Step 2 there may be properly selected depending on the kind of the polymerization initiator and curable composition used. The radiation to be used herein is not specifically limited so far as it has a wavelength to which the polymerization initiators (a) and (c) are sensitive. However, the irradiation with ultraviolet rays is preferably effected. The curing with ultraviolet rays is preferably effected because it allows fast polymerization, requires only compact facilities, allows selection of a variety of compound seeds and can be effected at reduced cost. In the case where ultraviolet rays are used, ultrahigh pressure mercury vapor lamp, high pressure mercury vapor lamp, low pressure mercury vapor, carbon arc, xenon arc, metal halide lamp, etc. may be used. The dose of ultraviolet rays is preferably from 30 to 1,000 mJ/cm², more preferably from 50 to 700 mJ/cm².

In the case where the optical film is an anti-reflection membrane, the low refractive layer is preferably cured at Step 2. In this case, the layer A is a layer on which the low refractive layer is provided.

The irradiation with ionizing radiation at Steps 1 and 2 is preferably effected in an oxygen concentration of 3% by volume or less.

Further, at Step 2, the spreading of the coating solution for layer B containing a curable composition, optionally followed by drying of the coat layer, is preferably followed by:

(1) continuous irradiation of the coat layer with ionizing radiation together with the conveyance of the web in an oxygen concentration of 3% by volume or less wherein the oxygen concentration during conveyance is 3% by volume or less and not smaller than the oxygen concentration during irradiation with ionizing radiation;

(2) irradiation of the coat layer with ionizing radiation in an oxygen concentration of 3% by volume or less at a film surface temperature of 60° C. or more;

(3) irradiation of the coat layer with ionizing radiation in an oxygen concentration of 3% by volume or less accompanied or followed by heating in an oxygen concentration of 3% by volume or less; or

(4) the aforementioned steps (1) to (3) in combination.

The term “(A) is followed by (B)” as used herein is meant to indicate that (A) is immediately followed by (B) without effecting any other steps in between (A) and (B). This applies also to the case where (B) is “to heat”.

When the conveyance of the web is effected in an oxygen concentration of 3% by volume or less and not smaller than the oxygen concentration during irradiation with ionizing radiation before irradiation with ionizing radiation in an oxygen concentration of 3% by volume or less as mentioned in the aforementioned paragraph (1), the oxygen concentration in the surface and interior of the coat layer can be effectively reduced, making it possible to accelerate curing to advantage. Further, when irradiation with ionizing radiation in an oxygen concentration of 3% by volume or less is accompanied or followed by heating in an atmosphere having an oxygen concentration of 3% by volume or less as mentioned in the aforementioned paragraph (3), the curing reaction initiated by ionizing radiation is accelerated by heat, making it possible to form a film excellent in physical strength and chemical resistance.

The oxygen concentration during irradiation with ionizing radiation is preferably 1% by volume or less, more preferably 0.1% by volume or less. The oxygen concentration before irradiation with ionizing radiation, particularly during conveyance, too, is preferably 1% by volume or less, more preferably 0.1% by volume or less. The oxygen concentration during heating, too, is preferably 1% by volume or less, more preferably 0.1% by volume or less. The means of reducing the oxygen concentration is preferably substitution of the atmosphere (nitrogen concentration: approx. 79% by volume; oxygen concentration: approx. 21% by volume) by other inert gas, particularly with nitrogen (nitrogen purge). The discharge of the inert gas which has been used to reduce the oxygen concentration of the irradiation zone of ionizing radiation to the previous low oxygen concentration zone and/or subsequent heating zone is advantageous from the standpoint of effective utilization of inert gas leading to the reduction of production cost.

The irradiation with ionizing radiation is preferably accompanied or followed by the heating of the film. The film is preferably heated such that the temperature of the surface thereof reaches a range of from not lower than 60° C. to not higher than 170° C. When the film is heated such that the temperature of the surface thereof reaches 60° C. or more, desirable results of heating can be obtained. When the film is heated such that the temperature of the surface thereof reaches 170° C. or less, there arise no problems such as deformation of substrate to advantage. The surface temperature is more preferably from 80° C. to 130° C. The term “temperature of the film surface” as used herein is meant to indicate the temperature of the surface of the layer to be cured.

The time required until the temperature of the film reaches the above defined range is preferably from not smaller than 0.1 seconds to not greater than 300 seconds, more preferably 10 seconds or less, from the initiation of irradiation with ultraviolet rays. When the time during which the temperature of the film surface is kept within the above defined range is sufficient, the reaction of the curable composition for the formation of film can be accelerated. Further, when the time is not too long, there arise neither deterioration of optical properties of film nor production problems such as excessive increase of the size of facilities.

The heating method is not specifically limited, but there is preferably used a method which comprises bringing a heated roll into contact with the film, a method which comprises spraying heated nitrogen over the film or a method involving the irradiation with far infrared rays or infrared rays. Alternatively, a method may be used which comprises allowing hot water or water vapor to flow over a rotary metal roll to heat the roll as described in Japanese Patent No. 2523574.

<Film-Forming Binder>

As the main film-forming binder of the curable composition to be contained in the coating solution for forming the layer to be cured with ionizing radiation in the method of producing the optical film of the invention there is preferably used a compound containing an ethylenically unsaturated group from the standpoint of film strength, stability of coating solution, productivity of coat layer, etc. The term “main film-forming binder component” as used herein is meant to indicate those accounting for not smaller than 10% by mass to not greater than 100% by mass, preferably from not smaller than 20% by mass to not greater than 100% by mass, more preferably not smaller than 30% by mass to not greater than 95% by mass, of the film-forming component excluding inorganic particles.

The main film-forming binder is preferably a polymer having a saturated hydrocarbon chain or polyether chain as a main chain, more preferably a polymer having a saturated hydrocarbon chain. It is further preferred that the polymer have a crosslinked structure. The binder polymer having a saturated hydrocarbon chain as a main chain and a crosslinked structure is preferably a (co)polymer of monomers having two or more ethylenically unsaturated groups. In order to provide the layer with a high refractive index, it is preferred that the structure of the monomer comprise an aromatic ring or at least one atom selected from the group consisting of halogen atoms other than fluorine, sulfur atom, phosphorus atom and nitrogen atom incorporated therein.

Examples of the monomer having two or more ethylenically unsaturated groups include esters of polyvalent alcohol with (meth)acrylic acid (e.g., ethylene glycol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, polyester polyacrylate), vinylbenzene and derivatives thereof (e.g., 1,4-divinyl cyclohexanone), 2-acryloylethyl 4-vinyl benzoate ester vinylsulfone (e.g., divinylsulfone), acrylamide (e.g., methylene bisacrylamide), and methacrylamide. These monomers may be used in combination of two or more thereof.

The terms “(meth)acrylate”, “(meth)acryloyl” and “(meth)acrylic acid” as used herein are meant to indicate “acrylate or methacrylate”, “acryloyl or methacryloyl” and “acrylic acid or methacrylic acid”, respectively.

Specific examples of the high refractive monomer to be used to provide the cured layer with a high refractive index include bis(4-methacryloylthiophenyl) sulfide, vinyl naphthalene, vinyl phenyl sulfide, and 4-methacryloylphenyl-4′-methoxyphenylthioether. These monomers, too, may be used in combination of two or more thereof.

The polymerization of the monomers having an ethylenically unsaturated group may be carried out by the irradiation with ionizing radiation or heating in the presence of the photoradical polymerization initiator or heat radical polymerization initiator. As previously mentioned, the curing of the layer corresponding to layer A and layer B among the layers to be cured with ionizing radiation in the optical film produced according to the invention is effected at the aforementioned Steps 1 and 2.

The kind of the ionizing radiation to be used in the invention is not specifically limited but may be properly selected from the standpoint of ultraviolet rays, electron rays, near ultraviolet rays, visible light, near infrared rays, infrared rays and X rays depending on the kind of the curable composition from which the film is formed. In the invention, irradiation with ultraviolet rays is preferred. The curing with ultraviolet rays is preferably effected because it allows fast polymerization, requires only compact facilities, allows selection of a variety of compound seeds and can be effected at reduced cost.

In the case where ultraviolet rays are used, ultrahigh pressure mercury vapor lamp, high pressure mercury vapor lamp, low pressure mercury vapor, carbon arc, xenon arc, metal halide lamp, etc. may be used. In the case where electron rays are used, electron ray having an energy of from 50 to 1,000 keV emitted by various electron accelerators such as Cockroft-Walton accelerator, Van de Graaff accelerator, resonance-transformation type accelerator, insulating core-transformer type accelerator, linear type acclerator, dynamitron type accelerator and high frequency type accelerator may be used.

Examples of the photoradical polymerization initiator include acetophenones, benzoins, benzophenones, phosphine oxides, ketals, anthraquinones, thioxanthones, azo compounds, peroxides, 2,3-dialkyldione compounds, disulfide compounds, fluoroamine compounds, and aromatic sulfoniniums. Examples of the acetophenones include 2,2-diethoxyacetophenone, p-dimethylacetophenone, 1-hydroxydimethyl phenyl ketone, 1-hydroxycyclohexyl phenyl ketone, 2-methyl-4-methylthio-2-morpholino propiophenone, and 2-benzyl-2-dimethylamino-1-(4-moropholinophenyl-butanone. Examples of the benzoins include benzoinbenzenesulfonic acid ester, benzointoluenesulfonic acid ester, benzoin methyl ether, benzoin ethyl ether, and benzoin isopropyl ether. Examples of the benzophenones include benzophenone, 2,4-dichlorobenzophenone, 4,4-dichlorobenzophenone, and p-chlorobenzophenone. Examples of the phosphine oxides include 2,4,6-trimethylbenzoyl diphenyl phosphine oxide.

Various examples of the photoradical polymerization initiator are listed also in “Saishin UV Koka Gijutsu (Newest UV Curing Technique)”, TECHNICAL INFORMATION INSTITUTE CO., LTD., page 159, 1991. These examples are useful in the invention.

Preferred examples of commercially available photocleavable photoradical polymerization initiators include Irgacure (651, 184, 907) (produced by Nihon Ciba-Geigy K.K.).

The photopolymerization initiator is preferably used in an amount of from 0.1 to 15 parts by mass, more preferably from 1 to 10 parts by mass based on 100 parts by mass of polyfunctional monomer.

In addition to the photopolymerization initiator, a photosensitizer may be used. Specific examples of the photosensitizer include n-butylamine, triethylamine, tri-n-butylphosphine, Michler's ketone, and thioxanthone.

As the heat radical polymerization initiator there may be used an organic or inorganic peroxide, an organic azo or diazo compound or the like.

Specific examples of the organic peroxide include benzoyl peroxide, halogen benzoyl peroxide, lauroyl peroxide, acetyl peroxide, dibutyl peroxide, cumene hydroperoxide, and butyl hydroperoxide. Specific examples of the inorganic peroxide include hydrogen peroxide, ammonium persulfate, and potassium persulfate. Specific examples of the azo compound include 2,2′-azobis(isobutylnitrile), 2,2′-azobis (propionitrile), and 1,1′-azobis (cyclohexanedinitrile). Specific examples of the diazo compound include diazoaminobenzene, and p-nitrobenzene diazonium.

In the invention, a polymer having a polyether as a main chain may be used. The ring opening polymerization product of a polyfunctional epoxy compound is preferred. The ring opening polymerization of a polyfunctional epoxy compound may be effected by irradiation with ionizing radiation or heating in the presence of a photo-acid generator or heat-acid generator. As the photo-acid generator and heat-acid generator there may be used materials known as such.

Instead of or in addition to the monomer having two or more ethylenically unsaturated groups, a monomer having a crosslinked structure may be used to introduce a crosslinkable functional group into the polymer so that the crosslinkable functional group is reacted to introduce a crosslinked structure into the binder polymer.

Examples of the crosslinkable functional group include isocyanate groups, epoxy groups, aziridine groups, oxazoline groups, aldehyde groups, carbonyl groups, hydrazine groups, carboxyl groups, methylol groups, and active methylene groups. A vinylsulfonic acid, an acid anhydride, a cyano acrylate derivative, a melamine, an etherified methylol, an ester, an urethane or a metal alkoxide such as tetramethoxysilane may be used as a monomer for the incorporation of a crosslinked structure. A functional group which exhibits crosslinkability as a result of decomposition reaction such as blocked isocyanate group may be used. In other words, the crosslinkable functional group to be used in the invention may be not immediately reactive but may be reactive as a result of decomposition reaction.

These binder polymers having a crosslinkable functional group may form a crosslinked structure when heated after being spread.

The various layers constituting the anti-reflection layer of the anti-reflection film which is a representative example of the optical film produced according to the invention will be further described hereinafter.

<Material for Low Refractive Layer>

As previously mentioned, the low refractive layer is preferably formed at Step 2. In other words, the low refractive layer is preferably formed as a layer corresponding to the layer B.

The low refractive layer is preferably formed by the cured film of a copolymer comprising as essential constituents a repeating unit derived from fluorine-containing vinyl monomer and a repeating unit having a (meth)acryloyl group in its side chain. The component derived from the copolymer preferably accounts for 60% by mass or more, more preferably 70% by mass or more, particularly 80% by mass or more of the film solid content. From the standpoint of both reduction of refractive index and accomplishment of desired film hardness, a hardener such as polyfunctional (meth)acrylate is preferably used in an amount such that the compatibility thereof cannot be impaired.

Compounds as disclosed in JP-A-11-228631 are preferably used.

The refractive index of the low refractive index layer is preferably from 1.20 to 1.46, more preferably, from 1.25 to 1.46, and particularly preferably from 1.30 to 1.46.

The thickness of the low refractive layer is preferably from 50 to 200 nm, more preferably from 70 to 100 nm. The haze of the low refractive layer is preferably 3% or less, more preferably 2% or less, most preferably 1% or less. The specific hardness of the low refractive layer is preferably H or more, more preferably 2H or more, most preferably 3H or more according to pencil hardness test at a load of 500 g.

In order to improve the stainproofness of the anti-reflection film, the contact angle of the surface of the anti-reflection film with respect to water is preferably 90° or more, more preferably 95° or more, particularly 100° or more.

[Fluorine-Containing Polymer]

The copolymer which is preferably used in the low refractive layer of the invention will be described hereinafter.

Examples of the fluorine-containing monomer include fluoroolefins (e.g., fluoroethylene, vinylidene fluoride, tetrafluoroethylene, hexafluoropropylene), partly or fully fluorinated alkylester derivatives of (meth)acrylic acid (e.g., Biscoat 6FM (produced by OSAKA ORGANIC CHEMICAL INDUSTRY LTD.), M-2020 (produced by DAIKIN INDUSTRIES, Ltd.)), and fully or partly-fluorinated vinyl ethers. Preferred among these fluorine-containing monomers are perfluoroolefins. Particularly preferred among these fluorine-containing monomers is hexafluoropropylene from the standpoint of refractive index, solubility, transparency, availability, etc. When the proportion of these fluorine-containing vinyl monomers rises, the resulting low refractive layer can be provided with a reduced refractive index but is provided with a reduced film strength. In the invention, the fluorine-containing vinyl monomers are preferably introduced in such an amount that the content of fluorine in the copolymer reach a range of from 20 to 60% by mass, more preferably from 25 to 55% by mass, particularly from 30 to 50% by mass.

The copolymer to be used in the invention preferably has a repeating unit having a (meth)acryloyl group in its side chains as an essential component. When the proportion of these (meth)acryloyl group-containing repeating units increases, the resulting film has an enhanced strength but a raised refractive index. Though depending on the kind of the repeating unit derived from fluorine-containing vinyl monomer, the (meth)acryloyl group-containing repeating unit preferably accounts for from 5 to 90% by mass, more preferably from 30 to 70% by mass, particularly from 40 to 60% by mass of the copolymer.

In the copolymer useful in the invention, other proper vinyl monomers may be copolymerized besides the repeating unit derived from the aforementioned fluorine-containing vinyl monomer and the repeating unit having a (meth)acryloyl group in its side chains from the standpoint of adhesion to substrate, Tg of polymer (contributing to film hardness), solubility in solvent, transparency, slipperiness, dustproofness/stainproofness, etc. A plurality of these vinyl monomers may be used in combination depending on the purpose. These vinyl monomers are preferably introduced in a total amount of from 0 to 65 mol-%, more preferably from 0 to 40 mol-%, particularly from 0 to 30 mol-% based on the copolymer.

The monomers to be used in combination with the aforementioned constituent units are not specifically limited. Examples of these monomers include olefins (e.g., ethylene, propylene, isoprene, vinyl chloride, vinylidene chloride), acrylic acid esters (e.g., methyl acrylate, ethyl acrylate, 2-ethylhexyl acrylate), methacrylic acid esters (methyl methacrylate, ethyl methacrylate, butyl methacrylate, 2-hydroxyethyl methacrylate), styrene derivatives (e.g., styrene, p-hydroxymethyl styrene, p-methoxystyrene), vinyl ethers (e.g., methyl vinyl ether, ethyl vinyl ether, cyclohexyl vinyl ether, hydroxy ethyl vinyl ether, hydroxy butyl vinyl ether), vinyl esters (e.g., vinyl acetate, vinyl priopionate, vinyl cinnamate), unsaturated carboxylic acids (e.g., acrylic acid, methacrylic acid, crotonic acid, maleic acid, itaconic acid), acrylamides (e.g., N,N-dimethyl acrylamide, N-t-butylacrylamide, N-cyclohexyl acrylamide), methacrylamides (e.g., N,N-dimethyl methacrylamide), and acrylonitrile.

In the invention, as the copolymer there is preferably used a fluorine-containing polymer represented by the following general formula (1):

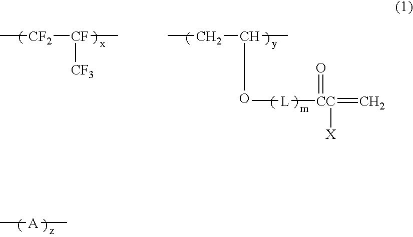

In the general formula (1), L represents a C₁-C₁₀ connecting group, preferably a C₁-C₆ connecting group, particularly C₂-C₄ connecting group. The connecting group may be straight-chain or may have a branched or cyclic structure. The connecting group may have hetero atoms selected from the group consisting of oxygen, nitrogen and sulfur.

Preferred examples of L include *—(CH₂)₂—O—**, *—(CH₂)₂—NH—**, *—(CH₂)₄—O—**, *—(CH₂)₆—O—**, *—(CH₂)₂—O— (CH₂)₂—O—**, *—CONH—(CH₂)₃—O—**, *—CH₂CH(OH)CH₂—O—**, and *—CH₂CH₂OCONH(CH₂)₃—O—** (in which * indicates the connecting site on the polymer main chain side and ** indicates the connecting site on the (meth)acryloyl group side). The suffix m represents 0 or 1.

In the general formula (1), X represents a hydrogen atom or methyl group, preferably hydrogen atom from the standpoint of curing reactivity.

In the general formula (1), the group A represents a repeating unit derived from arbitrary vinyl monomer. The repeating unit is not specifically limited so far as it is a constituent of a monomer copolymerizable with hexafluoropropylene. The repeating unit may be properly selected from the standpoint of adhesion to substrate, Tg of polymer (contributing to film hardness), solubility in solvent, transparency, slipperiness, dustproofness, stainproofness, etc. The repeating unit may be composed of a single or a plurality of vinyl monomers depending on the purpose.

Preferred examples of the aforementioned vinyl monomer include vinyl ethers such as methyl vinyl ether, ethyl vinyl ether, t-butyl vinyl ether, cyclohexyl vinyl ether, isopropyl vinyl ether, hydroxyethyl vinyl ether, hydroxybutyl vinyl ether, glycidyl vinyl ether and allyl vinyl ether, vinyl esters such as vinyl acetate, vinyl propionate and vinyl butyrate, (meth)acrylates such as methyl (meth)acrylate, ethyl (meth)acrylate, hydroxyethyl (meth)acrylate, glycidyl methacrylate, allyl (meth)acrylate and (meth)acryloyloxypropyl trimethoxysilane, styrene derivatives such as styrene and p-hydroxymethylstyrene, unsaturated carboxylic acids such as crotonic acid, maleic acid and itaconic acid, and derivatives thereof. More desirable among these vinyl monomers are vinyl ether derivatives and vinyl ester derivatives. Particularly preferred among these vinyl monomers are vinyl ether derivatives.

The suffixes x, y and z each represent the molar percentage of the respective constituent component and satisfy the relationships 30≦x≦60, 5≦y≦70 and 0≦z≦65, preferably 35≦x≦55, 30≦y≦60 and 0≦z≦20, particularly 40≦x≦55, 40≦y≦55 and 0≦z≦10, with the proviso that the sum of x, y and z is 100.

A particularly preferred embodiment of the copolymer to be used in the invention is one represented by the general formula (2).

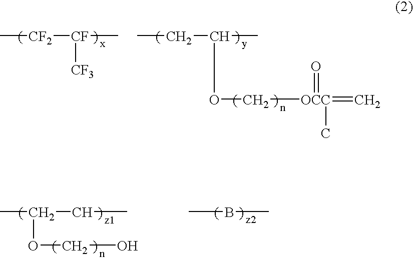

In the general formula (2), X, x and y and their preferred range are as defined in the general formula (1). The suffix n represents an integer of from not smaller than 2 to not greater than 10, preferably from not smaller than 2 to not greater than 6, particularly from not smaller than 2 to not greater than 4. The group B represents a repeating unit derived from arbitrary vinyl monomer. The repeating unit may be composed of a single composition or a plurality of compositions. Examples of the repeating unit include those listed above with reference to the group A in the general formula (1). The suffixes z1 and z2 each represent the molar percentage of the respective repeating unit and satisfy the relationship 0≦z1≦65 and 0≦z2≦65, preferably 0≦z1≦30 and 0≦z2≦10, particularly 0≦z1≦10 and 0≦z2≦5, with the proviso that the sum of x, y, z1 and z2 is 100.

The copolymer represented by the general formula (1) or (2) can be synthesized by introducing a (meth) acryloyl group into a copolymer comprising a hexafluoropropylene component and a hydroxyalkylvinyl ether component.

Preferred examples of the copolymer useful in the invention will be given below, but the invention is not limited thereto.

TABLE 1

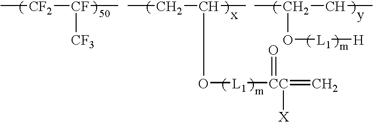

| | | | | | | Number |
|---|---|---|---|---|---|---|
| | | | | | | average |
| | | | | | | molecular |
| | | | | | | weight |
| | x | y | m | L₁ | X | Mn (×10⁴) |
| P-1 | 50 | 0 | 1 | *—CH₂CH₂O— | H | 3.1 |
| P-2 | 50 | 0 | 1 | *—CH₂CH₂O— | CH₃ | 4.0 |
| P-3 | 45 | 5 | 1 | *—CH₂CH₂O— | H | 2.8 |
| P-4 | 40 | 10 | 1 | *—CH₂CH₂O— | H | 3.8 |
| P-5 | 30 | 20 | 1 | *—CH₂CH₂O— | H | 5.0 |
| P-6 | 20 | 30 | 1 | *—CH₂CH₂O— | H | 4.0 |
| P-7 | 50 | 0 | 0 | — | H | 11.0 |
| P-8 | 50 | 0 | 0 | *—C₄H₈O— | H | 0.8 |
| P-9 | 50 | 0 | 0 | 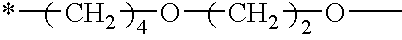 | H | 1.0 |
| P- 10 | 50 | 0 | 0 | 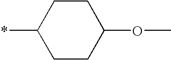 | H | 7.0 |
| P- | 50 | 0 | 1 | *—CH₂CH₂NH— | H | 4.0 |
| 11 | | | | | | |
| P- 12 | 50 | 0 | 1 | 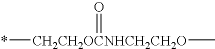 | H | 4.5 |
| P- 13 | 50 | 0 | 1 | 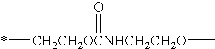 | CH₃ | 4.5 |
| P- 14 | 50 | 0 | 1 | 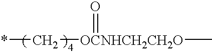 | CH₃ | 5.0 |
| P- 15 | 50 | 0 | 1 | 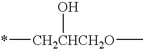 | H | 3.5 |
| P- 16 | 50 | 0 | 1 | 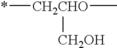 | H | 3.0 |
| P- 17 | 50 | 0 | 1 | 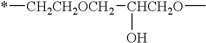 | H | 3.0 |
| P- 18 | 50 | 0 | 1 | 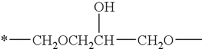 | CH₃ | 3.0 |
| P- 19 | 50 | 0 | 1 | 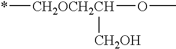 | CH₃ | 3.0 |
| P- | 40 | 10 | 1 | *—CH₂CH₂O— | CH₃ | 0.6 |
| 20 | | | | | | |

The symbol * indicates the main chain side.

TABLE 2

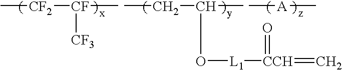

| | | | | | | Number average molecular weight |
|---|---|---|---|---|---|---|
| | x | y | z | L₁ | A | Mn (×10⁴) |
| P-21 | 55 | 45 | 0 | *—CH₂CH₂O—** | — | 1.8 |
| P-22 | 45 | 55 | 0 | *—CH₂CH₂O—** | — | 0.8 |
| P-23 | 50 | 45 | 5 | 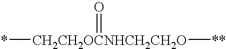 | 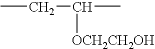 | 0.7 |
| P-24 | 50 | 45 | 5 | 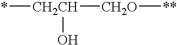 | 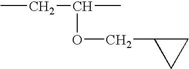 | 4.0 |
| P-25 | 50 | 45 | 5 | 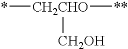 | 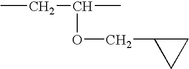 | 4.0 |
| P-26 | 50 | 40 | 10 | *—CH₂CH₂O—** | 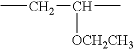 | 4.0 |
| P-27 | 50 | 40 | 10 | *—CH₂CH₂O—** | 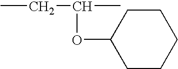 | 4.0 |
| P-28 | 50 | 40 | 10 | *—CH₂CH₂O—** | 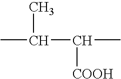 | 5.0 |

The symbol * indicates the polymer main chain side.
The symbol ** indicates the acryloyl group side.

TABLE 3

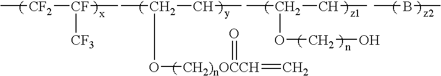

| | | | | | | | | Number average molecular weight |
|---|---|---|---|---|---|---|---|---|
| | x | y | z1 | z2 | n | X | B | Mn (×10⁴) |
| P-29 | 50 | 40 | 5 | 5 | 2 | H | 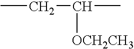 | 5.0 |
| P-30 | 50 | 35 | 5 | 10 | 2 | H | 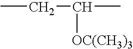 | 5.0 |
| P-31 | 40 | 40 | 10 | 10 | 2 | CH₃ | 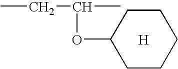 | 4.0 |

TABLE 4

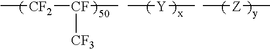

| | | | | | Number average molecular weight |
|---|---|---|---|---|---|
| | x | y | Y | Z | Mn (×10⁴) |
| P-32 | 45 | 5 | 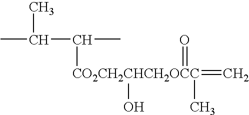 | 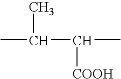 | 4.0 |
| P-33 | 40 | 10 | 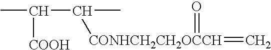 | 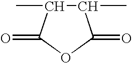 | 4.0 |

TABLE 5

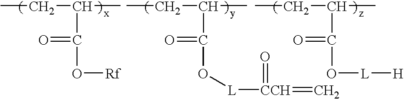

| | | | | | | Number average molecular weight |
|---|---|---|---|---|---|---|
| | x | y | z | Rf | L | Mn (×10⁴) |
| P-34 | 60 | 40 | 0 | —CH₂CH₂C₈F₁₇(n) | *—CH₂CH₂O— | 11 |
| P-35 | 60 | 30 | 10 | —CH₂CH₂C₄F₈H(n) | *—CH₂CH₂O— | 30 |
| P-36 | 40 | 60 | 0 | —CH₂CH₂C₆F₁₂H(n) | *—CH₂CH₂CH₂CH₂O— | 4.0 |

The symbol * indicates the polymer main chain side.

TABLE 6

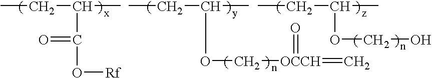

| | | | | | | Number average |
|---|---|---|---|---|---|---|
| | | | | | | molecular weight |
| | x | y | z | n | Rf | Mn (×10⁴) |
| P-37 | 50 | 50 | 0 | 2 | —CH₂C₄F₈H(n) | 5.0 |
| P-38 | 40 | 55 | 5 | 2 | —CH₂C₄F₈H(n) | 4.0 |
| P-39 | 30 | 70 | 0 | 4 | —CH₂C₈F₁₇(n) | 10 |
| P-40 | 60 | 40 | 0 | 2 | —CH₂CH₂C₈F₁₆H(n) | 5.0 |

The copolymer to be used in the invention may be synthesized by the method disclosed in JP-A-2004-45462. The synthesis of the copolymer to be used in the invention can be carried out also by synthesizing a precursor such as hydroxyl group-containing polymer using any of various polymerization methods other than the aforementioned method, e.g., solution polymerization, suspension polymerization, precipitation polymerization, bulk polymerization and emulsion polymerization, and then subjecting the precursor to the aforementioned polymer reaction so that a (meth)acryloyl group is introduced thereinto. The polymerization reaction can be conducted by any known process such as batchwise process, semi-continuous process and continuous process.

Examples of the method of initiating polymerization include a method involving the use of a radical polymerization initiator and a method involving the irradiation with ionizing radiation.

For the details of these polymerization methods and polymerization initiating methods, reference can be made to Teiji Tsuruta, “Kobunshi Gosei Hoho (Polymer Synthesis Methods)”, revised edition, THE NIKKAN KOGYO SHINBUN LTD., 1971, and Takayuki Otsu and Masayoshi Kinoshita, “Kobunshi Gosei no Jikkenho (Experimental Methods of Polymer Synthesis)”, Kagakudojin, 1972, pp. 124-154.

Particularly preferred among the aforementioned polymerization methods is solution polymerization using a radical polymerization initiator. Examples of the solvent to be used in solution polymerization include various organic solvents such as ethyl acetate, butyl acetate, acetone, methyl ethyl ketone (MEK), methyl isobutyl ketone (MIBK), cyclohexanone, tetrahydrofurane, dioxane, N,N-dimethylformamide, N,N-dimethyl acetamide, benzene, toluene, acetonitrile, methylene chloride, chloroform, dichloroethane, methanol, ethanol, 1-propanol and 1-butanol. These organic solvents may be used singly or in combination of two or more thereof or in admixture with water.

The polymerization temperature needs to be predetermined in connection with the molecular weight of the polymer, the kind of the initiator, etc. and may range from not higher than 0° C. to not lower than 100° C. but preferably range from 50° C. to 100° C.

The reaction pressure may be properly predetermined but normally is preferably from about 1 to 100 kPa, particularly from about 1 to 30 kPa. The reaction time is from about 5 to 30 hours.

Preferred examples of reprecipitating solvent for the polymer thus obtained include isopropanol, hexane, and methanol.

[Particulate Inorganic Material]

The particulate inorganic material which is preferably incorporated in the low refractive layer of the anti-reflection film of the invention will be described hereinafter.

The spread of the particulate inorganic material is preferably from 1 mg/m² to 100 mg/m², more preferably from 5 mg/m² to 80 mg/m², even more preferably from 10 mg/m² to 60 mg/m². When the spread of the particulate inorganic material is not lower than the lower limit, the effect of improving scratch resistance can be sufficiently expected. On the other hand, when the spread of the particulate inorganic material is not higher than the upper limit, the production of fine roughness on the surface of the low refractive layer can be prevented, making it possible to inhibit the deterioration of the external appearance such as black tone and density and integrated reflectance when the anti-reflection film is used in display devices to advantage.

The particulate inorganic material preferably has a low refractive index because it is incorporated in the low refractive layer. Examples of the particulate inorganic material include particulate materials such as silica and hollow silica. The average particle diameter of the particulate silica is preferably from not smaller than 30% to not greater than 150%, more preferably from not smaller than 35% to not greater than 80%, even more preferably from 40% to not greater than 60% of the thickness of the low refractive layer. In some detail, when the thickness of the low refractive layer is 100 nm, the particle diameter of the particulate silica is preferably from not smaller than 30 nm to not greater than 150 nm, more preferably from not smaller than 35 nm to not greater than 80 nm, even more preferably from not smaller than 40 nm to not greater than 60 nm.

When the particle diameter of the particulate silica is not smaller than the lower limit, the resulting low refractive layer exhibits an improved scratch resistance. When the particle diameter of the particulate silica is not greater than the upper limit, the production of fine roughness on the surface of the low refractive layer can be prevented, making it possible to inhibit the deterioration of the external appearance such as black tone and density and integrated reflectance when the anti-reflection film is used in display devices to advantage. The particulate silica may be crystalline or amorphous. The particulate silica may be monodisperse or may be composed of agglomerated particles so far as they have a predetermined particle diameter. The shape of the particulate silica is most preferably sphere but may be amorphous. For the measurement of the average particle diameter of the particulate inorganic material, a coulter counter may be used.

In order to reduce the refractive index of the low refractive layer, a hollow particulate silica (hereinafter occasionally referred to as “hollow particulate material”) is preferably used. The refractive index of the hollow particulate material is preferably from 1.17 to 1.40, more preferably from 1.17 to 1.35, even more preferably from 1.17 to 1.30. The refractive index used herein means the refractive index of the entire particulate material rather than the refractive index of only the shell silica constituting the hollow particulate silica. Supposing that the radius of the bore of the particle is rᵢ and the radius of the shell of the particle is r₀, the percent void x is represented by the following numerical formula (2):
x=(rᵢ/r₀)³×100(%) (2)

The percent void x of the hollow particulate material is preferably from 10% to 60%, more preferably from 20% to 60%, most preferably from 30% to 60%. As the refractive index of the hollow particulate material decreases from the above defined range and the percentage void of the hollow particulate silica rises from the above defined range, the thickness of the shell decreases. Therefore, the refractive index of the hollow particulate material is preferably not smaller than 1.17 from the standpoint of strength of hollow particulate silica and scratch resistance of low refractive layer.

For the measurement of the refractive index of these hollow particulate materials, an Abbe refractometer (produced by ATAGO CO., LTD.) was used.

The refractive index of the low refractive layer, if it comprises a hollow particulate material incorporated therein, is preferably from not smaller than 1.20 to not greater than 1.46, more preferably from not smaller than 1.25 to not greater than 1.41, most preferably from not smaller than 1.30 to not greater than not greater than 1.39.

Further, the low refractive layer may comprise at least one of particulate silica materials having an average particle diameter of less than 25% of the thickness of the low refractive layer (hereinafter referred to as “small particle size particulate silica”) incorporated therein in combination with the aforementioned particulate silica (hereinafter referred to as “large particle size particulate silica”). The small particle size particulate silica can be present in the gap between the large size silica particles and thus can act as a retainer for large particle diameter particulate silica. In the case where the thickness of the low refractive layer is 100 nm, the average particle diameter of the small particle diameter particulate silica is preferably from not smaller than 1 nm to not greater than 20 nm, more preferably from not smaller than 5 nm to not greater than 15 nm, particularly from not smaller than 10 nm to not greater than 15 nm. The use of such a particulate silica is advantageous in material cost and effect of retainer.

[Organosilane Compound]

In the invention, a hydrolyzate of organosilane discussed later and/or partial condensate (sol) thereof is preferably incorporated in the low refractive layer from the standpoint of enhancement of film strength. The added amount of the sol is preferably from 2 to 200% by mass, more preferably from 5 to 100% by mass, most preferably from 10 to 50% by mass based on the aforementioned particulate inorganic material. The organosilane compound may includes those exemplified in [organosilane compound, etc.] of <hard coat layer> discussed later.

In the invention, it is preferred from the enhancement of stainproofness that the free energy of the surface of the anti-reflection membrane be reduced. In some detail, a fluorine-containing compound or a compound having a polysiloxane structure is preferably incorporated in the low refractive layer. Preferred examples of the additives having a polysiloxane structure include reactive group-containing polysiloxanes [e.g., “KF-100T”, “X-22-169AS”, “KF-102”, “X-22-37011E”, “X-22-164B”, “X-22-5002”, “X-22-173B”, “X-22-174D”, “X-22-167B”, “X-22-161AS” (produced by Shin-Etsu Chemical Co., Ltd.); “AK-5”, “AK-30”, “AK-32” (produced by TOAGOSEI CO., LTD); “SILA-PLANE FM0725”, “SILA-PLANE FM0721” (produced by CHISSO CORPORATION); DMS-U22, RMS-033, RMS-083, UMS-182, DMS-H21, DMS-H31, HMS-301, FMS121, FMS123, FMS131, FMS141, FMS221 (produced by Gelest Inc.)]. Further, silicone compounds as disclosed in Tables 2 and 3 in JP-A-2003-112383 are preferably used. These polysiloxanes are preferably used in an amount of from 0.1 to 10% by mass, particularly from 1 to 5% by mass based on the total solid content of the low refractive layer.

The polymerization of the aforementioned fluorine-containing polymer can be carried out by irradiating with ionizing radiation or heating in the presence of the aforementioned photoradical polymerization initiator or heat radical polymerization initiator. Accordingly, the low refractive layer can be formed by preparing a coating solution containing the aforementioned fluorine-containing polymer, photoradical polymerization initiator or heat radical polymerization initiator and particulate inorganic material, spreading the coating solution over a transparent substrate or the layer on which the low refractive layer is to be formed, and then irradiating the coat layer with ionizing radiation or heating the coat layer to cause curing reaction.

In the case where the low refractive layer is formed as a layer corresponding to the aforementioned layer B, the low refractive layer is preferably formed at Step 2 as previously mentioned.

In the case where the following various layers each correspond to the layer A, that is, the various layers are each formed as a layer directly on which the low refractive layer is formed as a layer corresponding to the layer B, the layer corresponding to the layer A is preferably cured at Steps 1 and 2 as previously mentioned.

<Hard Coat Layer>

The hard coat layer has hard coat properties for enhancing the scratch resistance of the film. The hard coat layer is preferably used also for the purpose of contributing light diffusion properties attributed to at least any of surface scattering and internal scattering to the film. Accordingly, the hard coat layer preferably comprises a light-transmitting resin for providing hard coat properties and a light-transmitting particulate material for providing light diffusion properties incorporated therein. If necessary, the hard coat layer may further comprise an inorganic filler incorporated therein to enhance refractive index and strength and prevent crosslink condensation.

The thickness of the hard coat layer is preferably from 1 to 10 μm, more preferably from 1.2 to 6 μm for the purpose of providing hard coat properties. When the thickness of the hard coat layer falls within the above defined range, hard coat properties can be sufficiently provided. Further, the curling resistance and brittleness resistance cannot be deteriorated, making it possible to prevent the deterioration of workability.

[Light-Transmitting Resin]

The light-transmitting resin to be incorporated in the hard coat layer is preferably a binder polymer having a saturated hydrocarbon chain or polyether chain as a main chain, more preferably a binder polymer having a saturated hydrocarbon chain as a main chain. The binder polymer preferably has a crosslinked structure.

As the binder polymer having a saturated hydrocarbon chain as a main chain there is preferably used a polymer of ethylenically unsaturated monomers. The binder polymer having a saturated hydrocarbon chain as a main chain and a crosslinked structure is preferably a (co)polymer of monomers having two or more ethylenically unsaturated groups.

In order to provide a binder polymer having a higher refractive index, a high refractive monomer comprising an aromatic ring or at least one atom selected from the group consisting of halogen atoms other than fluorine, sulfur atom, phosphorus atom and nitrogen atom incorporated therein may be selected.

Examples of the monomer having two or more ethylenically unsaturated groups which is used as a main component include esters of polyvalent alcohol with (meth)acrylic acid [e.g., ethylene glycol di(meth)acrylate, butanediol di(meth)acrylate, hexanediol di (meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipenta erythritol tetra(meth)acrylate, dipentaerythritol penta(meth)acrylate, dipentaerythritol hexa(meth)acrylate, pentaerythritol hexa(meth)acrylate, 1,2,3-cyclohexatetramethacrylate, polyurethane polyacrylate, polyester polyacrylate], ethylene oxide modification products, propylene oxide modification products and caprolactone modification products of the aforementioned esters, vinylbenzene and derivatives thereof [e.g., 1,4-divinylbenzene, 4-vinylbenzoic acid-2-acryloylethylester, 1,4-divinylcyclohexanone], vinylsulfones (e.g., divinylsulfone), acylamides (e.g., methylene bisacrylamide), and methacrylamides. Two or more of these monomers are preferably used in combination.

Specific examples of the high refractive monomer include bis(4-methacryloylthiophenyl)sulfide, vinyl naphthalene, vinyl phenyl sulfide, and 4-methacryloxy phenyl-4′-methoxyphenylthioether. These monomers, too, may be used in combination of two or more thereof.

The polymerization of these monomers having an ethylenically unsaturated group may be carried out by irradiating with ionizing radiation or heating in the presence of the same polymerization initiator as described with reference to the low refractive layer. Accordingly, the hard coat layer can be formed by preparing a coating solution containing a light-transmitting resin-forming monomer such as the aforementioned ethylenically unsaturated monomer, an initiator which generates radicals when irradiated with ionizing radiation or heated, light-transmitting particles and optionally an inorganic filler, spreading the coating solution over a transparent substrate or a layer on which the hard coat layer is to be formed, and then subjecting the coat layer to polymerization reaction by irradiation with ionizing radiation or heating.

In addition to the polymerization initiator which generates radicals when irradiated with ionizing radiation or heated, the same photosensitizer as described above with reference to film-forming binder.

The polymer having a polyether as a main chain is preferably a ring opening polymerization product of a polyfunctional epoxy compound. The ring opening polymerization of a polyfunctional epoxy compound may be effected by irradiation with ionizing radiation or heating in the presence of a photo-acid generator or heat-acid generator. Accordingly, the hard coat layer can be formed by preparing a coating solution containing a polyfunctional epoxy compound, a photo-acid generator or heat-acid generator, light-transmitting particles and an inorganic filler, spreading the coating solution over a transparent substrate or a layer on which the hard coat layer is to be formed, and then subjecting the coating layer to polymerization reaction by irradiation with ionizing radiation.

Instead of or in addition to the monomer having two or more ethylenically unsaturated groups, a monomer having a crosslinkable functional group may be used to introduce a crosslinkable functional group into the polymer so that the crosslinkable functional group is reacted to introduce a crosslinked structure into the binder polymer.

Examples of the crosslinkable functional group include isocyanate groups, epoxy groups, aziridine groups, oxazoline groups, aldehyde groups, carbonyl groups, hydrazine groups, carboxyl groups, methylol groups, and active methylene groups. A vinylsulfonic acid, an acid anhydride, a cyano acrylate derivative, a melamine or a metal alkoxide such as tetramethoxysilane may be used as a monomer for the incorporation of a crosslinked structure. A functional group which exhibits crosslinkability as a result of decomposition reaction such as blocked isocyanate group may be used. In other words, the crosslinkable functional group to be used in the invention may be not immediately reactive but may be reactive as a result of decomposition reaction. These binder polymers having a crosslinkable functional group may form a crosslinked structure when spread and heated.

[Light-Transmitting Particles]

The light-transmitting particulate material to be incorporated in the hard coat layer is used for the purpose of providing anti-glare properties or light diffusing properties. The average particle diameter of the light-transmitting particulate material is from 0.5 to 5 μm, preferably from 1.0 to 4.0 μm. When the average particle diameter of the light-transmitting particulate material is not smaller than the lower limit, there can little arise a problem that the distribution of light scattering angles is too wide, causing the deterioration of letter resolution of display or making it difficult to form surface roughness and hence causing the shortage of anti-glare properties. On the other hand, when the average particle diameter of the light-transmitting particulate material is not greater than the upper limit, it is not necessary that the thickness of the hard coat layer be too great, causing no problems such as much curling and rise of material cost.

Specific preferred examples of the aforementioned light-transmitting particulate material include inorganic particulate materials such as particulate silica and particulate TiO₂, and particulate resins such as particulate acryl, particulate crosslinked acryl, particulate methacryl particulate crosslinked methacryl, particulate polystyrene, particulate crosslinked styrene, particulate melamine resin and particulate benzoguanamine resin. Preferred among these light-transmitting particulate materials are particulate crosslinked styrene, particulate crosslinked acryl, particulate crosslinked acryl styrene, and particulate silica.

The light-transmitting particulate material may be spherical or amorphous.

Two or more light-transmitting particulate materials having different particle diameters may be used in combination. A light-transmitting particulate material having a greater particle diameter may be used to provide anti-glare properties while a light-transmitting particulate material having a smaller particle diameter may be used to provide other optical properties. For example, in the case where the anti-reflection film is stuck to a display having a precision of 133 ppi or more, it is required that there occur no glittering, which is one of defects in optical properties. Glittering is attributed to the presence of roughness (contributing to anti-glare properties) on the surface of the film that causes the expansion or shrinkage of pixels leading to the loss of uniformity in brightness. Glittering can be drastically eliminated by the additional use of light-transmitting particles having a greater particle diameter than that of the light-transmitting particulate material that provides anti-glare properties and a refractive index different from that of the binder.

Further, the distribution of particle diameter of the aforementioned light-transmitting particles is most preferably monodisperse. The particle diameter of the particles are preferably as close to each other as possible. For example, in the case where the particle having a particle diameter which is 20% or more of the average particle diameter greater is defined as coarse particle, the proportion of the coarse particles is preferably 1% or less, more preferably 0.1% or less, more preferably 0.01% or less based on the total number of particles. A light-transmitting particulate material having such a particle diameter distribution can be obtained by classifying particles produced by an ordinary synthesis reaction. By increasing the number of times of classification or raising the degree of classification, a better distribution can be obtained.

The light-transmitting particulate material is preferably incorporated in the hard coat layer thus formed in an amount of from 3 to 30% by mass, more preferably from 5 to 20% by mass based on the total solid content of the hard coat layer taking into account the light scattering effect, image resolution, surface turbidity, glittering, etc. The density of the light-transmitting particulate material is preferably from 10 to 1,000 mg/m², more preferably from 100 to 700 mg/m².

For the measurement of particle size distribution of light-transmitting particulate material, a coulter counter method is employed. The distribution thus measured is then converted to distribution of number of particles.

[Inorganic Filler]

The hard coat layer preferably comprises an inorganic filler composed of oxide of at least one of metals such as titanium, zirconium, aluminum, indium, zinc, tin and antimony having an average particle diameter of 0.2 μm or less, preferably 0.1 μm or less, even more preferably 0.06 μm or less incorporated therein in addition to the aforementioned light-transmitting particulate material to enhance the refractive index thereof.

On the contrary, in order to increase the difference in refractive index from the light-transmitting particulate material, the hard coat layer comprising a high refractive light-transmitting particulate material incorporated therein preferably comprises a silicon oxide incorporated therein for keeping the refractive index thereof low. The preferred particle diameter of the silicon oxide is the same as that of the aforementioned inorganic filler.

Specific examples of the inorganic filler to be incorporated in the hard coat layer include TiO₂, ZrO₂, Al₂O₃, In₂O₃, ZnO, SnO₂, Sb₂O₃, ITO, and SiO₂. Particularly preferred among these inorganic fillers are TiO₂ and ZrO₂ from the standpoint of enhancement of refractive index. These inorganic fillers are preferably subjected to silane coupling treatment or titanium coupling treatment on the surface thereof. A surface treatment having a functional group reactive with a binder seed on the surface of filler is preferably used.

The added amount of these inorganic fillers, if used, is preferably from 10 to 90%, more preferably from 20 to 80%, particularly from 30 to 75% based on the total mass of the hard coat layer.

The inorganic filler has a sufficiently smaller particle diameter than the wavelength of light and thus is not scattered. Thus, a dispersion of the filler in a binder polymer behaves as an optically uniform material.

[Organosilane Compound, etc.]

The hard coat layer, too, may comprise at least nay of organosilane compound, hydrolyzate of organosilane and/or partial condensate (sol) thereof incorporated therein.

The organosilane compound is preferably one represented by the following general formula (A):
(R¹)ₘ—Si(X)₄₋m (A)

In the general formula (A), R¹ represents a substituted or unsubstituted alkyl or aryl group. The alkyl group R¹ is preferably a C₁-C₃₀ alkyl group, more preferably C₁-C₁₆ alkyl group, particularly C₁-C₆ alkyl group. Specific examples of the alkyl group include methyl, ethyl, propyl, isopropyl, hexyl, decyl, and hexadecyl. Examples of the aryl group R¹ include phenyl, and naphthyl. Preferred among these aryl groups is phenyl.

X represents a hydroxyl group or hydrolyzable group. Preferred examples of the hydroxyl group or hydrolyzable group include alkoxy groups (preferably a C₁-C₅ alkoxy group such as methoxy and ethoxy), halogen atoms (e.g., Cl, Br, and I), and groups represented by R²COO (in which R² is preferably a hydrogen atom or C₁-C₆ alkyl group such as CH₃COO and C₂H₅COO). Preferred among these groups are alkoxy groups, particularly methoxy or ethoxy.

The suffix m represents an integer of from 1 to 3, preferably 1 or 2.

A plurality of X's, if any, may be the same or different.

The substituents on R¹ are not specifically limited but may be halogen atoms (e.g., fluorine, chlorine, bromine), hydroxyl groups, mercapto groups, carboxyl groups, epoxy groups, alkyl groups (e.g., methyl, ethyl, i-propyl, propyl, t-butyl), aryl groups (e.g., phenyl, naphthyl), aromatic heterocyclic groups (e.g., furyl, pyrazolyl, pyridyl), alkoxy groups (e.g., methoxy, ethoxy, i-propoxy, hexyloxy), aryloxy groups (e.g., phenoxy), alkylthio groups (e.g., methylthio, ethylthio), arylthio groups (e.g., phenylthio), alkenyl groups (e.g., vinyl, 1-propenyl), acyloxy groups (e.g., acetoxy, acryloyloxy, methacryloyloxy), alkoxycarbonyl groups (e.g., methoxycarbonyl, ethoxycarbonyl), aryloxycarbonyl groups (e.g., phenoxycarbonyl), carbamoyl groups (e.g., carbamoyl, N-methylcarbamoyl, N,N-dimethylcarbamoyl, N-methyl-N-octylcarbamoyl), acylamino groups (e.g., acetylamino, benzoylamino, acrylamino, methacrylamino), etc. These substituents may be further substituted.

R¹ is preferably a substituted alkyl or aryl group, particularly a compound having a vinyl-polymerizable substituent represented by the following general formula (B) as an organosilane compound.

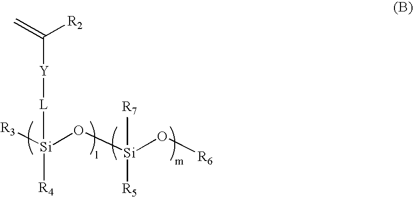

In the general formula (B), R₂ represents a hydrogen atom, methyl group, methoxy group, alkoxycarbonyl group, cyano group, fluorine atom or chlorine atom. Examples of the alkoxycarbonyl group include methoxycarbonyl group, and ethoxycarbonyl group. Preferred among these groups are hydrogen atom, methyl group, methoxy group, methoxycarbonyl group, cyano group, fluorine atom and chlorine atom. More desirable among these groups are hydrogen atom, methyl group, methoxycarbonyl group, fluorine atom and chlorine atom. Particularly preferred among these groups are hydrogen atom and methyl group.

Y represents a single bond, *—COO—**, *—CONH—** or *—O—**, preferably single bond, *—COO—** or *—CONH—**, more preferably single bond or *—COO—**, particularly *—COO—**. The symbol * indicates the position at which the group is connected to ═C(R₁). The symbol ** indicates the position at which the group is connected to L.

L represents a divalent connecting chain. Specific examples of the divalent connecting chain include substituted or unsubstituted alkylene groups, substituted or unsubstituted arylene groups, substituted or unsubstituted alkylene groups having a connecting group (e.g., ether, ester, amide) therein, and substituted or unsubstituted arylene groups having a connecting group therein. Preferred among these divalent connecting chains are substituted or unsubstituted alkylene groups, substituted or unsubstituted arylene groups and alkylene groups having a connecting group therein. More desirable among these divalent connecting chains are unsubstituted alkylene groups, unsubstituted arylene groups and alkylene groups having an ether or ester connecting group therein. Particularly preferred among these divalent connecting groups are unsubstituted alkylene groups and alkylene groups having an ether or ester connecting group therein. Examples of the substituents on these divalent connecting chains include halogens, hydroxyl groups, mercapto groups, carboxyl groups, epoxy groups, alkyl groups, and aryl groups. These substituents may be further substituted.

The suffix l represents a number satisfying the numerical formula l=100−m in which m represents a number of from 0 to 50, preferably from 0 to 40, particularly from 0 to 30.

R₃ to R₅ each are preferably a halogen atom, hydroxyl group, unsubstituted alkoxy group or unsubstituted alkyl group. R₃ to R₅ each are more preferably a chlorine atom, hydroxyl group or unsubstituted C₁-C₆ alkoxy group, even more preferably hydroxyl group and C₁-C₃ alkoxy group, particularly hydroxyl group or methoxy group.

R₆ represents a hydrogen atom and an alkyl group. Examples of the alkyl group is preferably methyl and ethyl. R₆ is more preferably a hydrogen atom and methyl.

R₇ has the same meaning as R₁ in the general formula (A). Preferred among the groups represented by R₇ are hydroxyl groups and unsubstituted alkyl groups. More desirable among these groups are hydroxyl groups and C₁-C₃ alkyl groups. Particularly preferred among these groups are hydroxyl group and methyl group.

Two or more compounds of the general formula (A) may be used in combination. In particular, the compound of the general formula (B) is synthesized from two compounds of the general formula (A) as starting materials.

The sol component to be used in the invention is prepared by the hydrolysis and/or partial condensation of the aforementioned organosilane.

The hydrolytic condensation reaction of the organosilane is carried out by stirring the organosilane with water added in an amount of from 0.05 to 2.0 mols, preferably from 0.1 to 1.0 mols per mol of the hydrolyzable group (X) at a temperature of from 25° C. to 100° C. in the presence of the catalyst used in the invention.

In at least any of the hydrolyzate of organosilane of the invention and the partial condensate thereof, the mass-average molecular weight of any of the hydrolyzate of organosilane having a vinyl-polymerizable group and the partial condensate thereof, excluding the components having a molecular weight of less than 300, is preferably from 450 to 20,000, more preferably from 500 to 10,000, even more preferably from 550 to 5,000, still more preferably from 600 to 3,000.

The proportion of the components having a molecular weight of more than 20,000 in the components having a molecular weight of 300 or more in the hydrolyzate and/or partial condensate of organosilane is preferably 10% by mass or less, more preferably 5% by mass or less, even more preferably 3% by mass or less. When the proportion of the components having a molecular weight of more than 20,000 is more than 10% by mass or less, the cured layer obtained by curing a curable composition containing such a hydrolyzate and/or partial condensate of organosilane does not exhibit a deteriorated transparency or adhesion to substrate, thus preferred

The mass-average molecular weight and the molecular weight each are a value obtained by measuring in THF as a solvent using a GPC analyzer comprising TSKgelGMHxL, TSKgelG4000HxL or TSKgelG2000HxL (produced by TOSOH CORPORATION) as a column and then converting the measurement in terms of polystyrene detected by a differential refractometer. The content of the hydrolyzate and/or partial condensate of organosilane is the percent area of the peak having a molecular weight falling within the above defined range based on 100% of the peak area of the components having a molecular weight of 300 or more.

The degree of dispersion (mass-average molecular weight/number-average molecular weight) is preferably from 1.1 to 3.0, more preferably from 1.1 to 2.5, even more preferably from 1.1 to 2.0, particularly from 1.1 to 1.5.

²⁹Si-NMR analysis of the hydrolyzate and partial condensate of organosilane of the invention makes it possible to confirm how X in the general formula (A) is condensed in the form of —OSi.

Supposing that the case where three Si bonds are condensed in the form of —OSi is (T3), the case where two Si bonds are condensed in the form of —OSi is (T2), the case where one Si bond is condensed in the form of —OSi (T1) and the case where no Si bond is condensed (T0), the condensation a is represented by the numerical formula (3):
α=(T3×3+T2×2+T1×1)/3/(T3+T2+T1+T0) (3)
The condensation α is preferably from 0.2 to 0.95, more preferably from 0.3 to 0.93, particularly from 0.4 to 0.9.

When the condensation α is 0.2 or more, it is prevented that the organosilane is not sufficiently hydrolyzed or condensed, raising the content of monomer components and hence making it impossible to sufficiently cure the resin composition, thus preferred On the contrary, when the condensation α is 0.95 or less, it is prevented that the hydrolysis or condensation of the organosilane proceeds too much, causing the consumption of the hydrolyzable groups and hence deteriorating the mutual interaction with the binder polymer, the resin substrate, the inorganic particulate material, etc., thus preferred Thus, the advantage of the invention can be sufficiently obtained within the above-mentioned range, thus preferred.

The hydrolyzate and partial condensate of organosilane to be used in the invention will be further described hereinafter.

The hydrolysis reaction of organosilane and the subsequent condensation reaction are normally effected in the presence of a catalyst. Examples of the catalyst employable herein include inorganic acids such as hydrochloric acid, sulfuric acid and nitric acid, organic acids such as oxalic acid, acetic acid, butyric acid, maleic acid, citric acid, formic acid, methanesulfonic acid and toluenesulfonic acid, inorganic bases such as sodium hydroxide, potassium hydroxide and ammonia, organic bases such as triethylamine and pyridine, metal alkoxides such as triisopropoxy aluminum, tetrabutoxy zirconium, tetrabutyl titanate and dibutyl tin dilaurate, metal chelate compounds comprising a metal such as zirconium, titanium and aluminum as a central metal, and fluorine-containing compound such as KF and NH₄F.

The aforementioned catalysts may be used singly or in combination.

The hydrolysis/condensation reaction of organosilane may be effected free from or in a solvent but is preferably effected in an organic solvent to uniformly mix the components. Preferred examples of the organic solvent employable herein include alcohols, aromatic hydrocarbons, ethers, ketones, and esters.

As the solvent there is preferably used one capable of dissolving the organosilane and the catalyst therein. It is also preferred from the procedural standpoint of view that the organic solvent be used as a coating solution or part thereof. A solvent which exhibits no deterioration in its dissolving power or dispersing force when mixed with other materials such as fluorine-containing polymer is preferably used.

Examples of the alcohols among these organic solvents include monovalent and divalent alcohols. Preferred among these monovalent alcohols are C₁-C₈ saturated aliphatic alcohols.

Specific examples of these alcohols include methanol, ethanol, n-propyl alcohol, i-propyl alcohol, n-butyl alcohol, sec-butyl alcohol, tert-butyl alcohol, ethylene glycol, diethylene glycol, triethylene glycol, ethylene glycol monobutyl ether, and ethylene glycol monoethyl ether acetate.

Specific examples of the aromatic hydrocarbons include benzene, toluene, and xylene. Specific examples of the ethers include tetrahydrofurane, and dioxane. Specific examples of the ketones include acetone, methyl ethyl ketone, methyl isobutyl ketone, diisobutyl ketone, and cyclohexanone. Specific examples of the esters include ethyl acetate, propyl acetate, butyl acetate, and propylene acetate.

These organic solvents may be used singly or in admixture of two or more thereof. The concentration of solid content during the reaction is not specifically limited but is normally from 1% to 100%.

The reaction is effected with water added in an amount of from 0.05 to 2 mols, preferably from 0.1 to 1 mols per mol of the hydrolyzable group with stirring at a temperature of from 25° C. to 100° C. in the presence or absence of the aforementioned solvent in the presence of a catalyst.

In the invention, the hydrolysis of organosilane is preferably effected with stirring at a temperature of from 25° C. to 100° C. in the presence of at least one metal chelate comprising an alcohol represented by the general formula R³OH (in which R³ represents a C₁-C₁₀ alkyl group) and a compound represented by the general formula R⁴COCH₂COR⁵ (in which R⁴ represents a C₁-C₁₀ alkyl group and R⁵ represents a C₁-C₁₀ alkyl or alkoxy group) as a ligand and a metal selected from the group consisting of zirconium, titanium and aluminum as a central metal.

Alternatively, the fluorine-containing compound, if used as a catalyst, allows complete progress of hydrolysis/condensation, making it possible to predetermine the amount of water to be added and hence determine the polymerization degree by which an arbitrary molecular weight can be predetermined to advantage. In some detail, in order to prepare a hydrolyzate/partial condensate of organosilane having an average polymerization degree M, water may be used in an amount of (M−1) mols based on M mols of the hydrolyzable organosilane.

As the metal chelate compound there may be preferably used any metal chelate compound without any specific limitation so far as it comprises an alcohol represented by the general formula R³OH (in which R³ represents a C₁-C₁₀ alkyl group) and a compound represented by the general formula R⁴COCH₂COR⁵ (in which R⁴ represents a C₁-C₁₀ alkyl group and R⁵ represents a C₁-C₁₀ alkyl or alkoxy group) as a ligand and a metal selected from the group consisting of zirconium, titanium and aluminum as a central metal. Two or more metal chelate compounds may be used in combination so far as they satisfy the aforementioned requirements. As the metal chelate compound to be used in the invention there is preferably used one selected from the group consisting of compounds represented by the general formulae Zr(OR³)ₚ₁(R⁴COCHCOR⁵)ₚ₂, Ti(OR³)_{q1}(R⁴COCHCOR⁵)_{q2} and Al(OR³)ᵣ₁(R⁴COCHCOR⁵)ᵣ₂. These metal chelate compounds act to accelerate the condensation reaction of the aforementioned hydrolyzate and partial condensate of organosilane compound.

In the metal chelate compounds, R³ and R⁴ may be the same or different and each represent a C₁-C₁₀ alkyl group such as ethyl, n-propyl, i-propyl, n-butyl, sec-butyl, t-butyl, n-pentyl and phenyl. R⁵ represents the same C₁-C₁₀ alkyl group or a C₁-C₁₀ alkoxy group such as methoxy, ethoxy, n-propoxy, i-propoxy, n-butoxy, sec-butoxy and t-butoxy. In the metal chelate compounds, p1, p2, q1, q2, r1 and r2 each represent an integer determined such that the sum of p1 and p2 is 4, the sum of q1 and q2 is 4 and the sum of r1 and r2 is 3.

Specific examples of these metal chelate compounds include zirconium chelate compounds such as tri-n-butoxyethyl acetoacetate zirconium, di-n-butoxybis (ethylacetoacetate)zirconium, n-butoxytris (ethylacetoacetate)zirconium, tetrakis(n-propyl acetoacetate)zirconium, tetrakis(acetylaceto acetate)zirconium and tetrakis(ethylacetoacetate) zirconium, titanium chelate compounds such as diisopropoxy bis(ethylacetoacetate)titanium, diisopropoxy bis(acetylacetate)titanium and diisopropoxy bis(acetylacetone)titanium, and aluminum chelate compounds such as diisopropoxy ethyl acetoacetate aluminum, diisopropoxyacetyl acetonate aluminum, isopropoxy bis(ethylacetoacetate) aluminum, isopropoxy bis(acetylacetonate)aluminum, tris(ethylacetoacetate)aluminum, tris(acetyl acetonate)aluminum and monoacetyl acetonate bis(ethyl acetoacetate)aluminum.

Preferred among these metal chelate compounds are tri-n-butoxyethyl acetoacetate zirconium, diisopropoxy bis(acetylacetonate)titanium, diisopropoxyethyl acetoacetate aluminum, and tris (ethylacetoacetate)aluminum. These metal chelate compounds may be used singly or in admixture of two or more thereof. Further, these metal chelate compounds may be used in the form of partial hydrolyzate.

The metal chelate compound is used in a proportion of preferably from 0.01% to 50% by mass, more preferably from 0.1% to 50% by mass, even more preferably from 0.5% to 10% by mass based on the amount of the aforementioned organosilane. When the metal chelate compound is used in the above defined proportion, the condensation reaction of the organosilane compound proceeds fast to provide a coat layer having a good durability. Further, the resulting composition comprising a hydrolyzate and partial condensate of organosilane compound and a metal chelate compound exhibits a good storage stability.

The coating solution to be used in the invention preferably comprises at least any of a β-diketone compound and a β-ketoester compound incorporated therein besides the aforementioned composition comprising a sol component and a metal chelate compound. This will be further described hereinafter.

In the invention, any of a β-diketone compound and β-ketoester compound represented by the general formula R⁴COCH₂COR⁵ is used. The β-diketone compound and β-ketoester compound each act as a stability improver for the composition to be used in the invention. It is thought that these compounds are coordinated to the metal atoms in the aforementioned metal chelate compound (any of zirconium, titanium and aluminum compounds) to inhibit the effect of these metal chelate compounds of accelerating the condensation reaction of the hydrolyzate and partial condensate of organosilane compound and hence enhance the storage stability of the composition thus obtained. R⁴ and R⁵ constituting the β-diketone compound and β-ketoester compound have the same meaning as R⁴ and R⁵ constituting the aforementioned metal chelate compounds.

Specific examples of the β-diketone compound and β-ketoester compound include acetyl acetone, methyl acetoacetate, ethyl acetoacetate, n-propyl acetoacetate, i-propyl acetoacetate, n-butyl acetoacetate, sec-butyl acetoacetate, t-butyl acetoacetate, 2,4-hexane-dione, 2,4-heptane-dione, 3,5-heptane-dione, 2,4-octane-dione, 2,4-nonane-dione, and 5-methyl-hexane-dione. Preferred among these β-diketone compounds and β-ketoester compounds are ethyl acetoacetate and acetyl acetone. These β-diketone compounds and β-ketoester compounds may be used singly or in admixture of two or more thereof. In the invention, the β-diketone compound and β-ketoester compound each are preferably used in an amount of 2 mols or more, more preferably from 3 to 20 mols per mol of the metal chelate compound. When the amount of the β-diketone compound and β-ketoester compound to be used is 2 mols or more, it is prevented that the resulting composition can exhibit a deteriorated storage stability to disadvantage, thus preferred.

The content of the aforementioned hydrolyzate and partial condensate of organosilane compound is preferably small in the case where it is incorporated in the anti-reflection layer, which is relatively thin, but is preferably great in the case where it is incorporated in the hard coat layer or anti-glare layer, which is relatively thick. Taking into account the development of effect, refractive index, shape and surface conditions of film, etc., the content of the aforementioned hydrolyzate and partial condensate of organosilane compound is preferably from 0.1% to 50% by mass, more preferably from 0.5% to 30% by mass, most preferably from 1% to 15% by mass based on the total solid content in the layer in which it is incorporated.

The amount of the sol component to be incorporated in the layers other than the low refractive layer is preferably from 0.001 to 50% by mass, more preferably from 0.01 to 20% by mass, even more preferably 0.05 to 10% by mass, particularly from 0.1 to 5% by mass based on the total solid content of the layer in which it is incorporated. In the case of hard coat layer, the limitation on the added amount of organosilane compound or sol component thereof is not so severe as in the low refractive layer. Therefore, the aforementioned organosilane compound is preferably used.

The refractive index of the bulk of the mixture of light-transmitting resin and light-transmitting particulate material is preferably from 1.48 to 2.00, more preferably from 1.50 to 1.80. In order to predetermine the refractive index of the bulk of the mixture of light-transmitting resin and light-transmitting particulate material within the aforementioned range, the kind and mixing proportion of the light-transmitting resin and the light-transmitting particulate material may be properly selected. The method of selecting these factors can easily be previously known experimentally.

The difference in refractive index between the light-transmitting resin and the light-transmitting particulate material (refractive index of light-transmitting particulate material—refractive index of light-transmitting resin) is from 0.02 to 0.2, preferably from 0.05 to 0.15. When the difference falls within the above defined range, the resulting internal scattering effect is sufficient, making it possible to prevent glittering. Further, the surface of the film doesn't become cloudy. The refractive index of the aforementioned light-transmitting resin is preferably from 1.45 to 2.00, more preferably from 1.48 to 1.70.

The refractive index of the aforementioned light-transmitting resin can be directly measured by an Abbe's refractometer or quantitatively evaluated by measuring spectral reflection spectrum or spectral ellipsometry.

The hard coat layer-forming coating composition may comprise either or both of a fluorine-based surface active agent and a silicone-based surface active agent incorporated therein to assure uniformity in surface conditions such as coating uniformity, drying uniformity and point defect. In particular, a fluorine-based surface active agent is preferably used in a smaller amount because it can exert an effect of eliminating defects in surface conditions such as coating unevenness, drying unevenness and point defect. In this manner, the hard coat layer-forming coating composition can be rendered adaptable to high speed coating while enhancing the uniformity in surface conditions so as to enhance the productivity.

<High (Middle) Refractive Layer>

The anti-reflection film of the invention preferably comprises a high refractive layer and/or a low refractive layer provided therein to have better anti-reflection properties. The refractive index of the high refractive layer in the anti-reflection film of the invention is preferably from 1.60 to 2.40, more preferably from 1.70 to 2.20. The refractive index of the middle refractive layer is adjusted so as to fall in between that of the low refractive layer and that of the high refractive layer. The refractive index of the middle refractive layer is preferably from 1.55 to 1.80. The haze of the high refractive layer and the middle refractive layer are each preferably 3% or less. The refractive index of these layers may be properly adjusted by adjusting the amount of the inorganic filler or binder.

[Inorganic Filler]

The high (middle) refractive layer preferably comprises an inorganic filler composed of oxide of at least one of metals such as titanium, zirconium, aluminum, indium, zinc, tin and antimony having an average particle diameter of 0.2 μm or less, preferably 0.1 μm or less, even more preferably 0.06 μm or less incorporated therein to enhance the refractive index thereof.

On the contrary, in order to increase the difference in refractive index from the mat particles contained in the high (middle) refractive layer, the high (middle) refractive layer comprising a high refractive mat particles incorporated therein preferably comprises a silicon oxide incorporated therein for keeping the refractive index thereof low. The preferred particle diameter of the silicon oxide is the same as that of the aforementioned hard coat layer.

Specific examples of the inorganic filler to be incorporated in the high (middle) refractive layer include TiO₂, ZrO₂, Al₂O₃, In₂O₃, ZnO, SnO₂, Sb₂O₃, ITO, and SiO₂. Particularly preferred among these inorganic fillers are TiO₂ . and ZrO₂ from the standpoint of enhancement of refractive index. These inorganic fillers are preferably subjected to silane coupling treatment or titanium coupling treatment on the surface thereof. A surface treatment having a functional group reactive with a binder seed on the surface of filler is preferably used.

The added amount of these inorganic fillers is adjusted according to desired refractive index and, if incorporated in the high refractive layer, is preferably from 10 to 90%, more preferably from 20 to 80%, particularly from 30 to 70% based on the total mass of the high refractive layer.

The inorganic filler has a sufficiently smaller particle diameter than the wavelength of light and thus is not scattered. Thus, a dispersion of the filler in a binder polymer behaves as an optically uniform material.

[Binder Precursor, Etc.]

The high (middle) refractive layer to be used in the invention is preferably formed by adding preferably a binder precursor necessary for the formation of matrix (e.g., monomer having two or more ethylenically unsaturated groups described above with reference to the hard coat layer), a photopolymerization initiator, etc. to the aforementioned dispersion of an inorganic particulate material in a dispersion medium to prepare a coating composition for forming a high refractive layer, spreading the coating solution for high refractive layer over a transparent substrate or a layer on which the high refractive layer is to be formed, and then subjecting the coat layer to curing by crosslinking reaction or polymerization reaction of ionizing radiation-curing compound (e.g., polyfunctional monomer or polyfunctional oligomer).

The polymerization of the photopolymerizable polyfunctional monomer is preferably effected in the presence of a photopolymerization initiator. As the photopolymerization initiator there is preferably used a photoradical polymerization initiator or photocation polymerization initiator, particularly photocation polymerization initiator. As the photoradical polymerization initiator there may be used the same material as mentioned above with reference to low refractive layer. Alternatively, a photosensitizer may be used. As the photosensitizer there may be the same material as mentioned above with reference to film-forming binder.

The high (middle) refractive layer may comprise a resin, a surface active agent, an antistatic agent, a coupling agent, a thickening agent, a coloration inhibitor, a colorant (e.g., pigment, dye), an anti-glare particulate material, an anti-foaming agent, a leveling agent, a fire retardant, an ultraviolet absorber, an infrared absorber, an adhesion-providing agent, a polymerization inhibitor, an oxidation inhibitor, a surface modifier, an electrically-conductive particulate metal, etc. incorporated therein besides the aforementioned components (e.g., inorganic filler, polymerization initiator, photosensitizer).

The thickness of the high (middle) refractive layer may be properly designed depending on the purpose. In the case where the high (middle) refractive layer is used as an optical interference layer, the thickness of the high (middle) refractive layer is preferably from 30 to 200 nm, more preferably from 50 to 170 nm, particularly from 60 to 150 nm.

The average reflectance of the anti-reflection film is preferably from 0.1 to 2.5%, more preferably from 0.2 to 2%, most preferably from 0.3 to 1.5%. When the average reflectance of the anti-reflection film falls within the above defined range, the reflection of background by the screen can be sufficiently prevented to advantage. In order to reduce the average reflectance of the anti-reflection film, it is preferred that a plurality of layers having different refractive indexes be laminated.

<Transparent Substrate>

As the transparent substrate for the optical film and anti-reflection film of the invention there is preferably used a plastic film. Examples of the polymer constituting the plastic film include cellulose acylates {e.g., cellulose triacetate, cellulose diacetate, cellulose acetate propionate, cellulose acetate butyrate; Representative examples of these cellulose acylates include “Fujitac TD80U” and “Fujitac TD80UF”, produced by Fuji Photo Film Co., Ltd.}, polyamides, polycarbonates, polyesters (e.g., polyethylene terephthalate, polyethylene naphthalate), polystyrenes, polyolefins, norbornene-based resins {“Arton” (trade name), produced by JSR Co., Ltd.}, and amorphous polyolefins {“Zeonex” (trade name), produced by ZEON CORPORATION}. Preferred among these polymers are triacetyl cellulose, polyethylene terephthalate, and polyethylene naphthalate. Particularly preferred among these polymers is triacetyl cellulose. For the details of cellulose acylate film substantially free of halogenated hydrocarbon such as dichloromethane and its production method, reference can be made to Japan Institute of Invention and Innovation's Kokai Giho No. 2001-1745, (issued on Mar. 15, 2001 hereinafter referred to as Kokai Giho No. 2001-1745). The cellulose acylates disclosed in this reference can be preferably used in the invention.

[Saponification Treatment]

In order to use the anti-reflection film of the invention in a liquid crystal display device, the anti-reflection film is disposed on the outermost surface of the display with a bonding-aid layer provided on one side of the anti-reflection film. Further, the anti-reflection film of the invention may be used in combination with a polarizing plate. In the case where the transparent substrate is a triacetyl cellulose, as a protective film for protecting the polarizing layer of the polarizing plate there is normally used a triacetyl cellulose film. Therefore, the anti-reflection film of the invention is preferably used as a protective film from the standpoint of cost.

In order to dispose the anti-reflection film of the invention on the outermost surface of a display with a bonding-aid layer provided on one side thereof or use the anti-reflection film of the invention as a protective film for polarizing plate, it is preferred that the anti-reflection film of the invention be subjected to saponification with an outermost layer mainly composed of a fluorine-containing polymer formed thereon to make sufficient bonding. The saponification is carried out by any known method, e.g., dipping the anti-reflection film in an alkaline solution for a proper period of time. It is preferred that the anti-reflection film which has been dipped in the alkaline solution be thoroughly washed with water or dipped in a dilute acid to neutralize the alkaline component so that the alkaline component is not left in the film.

When the anti-reflection film is saponified, the transparent substrate is hydrophilicized on the side thereof opposite the outermost layer of the anti-reflection layer. The hydrophilicized surface of the transparent substrate is effective for the improvement of the adhesion to the polarizing layer mainly composed of polyvinyl alcohol. Further, the hydrophilicized surface of the transparent substrate can little attract dust in the air. Therefore, dust can difficultly enter the gap between the polarizing layer and the anti-reflection film during bonding to the polarizing layer. Thus, the hydrophilicized surface of the transparent substrate is effective for the prevention of occurrence of point defects due to dust.

The saponification is preferably effected in such a manner that the contact angle of the surface of the transparent substrate on the side thereof opposite the outermost layer with respect to water is 40° or less, more preferably 30° or less, particularly 20° or less.

As a specific method of alkaline saponification there may be selected from the following two methods (1) and (2). The method (1) is advantageous in that it allows processing at the same step as general-purpose triacetyl cellulose film. However, the method (1) can be disadvantageous in that since the anti-reflection film can be saponified up to the anti-reflection layer, the surface of the anti-reflection layer is subjected to alkaline hydrolysis, causing the deterioration of the anti-reflection layer or stain with the saponifying solution, if left. In this case, the method (2) is better, although it requires a special process.

(1) The anti-reflection film which has been provided with an anti-reflection layer on the transparent substrate is dipped in an alkaline solution at least once to saponify the back side thereof.

(2) Before or after the formation of an anti-reflection film on the transparent substrate, an alkaline solution is spread over the anti-reflection film on the side thereof opposite the anti-reflection layer. The anti-reflection film is heated, and then washed with water and/or neutralized to saponify only the back side thereof.

<Method of Forming Coat Layer>

The optical film and anti-reflection film of the invention can be formed by the following method, but the invention is not limited thereto.

[Production of Optical Film and Anti-Reflection Film]

The various layers constituting the optical film and anti-reflection film of the invention can be formed by dissolving the coating compositions for the various layers in the coating dispersing medium described later to prepare coating solutions, and then spreading the coating solutions using coating methods such as dip coating method, air knife coating method, curtain coating method, roller coating method, wire bar coating method, gravure coating method and die coating method (e.g., extrusion coating method (disclosed in U.S. Pat. No. 2,681,294)), slot coating method), preferably die coating method. More preferably, coating is effected using a die coater described later at the coating step. Two or more coating solutions may be simultaneously spread. The simultaneous coating may be carried out using a method as disclosed in U.S. Pat. Nos. 2,761,791, 2,941,898, 3,508,947 and 3,526,528, and Yuji Harasaki, “Coating Engineering”, page 253, Asakura Shoten, 1973 without any special limitation.

The optical film and anti-reflection film of the invention comprises at least two ionizing radiation-curing layers laminated therein and shows remarkable bright point defects when foreign matters such as dust are present therein. The term “bright point defect” as used herein is meant to indicate defect that can be visually observed on the coat layer during reflection. The bright point defect can be visually detected by a treatment such as black-painting the back side of the optical film or anti-reflection film thus formed. The bright point defects that can be visually observed normally have a size of 50 μm or more.

The number of bright point defects on the optical film and anti-reflection film of the invention is preferably 20 or less, more preferably 10 or less, even more preferably 5 or less, particularly 1 or less per m². When the number of bright point defects falls within the above defined range, it is advantageous in yield during production. Further, a large area optical film and anti-reflection film can be produced without any problems to advantage.

In order to continuously produce the optical film and anti-reflection film of the invention, there are effected a step of continuously feeding the transparent substrate (web) from the roll, a step of spreading the coating solution over the web, a step of drying the coat layer, a step of curing the coat layer and a step of winding the web having a cured layer.

The web is continuously fed from the roll into a clean chamber where the electrostatically charged web is then destaticized by an electrostatic destaticizer and then freed of foreign matters by a dust removing device. Subsequently, a coating solution is spread over the web in a coating zone disposed in the clean chamber. The web thus coated is fed into a drying chamber where it is then dried. The web having a dried coat layer is fed from the drying chamber into a radiation curing chamber where it is then irradiated with radiation so that the curable resin contained in the coat layer is polymerized and cured. Subsequently, the web having a radiation-cured layer is fed into a heat-curing zone where it is then heated to complete curing. The web having a fully-cured layer is then wound to form a roll.

The aforementioned various steps may be effected for each of the formation of various layers. A plurality of coating zones, drying chambers, radiation curing zones and heat curing chambers may be provided so that the formation of various layers are continuously effected. However, the various layers are preferably continuously effected from the standpoint of productivity.

[Producing Device]

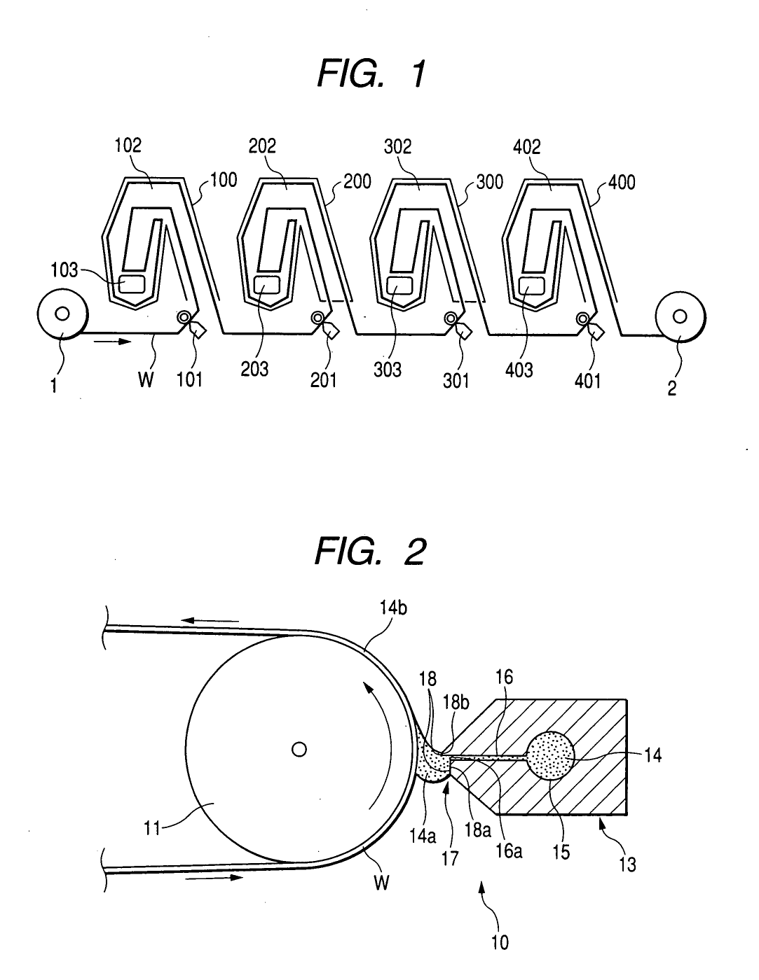

The invention will be further described with reference to an embodiment of the producing device shown in FIG. 1 which is preferably used in the invention.

FIG. 1 is a schematic diagram illustrating an embodiment of the producing device to be used in the invention.

The producing device shown in FIG. 1 comprises a web W which is continuously fed at the aforementioned step and a roll 1 thereof, a plurality of guide rollers (not shown), a winding roll 2 for effecting the aforementioned winding step and a necessary number of film-making units 100, 200, 300 and 400 for effecting the aforementioned coating step, drying step and coat layer curing step. An anti-reflection film which is a representative example of the optical film produced according to the invention will be described as an example of the present embodiment. The film-making unit 100 is adapted to form a hard coat layer. The film-making unit 200 is adapted to form a middle refractive layer. The film-making unit 300 is adapted to form a high refractive layer. The film-making unit 400 is adapted to form a low refractive layer.

Since the various film-making units have the same configuration, only the film-making unit 100 will be described on behalf of the film-making units. The film-making unit 100 comprises a coating zone 101 for effecting the aforementioned coating solution coating step, a drying zone 102 for effecting the aforementioned step of drying the coating solution thus spread and a curing device 103 for effecting the aforementioned step of curing the coating solution thus dried.

The device shown in FIG. 1 is an example of the configuration for use in the continuous spreading of four coating solutions without winding, but the number of film-making units may be, of course, changed according to the layer configuration.

More preferably, the web having a hard coat layer formed thereon is continuously fed from the roll into a device comprising three film-making units where a hard coat layer, a high refractive layer and a low refractive layer are sequentially formed thereon, and then wound. Even more preferably, the web is continuously fed from the roll into the device comprising four film-making units shown in FIG. 1 where a hard coat layer, a middle refractive layer, a high refractive layer and a low refractive layer are sequentially formed thereon, and then wound.

Among the aforementioned coating methods, microgravure coating method is preferably used. At least two ionizing radiation-curing layers of the invention, too, may be produced by microgravure coating method. In this manner, a good crosswise distribution of spread can be obtained. Further, good surface conditions can be obtained against various defects in surface conditions. A satisfactory longitudinal spread distribution can be obtained by optimizing the material, shape and other factors of the metal blade for scraping off the coat layer.

On the other hand, die coating method (e.g., extrusion coating method, slot coating method) is preferably used from the standpoint of enhancement of production speed. The die coating method can attain both high productivity and surface conditions free of coating unevenness at a high order and thus can be used to advantage.

In the invention, as a method of producing an anti-reflection film there is preferably used the following producing method of the invention involving such a die coating method.

In other words, there is preferably used a method of producing an anti-reflection comprising a coating step of spreading a coating solution over the surface of a web which is being continuously running while being supported on a backup roll through the slot of the forward end lip of a slot due the land of which is disclosed close thereto wherein any one or both of coating solutions corresponding to the layers A and B is spread using a coating device arranged such that the length of the land of the forward end lip of the slot die on the forward side thereof in the web running direction is from not smaller than 30 μm to not greater than 100 μm and the gap between the forward end lip on the side thereof opposite the forward side and the web is from not smaller than 30 μm to 120 μm greater than the gap between the forward end lip on the forward side thereof and the web (This numerical limitation will be hereinafter referred to as “overbite length”) when the slot die is set at the coating position.

The producing method of the invention will be further described hereinafter with reference to die coater which can be preferably sued in the producing method of the invention in connection with the attached drawings. The die coater can be used to provide a smaller wet spread (20 ml/m² or less) to advantage.

(Configuration of Die Coater)

FIG. 2 is a sectional view of a coater (coating device) comprising a slot die that can fairly embody the invention.

The coater 10 comprises a backup roll 11 and a slot die 13. A coating solution 14 is ejected in the form of bead 14a through the slot die 13 onto the web W which is being continuously running while being supported on the backup roll 11 to form a coat layer 14b on the web W.

The slot die 13 has a pocket 15 and a slot 16 formed therein. The pocket 15 has a section formed by a curve and a straight line. The section may be substantially circular or semicircular. The pocket 15 is a coating solution reservoir space extending in the crosswise direction of the slot die 13 with its sectional shape (The crosswise direction of the slot die 13 indicates the forward or rear direction perpendicular to the paper on FIG. 2). The effective length of extension of the space is normally equal to or somewhat longer than the coating width. The supply of the coating solution 14 into the pocket 15 is conducted on the side of the slot die 13 or on the center of the side of the slot die 13 opposite the slot opening 16a. The pocket 15 comprises a plug (not shown) provided therein for preventing the leakage of the coating solution 14″.

The slot 16 is a channel for the coating solution 14 from the pocket 15 to the web W. The channel has a sectional shape extending in the crosswise direction of the slot die 13 as in the pocket 15. The width of the opening 16a disposed on the web side of the channel is normally adjusted to a value substantially equal to the coating width by a width limiting plate (not shown). The angle of the forward end of the slot 16 with respect to the line normal to the surface of the backup roller 11 in the running direction of the web W is preferably from not smaller than 30° to not greater than 90°.

The forward end lip 17 of the slot die 13 at which the opening 16a of the slot 16 is disposed is convergent. The forward end of the lip 17 forms a flat portion 18 called land. In the land 18, the portion disposed upstream from the slot 16 along the running direction of web W (running direction, i.e., direction opposite the arrow in the drawing) is called upstream lip land 18a. The portion disposed downstream from the slot 16 along the running direction of web W (running direction) is called downstream lip land 18b.

The gap between the upstream lip land 18a and the web W is greater than the gap between the downstream lip land 18b and the web W by the above defined range. The length of the downstream lip land 18b is as defined above.

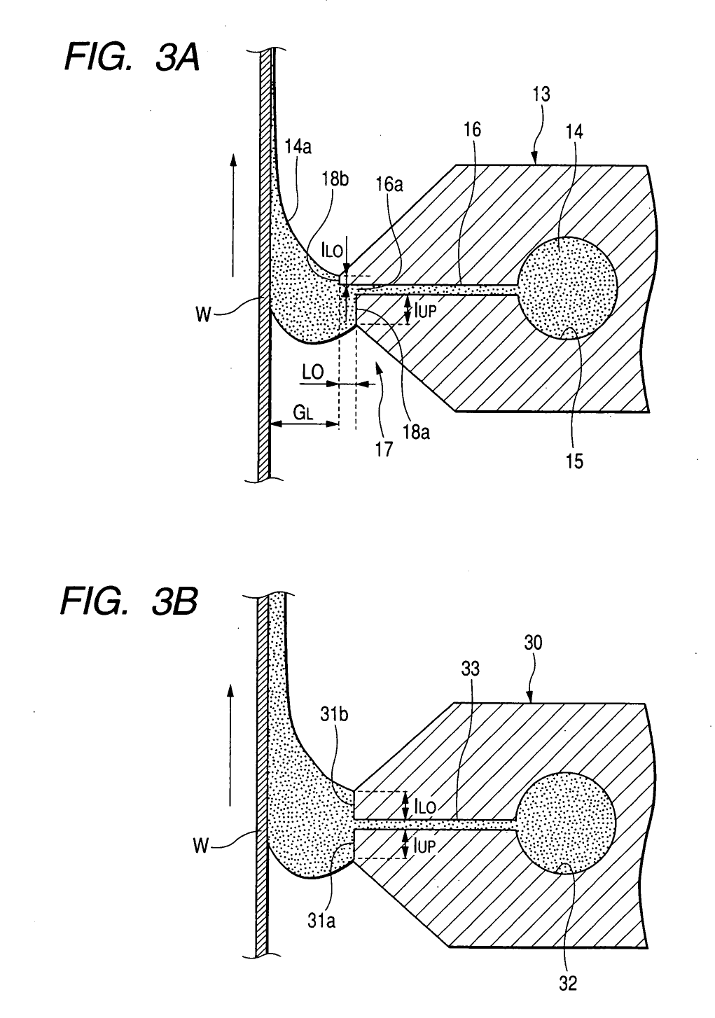

Explaining the site concerning the aforementioned numerical limitation with reference to FIG. 3A, the length of the land on the web running direction side thereof is the portion shown by I_{L0} in FIG. 3A. The length of the aforementioned overbite is the portion shown by LO in FIG. 3.

The coating device to be used in the implementation of the method of producing an anti-reflection film of the invention and a related art coating device will be compared with each other in connection with FIG. 3. FIG. 3 illustrates the comparison of the sectional shape of the slot die 13 with that of the related art slot die wherein FIG. 3A indicates the slot die 13 of the invention and FIG. 3B indicates a related art slot die 30.

In the related art slot die 30, the distance between the upstream lip land 31a and the web W and the distance between the downstream lip land 31b and the web W are the same as each other. In FIG. 3B, the reference numeral 32 indicates a pocket and the reference numeral 33 indicates a slot. In the slot die 13 of the invention, on the contrary, the length I_{LO} of the downstream lip land is shorter than the length of the upstream lip land. In this arrangement, spreading can be conducted to a wet thickness of 20 μm or less with a good precision.

The length I_{UP} of the upstream lip land 18a is not specifically limited but is preferably from 500 μm to 1 mm. The length I_{LO} of the downstream lip land 18b is preferably from not smaller than 30 μm to not greater than 100 μm, more preferably from not smaller than 30 μm to not greater than 80 μm, most preferably from not smaller than 30 μm to not greater than 601m. When the length I_{LO} of the downstream lip land is not smaller than 30 μm, the edge or land of the forward lip can difficultly break off, making it possible to prevent the occurrence of streak on the coat layer to advantage. Further, the wet line position on the downstream side can be easily predetermined. Moreover, the spread of the coating solution on the downstream side can be inhibited to advantage. The expansion of wet by the coating solution on the downstream side means unevenness in wet line and results in the occurrence of defective shapes such as streak on the coat layer. On the contrary, when the length I_{LO} of the downstream lip land is not more than 100 μm, the bead 14a can be formed. When the coating solution forms the bead 14a, thin layer spreading can be effected.

Further, the downstream lip land 18b has an overbite configuration such that it is disposed closer to the web W than the upstream lip land 18a. In this arrangement, the degree of vacuum can be reduced to form a bead 14a suitable for thin layer spreading. The difference in distance from the web W between the downstream lip land 18b and the upstream lip land 18a (hereinafter referred to as “overbite length LO”) is preferably from not smaller than 30 μm to not greater than 120 μm, more preferably from not smaller than 301m to not greater than 100 μm, most preferably from not smaller than 30 μm to not greater than 80 μm. When the slot die 13 has an overbite configuration, the gap G_{L} between the forward end lip 17 and the web W indicates the gap between the downstream lip land 18b and the web W.

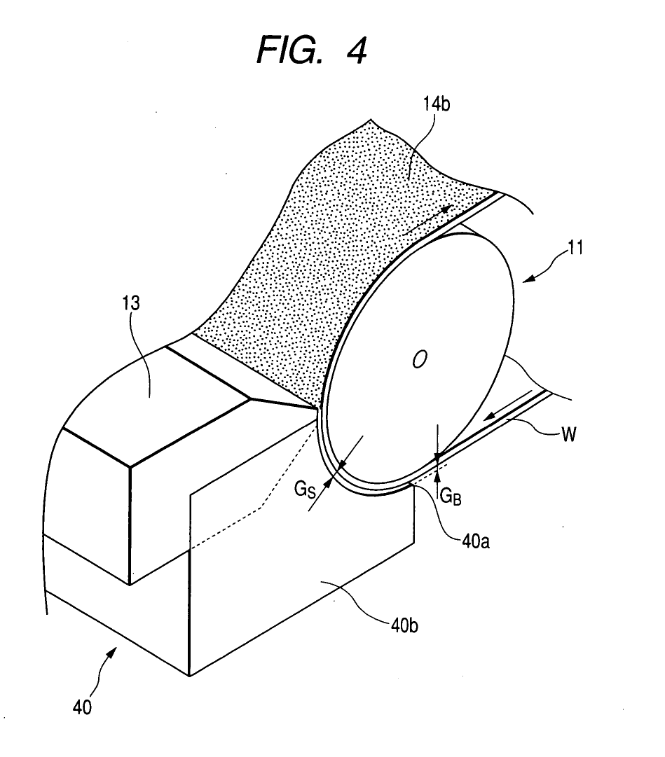

The aforementioned coating step will be generally described hereinafter in connection with FIG. 4.

FIG. 4 is a perspective view illustrating a slot die 13 used at the coating step in the implementation of the invention and its periphery. Disposed on the side of the slot die opposite the side on which the web W is running is a pressure-reducing chamber 40 at a position where it doesn't come in contact with the slot die such that sufficient adjustment of pressure reduction can be made on the bead 14a. The pressure-reducing chamber 40 comprises a back plate 40a and a side plate 40b for maintaining the operating efficiency. There are present gaps G_{B} and G_{S} between the back plate 40a and the web W and between the side plate 40b and the web W, respectively.

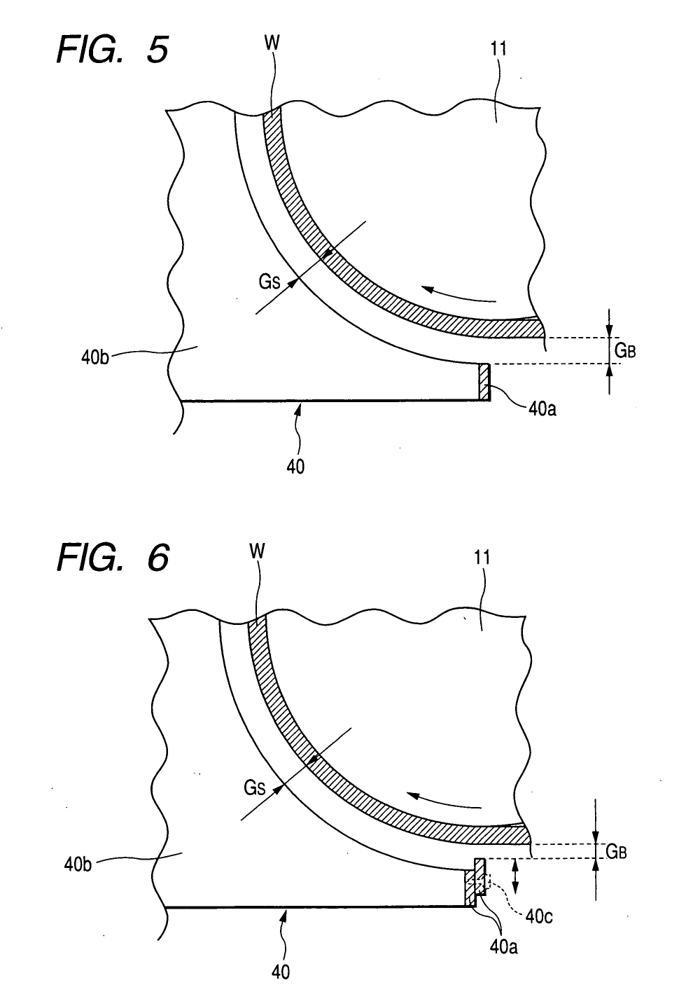

The relationship between the pressure-reducing chamber 40 and the web W will be described hereinafter in connection with FIGS. 5 and 6. FIGS. 5 and 6 each are a sectional view illustrating the pressure-reducing chamber 40 and the web W which are disposed close to each other.

The side plate 40b and the back plate 40a may be formed integral with the chamber as shown in FIG. 5 or may be fixed to the chamber 40 with a screw 40c so that the gap G_{B} can be properly varied as shown in FIG. 6. Regardless of the configuration, the actual space between the back plate 40a and the web W and between the side plate 40b and the web W are defined to be G_{B} and G_{S}, respectively. The gap G_{B} between the back plate 40a and the web W in the pressure-reducing chamber 40 indicates the gap between the uppermost end of the back plate 40a and the web W in the case where the pressure-reducing chamber 40 is disposed beneath the web W and the slot die 13 as shown in FIG. 4.

The arrangement is preferably made such that the gap G_{B} between the back plate 40a and the web W is larger than the gap G_{L} between the forward end lip 17 of the slot die 13 and the web W (see FIG. 3). In this arrangement, the change of the degree of vacuum in the vicinity of bead attributed to the eccentricity of the backup roller 11 can be inhibited. For example, when the gap G_{L} between the forward end lip 17 of the slot die 13 and the web W is from not smaller than 30 μm to not greater than 100 μm, the gap G_{B} between the back plate 40a and the web W is preferably predetermined to be from not smaller than 100 μm to not greater than 500 μm.

(Material, Precision)

The length of the land of the forward end lip of the slot die on the forward side thereof in the web running direction (length I_{LO} of downstream lip land shown in FIG. 3A) preferably falls within the above defined range. The change of I_{LO} in the crosswise direction of slot die is preferably not greater than 20 μm. When these factors fall within these ranges, the bead can be prevented from becoming unstable even due to slight disturbance to advantage.

Referring to the material of the forward end lip of the slot die, a material such as stainless steel undergoes sagging during die machining to disadvantage. When a stainless steel or the like is used, the desired precision of the forward end lip can be difficultly satisfied even if the length I_{L0} of the forward end lip of the slot die on the downstream side is from 30 to 100 μm previously mentioned. In order to maintain a high working precision, it is preferred to use an ultrahard material as disclosed in Japanese Patent No. 2,817,053. In some detail, at least the forward end lip of the slot die is preferably made of an ultrahard alloy comprising carbide crystals having an average particle diameter of 5 μm or less bonded thereto. Examples of the ultrahard alloy include those obtained by bonding carbide crystallites such as tungsten carbide (hereinafter referred to as “WC”) with a binding metal such as cobalt. As the binding metal there may be used titanium, tantalum, niobium or mixture thereof besides cobalt. The average particle diameter of WC crystallites is more preferably 3 μm or less.

In order to realize a high precision spreading, the aforementioned length I_{L0} of the lip land on the downstream side is important. Further, the change of the gap G_{L} in the crosswise direction of slot die is preferably controlled. The backup roll 11 and the forward eng lip 17 are preferably arranged to attain a straightness such that the change of the gap in the crosswise direction of the slot die can be controlled. Preferably, the straightness of the forward end lip 17 with respect to the backup roller 11 is attained such that the change of the gap in the crosswise direction of the slot die is not greater than 5 μm.

In order to prepare an optical film and anti-reflection film having as little bright point defects as falling within the above defined range, the dispersion of filler, particulate material, etc. in the coating composition for layers A and B may be controlled and the coating solution may be precision-filtered. At the same time, the coating solutions for the various layers constituting the anti-reflection layer are preferably subjected to spreading at the coating step in the aforementioned coating zone and drying at the drying step in the drying chamber in an air atmosphere having a high cleanness. Before spreading, the film is preferably thoroughly freed of dust. The cleanness of the air at the coating step and the drying step is preferably Class 10 (353 or less particles having a size of 0.5 μm or more per m³) or more, more preferably Class 1 (35.5 or less particles having a size of 0.5 μm or more per m³) or more according to air cleanness specification of US Federal Standard 209E. Further, the air cleanness is preferably high also in the feeding zone and winding zone of the steps other than coating/drying steps.

Examples of the destaticizing method to be used at the destaticizing step which is effected prior to coating include dry destaticizing methods such as method which comprises pressing a nonwoven cloth, blade or the like against the surface of the film as disclosed in JP-A-59-150571, method which comprises blowing air having a high cleanness onto the surface of the film to peel foreign matters off the film and sucking the foreign matters from a suction port disclosed close to the film as disclosed in JP-A-10-309553, and method which comprises blowing supersonically oscillated compressed air onto the surface of the film to peel foreign matters off the film and sucking the foreign matters as disclosed in JP-A-7-333613 (New Ultracleaner, produced by SHiNKO CO., LTD.).

Alternatively, there may be used a wet destaticizing method such as method which comprises introducing the film into a cleaning tank where it is then freed of foreign matters by an ultrasonic vibrator, method which comprises supplying a cleaning solution onto the film and then blowing high speed air onto the film and sucking the air as disclosed in JP-A-49-13020 and method which comprises continuously rubbing the web with a roll wet with a liquid, and then spraying a liquid onto the rubbed surface of the web to clean the web as described in JP-A-2001-38306. Preferred among these destaticizing methods are ultrasonic destaticizing method and wet destaticizing method from the standpoint of destaticizing effect.

It is particularly preferred that the supporting film be electrostatically destaticized before being thus subjected to destaticizing step to enhance the destaticizing effect and inhibit the attraction of dust. For the destaticizing method, a corona discharge type ionizer, an ionizer capable of emitting light rays such as UV and soft X-ray, etc. may be used. The triboelectric voltage of the support film before and after dusting and coating is preferably 1,000 V or less, preferably 300 V or less, particularly 100 V or less.

[Coating Dispersing Medium]

The coating dispersing medium to be used in the aforementioned coating solution is not specifically limited. Coating dispersing media may be used singly or in admixture of two or more thereof. Preferred examples of dispersing medium include aromatic hydrocarbons such as toluene, xylene and styrene, chlorinated aromatic hydrocarbons such as chlorobenzene and ortho-dichlorobenzene, chlorinated aliphatic hydrocarbons such as methane derivative (e.g., monochloromethane) and ethane derivative (e.g., monochloroethane), alcohols such as methanol, isopropyl alcohol and isobutyl alcohol, esters such as methyl acetate and ethyl acetate, ethers such as ethyl ether and 1,4-dioxane, ketones such as acetone, methyl ethyl ketone, methyl isobutyl ketone and cyclohexanone, glycol ethers such as ethylene glycol monomethyl ether, alicyclic hydrocarbons such as cyclohexane, aliphatic hydrocarbons such as normal hexane, and mixture of aliphatic or aromatic hydrocarbons. Among these ketones, a coating dispersing medium prepared by ketones, singly or in admixture of two or more thereof. In the case where spreading is effected using a die coating method, the coating dispersing medium is preferably used in such a manner that the following liquid physical properties can be attained with respect to the solid component of the various layer-forming compositions.

[Physical Properties of Coating Solution]

In the coating process in the producing method of the invention, it is preferred that the liquid physical properties at the moment of spreading, particularly viscosity and surface tension, be controlled. By properly controlling the liquid physical properties, the upper limit of speed at which the coating solution can be spread can be raised to advantage. Further, the spread of the coating solution over the surface of the web can be properly controlled as described later to raise the upper limit of speed at which the coating solution can be spread to advantage.

The viscosity of the aforementioned coating solution during spreading is preferably 2.0 mPa·sec or less, more preferably 1.5 mPa·sec or less, most preferably 1.0 mPa·sec or less. Some coating solutions may change in its viscosity with shearing rate. Therefore, the aforementioned viscosity value indicates the viscosity at the shearing rate developed at the moment of spreading. A coating solution comprising a thixotropic agent incorporated therein exhibits a low viscosity during spreading, at which a high shearing is developed, and a high viscosity during drying, at which little or no shearing is developed. Thus, there can occur little drying unevenness to advantage.

The spread of the coating solution over the surface of the web is preferably from 2.0 to 5.0 ml/m². When the spread of the coating solution falls within the above defined range, the upper limit of speed at which the coating solution can be spread can be raised to advantage. This is advantageous also in the reduction of drying burden. The optimum spread of the coating solution over the surface of the web is preferably determined depending on the liquid formulation and coating conditions.

The surface tension of the coating solution is preferably from 15 to 36 mN/m. When the surface tension of the coating solution falls within the above defined range, the occurrence of drying unevenness can be prevented to advantage. The surface tension of the coating solution is more preferably from 17 to 32 mN/m, particularly from 19 to 26 mN/m. When the surface tension of the coating solution falls within the above defined range, the drop of the upper limit of speed at which the coating solution can be spread can be prevented to advantage. The surface tension of the coating solution can be controlled by the incorporation of a leveling agent.

In the producing method of the invention, the aforementioned coating solution is preferably spread at a rate of 25 m/min or more over the surface of the web which is being continuously running.

[Filtration]

The coating solution to be spread is preferably filtered before spreading. As the filter for filtration there is preferably used one having a pore diameter as small as possible so far as the components in the coating solution are not removed. For the filtration, a filter having an absolute filtration precision of from 0.1 to 10 μm, preferably from 0.1 to 5 μm is preferably used. The thickness of the filter is preferably from 0.1 to 10 mm, more preferably from 0.2 to 2 mm. In this arrangement, filtration is preferably effected at a pressure of 1.5 MPa or less, more preferably 1.0 MPa or less, even more preferably 0.2 MPa or less.

The filtering member is not specifically limited so far as it has no effects on the coating solution. In some detail, the same filtering material as described with reference to the filtering member for wet dispersion of inorganic compound may be used.

It is also preferred that the coating solution thus filtered be subjected to ultrasonic dispersion shortly before being spread to help defoaming and help keeping the dispersed particles fairly dispersed.

[Formation of Various Layers]

In the case where a plurality of layers are laminated on a transparent substrate, it is preferred from the standpoint of product cost that at least two of the layers to be laminated on the transparent substrate film be formed at one step of feeding the transparent substrate film, forming the various layers and winding the film. More preferably, three of the layers are formed at one step. This producing method can be accomplished by longitudinally providing a plurality of, preferably the same number as that of layers to be laminated or more, sets of coating station and drying/curing zone between the point of feeding and the point of the transparent substrate film in the coating machine.

As previously mentioned, FIG. 1 is a schematic diagram illustrating an example of the device configuration. FIG. 1 illustrate an example of the device configuration comprising a first coating station (101), a first drying zone (102), a first curing device such as UV emitting machine (103), a second coating station (201), a second drying zone (202), a second curing device (203), a third coating station (301), a third drying zone (302), a third curing device (303), a fourth coating station (401), a fourth drying zone (402) and a fourth curing device (403) during one step from feeding the web from the roll (1) to winding at the winding roll (2). As previously mentioned, four functional layers, e.g., hard coat layer, middle refractive layer, high refractive index, low refractive layer can be formed at one step to drastically reduce the coating cost. As another preferred embodiment, there may be optionally provided a device configuration the number of coating stations in which is reduced to 3 whereby three layers, i.e., middle refractive layer, high refractive layer, low refractive layer or hard coat layer, high refractive layer, low refractive layer are formed at one step or the number of coating stations in which is reduced to 2 whereby only two layers, i.e., middle refractive layer, high refractive layer are formed at one step. The results of checking of surface conditions, film thickness, etc. are fed back to raise the yield.

<Polarizing Plate>

A polarizing plate is mainly composed of two sheets of protective film with a polarizing membrane provided interposed therebetween. The anti-reflection film produced according to the invention is preferably used as at least one of the two sheets of protective film between which the polarizing membrane is disposed interposed. When the anti-reflection film acts also as a protective film, the production cost of the polarizing plate can be reduced. Further, when the anti-reflection film of the invention is used as an outermost surface layer, the reflection of external light, etc. can be prevented, making it possible to provide a polarizing plate excellent also in scratch resistance, stainproofness, etc.

As the polarizing layer there may be used a known polarizing layer or a polarizing layer cut out of a polarizing layer of continuous length having an absorption axis which is neither parallel to nor perpendicular to the longitudinal direction. The polarizing layer of continuous length having an absorption axis which is neither parallel to nor perpendicular to the longitudinal direction is prepared by the following method.

This is a polarizing layer stretched by tensing a continuously supplied polymer while being retained at the both ends thereof by a retainer. In some detail, the polarizing layer can be produced by a stretching method which comprises stretching the film by a factor of from 1.1 to 20.0 at least in the crosswise direction in such a manner that the difference in longitudinal progress speed of retainer between at both ends is 3% or less and the direction of progress of film is deflexed with the film retained at the both ends thereof such that the angle of the direction of progress of film at the outlet of the step of retaining both ends of the film with respect to the substantial direction of film stretching is from 20° to 70°. In particular, those obtained under the aforementioned conditions wherein the inclination angle is 45° are preferably used from the standpoint of productivity.

For the details of the method of stretching polymer film, reference can be made to JP-A-2002-86554, paragraphs [0020]-[0030].

<Optical Film>

The aforementioned method of producing an optical film of the invention can be applied to the outermost layer (corresponding to the layer B) and the layer on which the layer B is formed in various optical films. Examples of the optical films to which the producing method of the invention can be applied include an optical film comprising various functional layers laminated on a transparent substrate. Specific examples of the functional layers include antistatic layer, cured resin layer (transparent hard coat layer), bonding-aid layer, anti-glare layer, optical compensation layer, alignment layer, and anti-reflection layer (composed of high refractive layer, middle refractive layer and low refractive layer). These functional layers may be provided in combination. As the anti-reflection layer there may be used one described above with reference to anti-reflection film. Examples of these functional layers in the invention and their materials include surface active agents, lubricants, matting agents, antistatic agents, antistatic layers, and transparent hard coat layers.

JP-A-9-201912 discloses a protective film for polarizing plate which comprise an active ray-curing resin layer provided on one side of a transparent resin film and an anti-curling layer provided on the other side thereof to improve the windability thereof despite the provision of active ray-curing resin layer. This protective film can be used also in the invention.

Further, JP-A-9-203810 discloses a protective film for polarizing plate which comprises an antistatic layer containing an ionically-conductive polymer and a hydrophobic binder provided on one side of a transparent plastic film and a cured film layer formed thereon obtained by irradiating a layer containing an ultraviolet-curing resin composition with ultraviolet rays to attain both scratch resistance and antistatic properties, reduce loss, provide a good yield and reduce cost. This protective film can be used also in the invention.

Moreover, JP-A-2000-352620 discloses that an optical film or protective film for polarizing plate is subjected to antistatic treatment, transparent hard coating, anti-glare treatment, anti-reflection treatment, adhesive treatment or the like or is provided with an alignment layer to have an optical compensation layer whereby it is provided with optical compensation properties. This arrangement can be used also in the invention.

These functional layers and their materials will be further described hereinafter.

(Surface Active Agent)

Surface active agents can be classified into dispersant, coating aid, wetting agent, antistatic agent, etc. These purposes can be accomplished by properly using the following surface active agents. As the surface active agent to be used in the invention there may be used any of nonionic and ionic (anionic, cationic, betaine) surface active agents. Further, a fluorine-containing surface active agent, too, can be preferably used as a coating aid or antistatic agent in an organic solvent. The surface active agent may be used in a cellulose acylate solution or other functional layers. Examples of the functional layer, if the surface active agent is utilized for optical use, include undercoat layer, intermediate layer, alignment control layer, refractive index control layer, protective layer, stainproof layer, bonding-aid layer, back undercoat layer, and back layer. The amount of the surface active agents to be used is not specifically limited so far as it meets the requirements for accomplishment of purpose but is normally preferably from 0.0001 to 5% by mass, more preferably from 0.0005 to 2% by mass based on the mass of the layer in which they are incorporated. In this case, the spread of the surface active agents is preferably from 0.02 to 1,000 mg, more preferably from 0.05 to 200 mg per m².

Preferred examples of the nonionic surface active agent employable herein include surface active agents comprising polyoxyethylene, polyoxypropylene, polyoxybutylene, polyglycidyl or sorbitan as nonionic hydrophilic group. Specific examples of these surface active agents include polyoxyethylene alkyl ether, polyoxyethylene alkyl phenyl ether, polyoxyethylene-polyoxypropylene glycol, polyvalent alcohol fatty acid partial ester, polyoxyethylene polyvalent alcohol fatty acid partial ester, polyoxyethylene fatty acid ester, polyglycerin fatty acid ester, aliphatic acid diethanolamide, and triethanolamine fatty acid partial ester.

Examples of the anionic surface active agent employable herein include carboxylic acid salts, sulfuric acid salts, sulfonic acid salts, and phosphoric acid salts. Representative examples of these anionic surface active agents include aliphatic acid salts, alkylbenzenesulfonic acid salts, alkylnaphthalene sulfonic acid salts, alkylsulfonic acid salts, α-olefinsulfonic acid salts, dialkylsulfosuccinic acid salts, α-sulfonated aliphatic acid salts, N-methyl-N-oleyltaurine, petroleum sulfonic acid salts, alkylsulfuric acid salts, sulfated oil, polyoxyethylene alkyl ether sulfuric acid salts, polyoxyethylene alkyl phenyl ether sulfuric acid salts, polyoxyethylene styrenated phenyl ether sulfuric acid salts, alkylphosphoric acid salts, polyoxyethylene alkyl ether phosphoric acid salts, and naphthalenesulfonic acid salt-formaldehyde condensates.

Examples of the cationic surface active agents employable herein include amine salts, quaternary ammonium salts, and pyridium salts. Specific examples of these cationic surface active agents include primary, secondary and tertiary aliphatic amine salts, and quaternary ammonium salts (e.g., tetraalkylammonium salt, trialkylbenzenylammonium salt, alkylpyridium salt, alkylimidazolium salt). Examples of amphoteric surface active agents include carboxybetaines, and sulfobetaines. Specific examples of these amphoteric active agents include N-trialkyl-N-carboxymethyl ammonium betaine, and N-trialkyl-N-sulfoalkylene ammonium betaine.

For the details of these surface active agents, reference can be made to Takao Karigome, “Kaimen Kasseizai no Oyo (Application of Surface Active Agents)”, Saiwai Shobo, Sep. 1, 1980. In the invention, the surface active agents which can be preferably used are not specifically limited in their amount. They may be used in any amount so far as the desired surface activity can be attained. Specific examples of surface active agents will be given below, but the invention is not limited thereto. (The group —C₆H₄— indicates phenylene group.)

WA-1: C₁₂H₂₅(OCH₂CH₂)₁₀OH

WA-2: C₉H₁₉—C₆H₄—(OCH₂CH₂)₁₂OH

WA-3: Poly(polymerization degree: 20)oxyethylene sorbitan monolaurylphosphoric acid ester

WA-4: Dodecylbenzenesulfonic acid soda

WA-5: Tri(isopropyl)naphthalenesulfonic acid soda

WA-6: Dodecylsulfuric acid soda

WA-7: Sodium salt of α-sulfosuccinic acid di(2-ethylhexyl)ester

WA-8: Cetyl trimethyl ammonium chloride

WA-9: C₁₁H₂₃CONHCH₂CH₂N⁺(CH₃)₂—CH₂COO⁻

WA-10: C₈F₁₇SO₂N(C₃H₇)(CH₂CH₂O)₁₆H

WA-11: C₈F₁₇SO₂N(C₃H₇)CH₂COOK

WA-12: C₇F₁₅COONH₄

WA-13: C₈F₁₇SO₃K

WA-14: C₈F₁₇SO₂N(C₃H₇)(CH₂CH₂O)₄(CH₂)₄SO₃Na

WA-15: C₈F₁₇SO₂N(C₃H₇)—(CH₂)₃—N⁺(CH₃)₃—I⁻

WA-16: C₈F₁₇SO₂N(C₃H₇)CH₂CH₂CH₂N⁺(CH₃)₂—CH₂COO⁻

WA-17: C₈F₁₇CH₂CH₂—O—(CH₂CH₂O)₁₆H

WA-18: C₈F₁₇CH₂CH₂—O—(CH₂)₃—N⁺(CH₃)₃.I⁻

WA-19: H(CF₂)₈CH₂CH₂OCOCH₂CH(SO₃Na)COOCH₂CH₂CH₂CH₂(CF₂)₈H

WA-20: H(CF₂)₆CH₂CH₂O(CH₂CH₂O)₁₆H

WA-21: H(CF₂)₈CH₂CH₂—O—(CH₂)₃—N⁺(CH₃)₃.I⁻

WA-22: H(CF₂)₈CH₂CH₂OCOCH₂CH(SO₃K)COOCH₂CH₂CH₂CH₂C₈F₁₇

WA-23: C₉F₁₇—C₆H₄—SO₂N(C₃H₇)(CH₂CH₂O)₁₆H

WA-24: C₉F₁₇—C₆H₄—CSO₂N(C₃H₇)—(CH₂)₃—N⁺(CH₃)₃.I⁻

(Lubricant)

Any layers of the transparent substrate may comprise a lubricant incorporated therein. In this case, the outermost layer is particularly preferred. Examples of the lubricant employable herein include polyorganosiloxanes as disclosed in JP-B-53-292, higher aliphatic acid amides as disclosed in U.S. Pat. No. 4,275,146, higher aliphatic acid esters (ester of aliphatic acid having from 10 to 24 carbon atoms with alcohol having from 10 to 24 carbon atoms) as disclosed in JP-B-58-33541, British Patent 927,446, JP-A-55-126238 and JP-A-58-90633, higher aliphatic acid metal salts as disclosed in U.S. Pat. No. 3,933,516, esters of straight-chain higher aliphatic acid with straight-chain higher alcohol as disclosed in JP-A-58-50534, and higher aliphatic acid-higher alcohol esters containing branched alkyl group as disclosed in International Patent Disclosure No. 90,108,115 pamphlet.

Among these lubricants, as the polyorganosiloxanes there may be used commonly known polyorganosiloxanes such as polyalkylsiloxane (e.g., polydimethylsiloxane, polydiethylsiloxane), polyarylsiloxane (e.g., polydiphenylsiloxane, polymethylphenylsiloxane), organopolysiloxane having an alkyl group having 5 or more carbon atoms as disclosed in JP-B-53-292, JP-B-55-49294 and JP-A-60-140341 and modified polysiloxane (e.g., organopolysiloxane having alkoxy, hydroxy, hydrogen, carboxyl, amino or mercapto group in its side chain). Block copolymers having siloxane unit may be used. Specific examples of these compounds will be given below, but the invention is not limited thereto.

(S-1): (CH₃)₃SiO—(Si(CH₃)₂O)ₐ—Si(CH₃)₃ a=5 to 1,000

(S-2): (C₆H₅)₃SiO—(Si(CH₃)₂O)ₐ—Si(CH₃)₃ a=5 to 1,000

(S-3): (CH₃)₃SiO—(Si(C₅H₁₁)(CH₃)—O)ₐ—Si(CH₃)₃ a=10

(S-4): (CH₃)₃SiO—(Si(C₁₂H₂₅)(CH₃)—O)₁₀—(Si(CH₃)₂O)₁₈—Si (CH₃)₃

(S-5): (CH₃)₃SiO—(Si(CH₃)₂O)x-(Si(CH₃)((CH₂)₃—O(CH₂CH₂O)₁₀H)—O)_{y}—(Si(CH₃)₂ O)₁—Si(CH₃)₃ x+y+z=30

(S-6): (CH₃)₃SiO—(Si(CH₃)₂O)x-(Si(CH₃){(CH₂)₃—O(CH₂CH(CH₃)—O)₁₀(CH₂CH₂O)₁₀C₃H₇}O)_{y}-(Si(CH₃)₂O)_{z}—Si(CH₃)₃ x+y+z=35

Examples of the higher aliphatic acid and derivatives thereof and higher alcohol and derivatives thereof employable herein include higher aliphatic acids, higher aliphatic acid metal salts, higher aliphatic acid esters, higher aliphatic acid amides, higher aliphatic acid polyvalent alcohol esters, higher aliphatic acid alcohols, monoalkyl phosphite, dialkyl phosphite, trialkyl phosphite, monoalkyl phosphate, dialkyl phosphate and trialkyl phosphate of higher aliphatic alcohol, higher aliphatic alkylsulfonic acids, amide compounds thereof, and salts thereof. Specific examples of these compounds will be given below, but the invention is not limited thereto.

(S-7): n-C₁₅H₃₁COOC₃₀H₆₁-n

(S-8): n-C₁₇H₃₅COOC₃₀H₆₁-n

(S-9): n-C₁₅H₃₁COOC₅₀H₁₀₁-n

(S-10): n-C₂₁H₄₃COO—(CH₂)₇CH(CH₃)—C₉H₁₉

(S-11): n-C₂₁H₄₃COOC₂₄H₄₉-iso

(S-12): n-C₁₈H₃₇OCO(CH₂)₄COOC₄₀H₈₁-n

(S-13): n-C₅₀H₁₀₁O(CH₂CH₂O)₁₅H

(S-14): n-C₄₀H₈₁OCOCH₂CH₂COO(CH₂CH₂O)₁₆H

(S-15): n-C₂₁H₄₁CONH₂

(S-16): Liquid paraffin H

(S-17): Carnauba wax

The use of such a lubricant makes it possible to obtain an excellent optical film having an excellent scratch resistance which causes no cissing on the undercoat layer. The content of the lubricant to be used is not specifically limited but is preferably from 0.0005 to 2 g/m², more preferably 0.001 to 1 g/m², particularly from 0.002 to 0.5 g/m². In the invention, the layer in which the lubricant is incorporated is not specifically limited but is preferably the outermost layer (layer closest to viewing side) on the back side of the optical film. The aforementioned surface layer comprising a lubricant incorporated therein can be formed by spreading a coating solution comprising such a lubricant dissolved in a proper organic solvent over a support optionally provided with other layers on the back side thereof, and then drying the coat layer. The lubricant may be incorporated in the coating solution in the form of dispersion. Preferred examples of the solvent employable herein include water, alcohols (e.g., methanol, ethanol, isopropanol), ketones (e.g., acetone, methyl ethyl ketone, cyclohexanone), esters (e.g., methyl, ethyl, propyl and butyl esters of acetic acid, formic acid, oxalic acid, maleic acid and succinic acid), aromatic hydrocarbon-based solvents (e.g., benzene, toluene, xylene), and amide-based solvents (e.g., dimethylformamide, dimethyl acetamide, n-methylpyrrolidone).

The aforementioned lubricant may be used in combination with a film-forming binder during spreading. Examples of polymers employable herein include known thermoplastic resins, thermosetting resins, radiation-curing resins, reactive resins and mixture thereof, and hydrophilic binders such as gelatin.

Referring to slip properties, the static friction coefficient of the optical film of the invention is preferably 0.30 or less, more preferably 0.25 or less, particularly 0.15 or less. Further, the static friction coefficient of the optical film of the invention with respect to the material with which it comes in contact is preferably small to help prevent the occurrence of scratch. The static friction coefficient of the optical film of the invention with respect to the material with which it comes in contact, too, is preferably 0.3 or less, more preferably 0.25 or less, particularly 0.13 or less. It is occasionally preferred that the static friction coefficient of the both sides of the optical film of the invention be small and the static friction coefficient between them is preferably 0.30 or less, more preferably 0.25 or less and particularly preferably 0.13 or less. The dynamic friction coefficient of the optical film of the invention is preferably 0.30 or less, more preferably 0.25 or less, particularly 0.13 or less. The dynamic friction coefficient of the optical film of the invention with respect to the material with which it comes in contact, too, is preferably 0.3 or less, more preferably 0.25 or less, particularly 0.15 or less. It is occasionally preferred that the dynamic friction coefficient of the both sides of the optical film of the invention, too, be small. The dynamic friction coefficient of the optical film of the both sides of the invention is preferably 0.30 or less, more preferably 0.25 or less, particularly 0.13 or less.

Further, JP-A-2003-096208 discloses a cellulose ester film which satisfies the relationships 1.0≦b/a≦1.5 and 1.0≦C/a≦5.0 supposing that the friction coefficient with respect to the contact surfaces of film at 23° C. and 55% RH is a, the friction coefficient with respect to the contact surfaces of film at 23° C. and 80% RH is b and the friction coefficient with respect to the contact surfaces of film at 23° C. and 85% RH is C, so that no wrinkling and break can occur even if the thickness of the film is as small as 60 μm or less. This cellulose ester film can be used as a transparent substrate for the optical film of the invention.

In order to provide excellent optical properties, JP-A-2001-002807 discloses a cellulose acetate film having an average acetylation degree of from 58 to 62.5% comprising a coat layer containing a polymer and a particulate material having an average particle diameter of 1.0 μm or less provided therein wherein the haze thereof as calculated in terms of thickness of 80 μm is 2.0% or less and the dynamic friction coefficient of the surface thereof on which the coat layer is provided is 0.40 or less. The above cited invention can be used as a transparent substrate for the optical film of the invention.

(Matting Agent)

The functional layers laminated on the transparent substrate as optical film each preferably comprise a matting agent incorporated therein to improve the adhesivity thereof or the adhesion resistance thereof at high humidity. In this case, the average height of the surface protrusions is preferably from 0.005 to 10 μm, more preferably from 0.01 to 5 μm. These protrusions are preferably present on the surface of the film as much as possible. However, when the protrusions are present more than necessary, haze occurs to disadvantage. The content of spherical or amorphous matting agent having protrusions having an average height falling within the above defined range is preferably from 0.5 to 600 mg/m², more preferably from 1 to 400 mg/m². The matting agent employable herein is not specifically limited in its formulation and may be an inorganic or organic material or a mixture of two or more matting agents.

Examples of the inorganic material as matting agent include particulate inorganic materials such as particulate barium sulfate, manganese colloid, particulate titanium dioxide, particulate strontium barium sulfate, particulate silicon dioxide, particulate aluminum oxide, particulate tin oxide, particulate zinc oxide, particulate calcium carbonate, particulate barium sulfate, particulate talc, particulate kaolin and particulate calcium sulfate. Further examples of the organic material as matting agent include silicon dioxide such as synthetic silica obtained by wet process or gelation of silicic acid, and titanium dioxide (rutile type or anatase type) produced by the reaction of titanium slag with sulfuric acid. Alternatively, the inorganic matting agent can be obtained by grinding an inorganic material having a relatively large particle diameter, e.g., 20 μm or more, and then classifying the particles (vibration filtration, air classification, etc.). Other examples of the matting agent include products obtained by grinding and classifying organic polymer compounds such as polytetrafluoroethylene, cellulose acetate, polystyrene, polymethyl methacrylate, polypropyl methacrylate, polymethyl acrylate, polyethylene carbonate, acryl styrene-based resin, silicone-based resin, polycarbonate resin, benzoguanamine-based resin, melamine-based resin, polyolefin-based resin, polyester-based resin, polyamide-based resin, polyimide-based resin, polyethylene fluoride-based resin and starch. Alternatively, a polymer compound synthesized by suspension polymerization method or a polymer compound or inorganic compound which has been rendered spherical by spray dry method, dispersion method or the like may be used. A particulate material made of the same material as mentioned above but having as greater a particle diameter as 0.1 to 10 μm may be added to form an anti-glare layer. It is preferred that the particulate material be added in an amount of from 0.5 to 20% by mass. Preferred examples of these particulate materials include silicon dioxide such as silica (e.g., Silysia, produced by Fuji Silysia Chemical Ltd., Nipsil E, produced by NIPPON SILICA CORPORATION).

As the particulate material according to the invention there may be preferably used also a particulate material having a C₂-C₂₀ alkyl or aryl group on the surface thereof. The number of carbon atoms in the alkyl group is more preferably from 4 to 12, even more preferably from 6 to 10. The less the number of carbon atoms is, the better is dispersibility. The more the number of carbon atoms is, the less is reagglomeration to occur when the coating solution is mixed with a dope. Examples of the inorganic materials among particulate materials having a C₂-C₂₀ alkyl or aryl group on the surface thereof include silicon dioxide, titanium dioxide, aluminum oxide, zirconium oxide, calcium carbonate, calcium carbonate, talc, clay, calcined kaolin, calcined calcium silicate, hydrated calcium silicate, aluminum silicate, magnesium silicate, and calcium phosphate. Preferred among these inorganic materials are silicon dioxide, titanium dioxide and zirconium oxide. Particularly preferred among these inorganic materials are those containing silicon atom such as silicon dioxide. Particulate silicon dioxides are commercially available in the trade name of Aerosil 130, Aerosil 200 and Aerosil 300 (produced by Nihon Aerosil Co., Ltd.). Further, particulate silicon dioxide and spherical particulate monodisperse silicon dioxide modified with silicone oil on the surface thereof may be preferably used.

The particulate inorganic material having a C₂-C₂₀ alkyl group on the surface thereof can be obtained, e.g., by treating the aforementioned particulate silicon dioxide with octyl silane. This particulate inorganic material is commercially available in the trade name of Aerosil R805 (produced by Nihon Aerosil Co., Ltd.), which has an octyl group on the surface thereof. This product can be used in the invention.

The particulate inorganic material having a phenyl group on the surface thereof can be obtained, e.g., by treating the aforementioned particulate silicon dioxide with trichlorophenyl silane.

Examples of the polymer among the aforementioned particulate materials having a C₂-C₂₀ alkyl group or a phenyl group on the surface thereof include silicone resins, fluororesins, and acrylic resins. Particularly preferred among these polymers are polymethyl methacrylates. As previously mentioned, there are preferably used compounds having silicon atom, particularly silicone dioxide or silicone resin having a three-dimensional network structure, most preferably silicon dioxide.

JP-A-2001-183528 discloses an optical film obtained by spreading a coating composition comprising a particulate material having a water content of 5% by mass or less containing at least a resin and a solvent over a film substrate to provide a resin layer for improving optical properties, surface properties, antistatic properties, scratch resistance, adhesion, etc. This optical film can be used in the invention.

In order to prevent the adhesion of a rolled film, JP-A-2001-151936 discloses a cellulose triacetate film comprising a particulate silicon dioxide having an average particle diameter of 0.5 μm or more and less than 1.0 μm incorporated in at least surface layer in an amount of from 0.10% by mass to 0.15% by mass. This cellulose triacetate film can be used as a transparent substrate for the optical film of the invention.

Further, JP-A-2002-317059 discloses a cellulose acylate film which has a matting agent content of from 0.03 to 0.15% by mass to have a static friction coefficient of from 0.4 to 0.7 so that scratch during film winding can be inhibited without deteriorating transmission. This cellulose acylate film can be used as a transparent substrate for the optical film of the invention.

Moreover, JP-A-2003-119297 discloses a cellulose ester film which comprises a particulate material and an ultraviolet absorber incorporated therein to control the particle diameter of agglomerated secondary particles and prevent the occurrence of spot-like defects, sticking of film sheets to each other, deformation of film, unevenness in sticking to polarizer and unevenness in coating wherein the relationship a/B=0.5 to 1.0 can be satisfied supposing that the average particle diameter of particles which have been just dispersed in a solvent is a μm and the average particle diameter of particles in the dried film is B μm. This cellulose ester film can be used as a transparent substrate for the optical film of the invention.

These particulate materials are preferably incorporated in the cellulose acylate in an amount of from 0.005 to 0.3% by mass, more preferably from 0.01 to 0.1% by mass. In this manner, the use of the particulate material according to the invention makes it possible to obtain a cellulose acylate film having a particulate material fairly dispersed therein wherein the number of particles having a particle diameter of 10 μm or more incorporated therein is 10/m² or less. For the details of such a cellulose acylate film, reference can be made to JP-A-2001-2788. This cellulose acylate film can be used in the invention.

(Antistatic Treatment, Antistatic Agent and Antistatic Layer)

Antistatic treatment is adapted to render a resin film capable of preventing itself from being electrostatically charged when handled. In some detail, antistatic treatment is carried out by providing a layer containing an ionically-conductive material or electrically-conductive particulate material. The term “ionically-conductive material” as used herein is meant to indicate an electrically-conductive material containing an ion which is an electricity-transporting carrier. Examples of such an ionically-conductive material include ionic polymer compounds.

Examples of the ionic polymer compounds employable herein include anionic polymer compounds as disclosed in JP-B-49-23828, JP-B-49-23827 and JP-B-47-28937, ionic polymers having a dissociable group in its main chain as disclosed in JP-B-55-734, JP-B-50-54672, JP-B-59-14735, JP-B-57-18175, JP-B-57-18176 and JP-B-57-56059, and cationic pendant type polymers having a cationic dissociable group in its side chains as disclosed in JP-B-53-13223, JP-B-57-15376, JP-B-53-45231, JP-B-55-145783, JP-B-55-65950, JP-B-55-67746, JP-B-57-11342, JP-B-57-19735, JP-B-58-56858, JP-A-61-27853 and JP-B-62-9346.

Preferred among these ionic polymer compounds are those obtained by finely dispersing a particulate electrically-conductive material in the aforementioned resins. Preferred examples of the electrically-conductive material to be dispersed in the resin include electrically-conductive particulate materials made of metal oxides or composite oxides thereof, and ionically-conductive polymers or particulate quaternary ammonium cationically-conductive polymers as disclosed in JP-A-9-203810. The particle diameter of these electrically-conductive materials is preferably from 5 nm to 10 μm. The even more desirable range of the particle diameter of the electrically-conductive materials depends on the kind of the particulate material used.

Preferred examples of the metal oxide which is an electrically-conductive material include ZnO, TiO₂, SnO₂, Al₂O₃, In₂O₃, SiO₂, MgO, BaO, MoO₂, V₂O₅, and composite oxides thereof. Particularly preferred among these metal oxides are ZnO, TiO₂ and SnO₂. Referring to examples containing hetero atoms, aluminum, indium, etc. are effectively added to ZnO. Niobium, tantalum, etc. are effectively added to TiO₂. Antimony, niobium, halogen atoms, etc. are effectively added to SnO₂. The amount of these hetero atoms to be incorporated is preferably from 0.01 to 25 mol-%, particularly from 0.1 to 15 mol-%.

The volume resistivity of these electrically-conductive metal oxide powders is preferably 10⁷ Ω·cm or less, particularly 10⁵ Ω·cm or less. It is preferred that a powder having a specific structure such that the primary particle diameter is not smaller than 100 angstrom to not greater than 0.2 μm and a high-order structure major axis diameter of not smaller than 30 nm to not greater than 6 μm be incorporated in the electrically-conductive layer in a volume fraction of from not smaller than 0.01% to not greater than 20%.

Further, referring to the characteristics of crosslinked cationic electrically-conductive polymer as a dispersible particulate polymer, the cationic components can be retained in the particulate material in a high concentration at a high density. Therefore, the crosslinked cationic electrically-conductive polymer not only exhibits an excellent electrical conductivity but also shows no deterioration of electrical conductivity even at a low relative humidity. Although the particles are fairly dispersed, they are fairly bonded to each other at the film-making step after coating, making it possible to provide a high film strength. Moreover, the crosslinked cationic electrically-conductive polymer exhibits an excellent adhesion to other materials such as support as well as an excellent chemical resistance.

The dispersible particulate polymer which is a crosslinked cationic electrically-conductive polymer to be incorporated in the antistatic layer normally has a particle size of from about 10 nm to 1,000 nm, preferably from 0 nm to 300 nm. The term “dispersible particulate polymer” as used herein is meant to indicate a polymer that can be visually seen as a transparent or slightly cloudy solution but can be seen as a particulate dispersion under electron microscope. The use of a coating composition substantially free of dust (foreign matters) having a particle diameter greater than the thickness of the overlying layer as an underlying layer coating composition makes it possible to prevent the overlying layer from undergoing defects due to foreign matters.

Referring to the ratio of resin to particulate material, the resin is used in an amount of from 0.5 to 4 parts by mass based on 1 part by mass of particulate material from the standpoint of adhesion. In particular, from the standpoint of adhesion after irradiation with ultraviolet rays, the resin is preferably used in an amount of from 1 to 2 parts by mass based on 1 part by mass of particulate material. Further, an organic electronically-conductive organic compound may be used. Examples of the organic electronically-conductive organic compound include polythiopene, polypyrrole, polyaniline, polyacetylene, and polyphosphazene. These organic electronically-conductive organic compounds are preferably used as an acid-providing material in the form of complex with polystyrenesulfonic acid, perchloric acid or the like.

Examples of the resin employable herein include cellulose derivatives such as cellulose diacetate, cellulose triacetate, cellulose acetate butyrate, cellulose acetate phthalate and cellulose nitrate, polyesters such as polyvinyl acetate, polystyrene, polycarbonte, polybutylene terephthalate and copolybutylene/tere/isophthalate, polyvinyl alcohol derivatives such as polyvinyl alcohol, polyvinyl formal, polyvinyl acetal, polyvinyl butyral and polyvinyl benzal, norbornene-based polymers having a norbornene compound, acrylic resins such as polymethyl methacrylate, polyethylene methacrylate, polypropyl methacrylate, polybutyl methacrylate and polymethyl acrylate, and copolymers thereof with other resins. However, the invention is specifically limited to these resins. Preferred among these resins are cellulose derivatives and acrylic resins. Most desirable among these resins are acrylic resins.

As the resin to be used in the resin layer such as antistatic layer there is preferably used the aforementioned thermoplastic resin having a mass-average molecular weight of more than 400,000 and a glass transition point of from 80° C. to 110° C. from the standpoint of optical properties and surface properties of coating layer.

For the measurement of glass transition point, the method according to JIS K7121 can be employed. The resin amount of the resin to be used herein is preferably 60% by mass, more preferably 80% by mass based on the total mass of the resin used in the underlying layer. If necessary, an active ray-curing resin or thermosetting resin may be added. These resins may be spread as a binder in the form of solution in the aforementioned proper solvent.

The coating composition for antistatic layer preferably comprises the following solvent. As the solvent there may be used a hydrocarbon, alcohol, ketone, ester or glycol, singly or in proper admixture with other solvents. However, the invention is not specifically limited to these solvents.

Among these solvents, solvents having a low boiling point can easily evaporate to make dew condensation of water in the air, causing water to be taken into the coating composition at the step of preparing the coating solution and the step of coating. Solvents having a low boiling point are subject to effect of external humidity rise particularly in rain, remarkably in an atmosphere of 65% RH. This effect becomes remarkable when the time during which the coating composition is exposed to air at the coating step is prolonged or the contact area of the coating composition with air is great.

Examples of the aforementioned hydrocarbons include benzene, toluene, xylene, hexane, and cyclohexane. Examples of the alcohols include methanol, ethanol, n-propyl alcohol, iso-propyl alcohol, n-butanol, 2-butanol, tert-butanol, pentanol, 2-methyl-2-butanol, and cyclohexanol. Examples of the ketones include acetone, methyl ethyl ketone, methyl isobutyl ketone, and cyclohexanone. Examples of the esters include methyl formate, ethyl formate, methyl acetate, ethyl acetate, isopropyl acetate, amyl acetate, ethyl lactate, and methyl lactate. Examples of the glycol ethers (C₁-C₄) include methyl cellosolve, ethyl cellosolve, propylene glycol monomethyl ether (PGME), propylene glycol monoethyl ether, propylene glycol mono-n-propylene ether, propylene glycol monoisopropyl ether, and propylene glycol monobutyl ether. Examples of the propylene glycol monoalkyl ether esters (C₁-C₄) include propylene glycol monomethyl ether acetate, and propylene glycol monoethyl ether acetate. Examples of other solvents include N-methylpyrrolidone. The invention is not specifically limited to these solvents. A proper mixture of these solvents, too, is preferably used.

The coating composition of the invention may be spread to a dry thickness of from 0.1 to 10 μm, preferably from 0.1 to 1 μm using a doctor coating method, extrusion coating method, slide coating method, roll coating method, gravure coating method, wire bar coating method, reverse coating method, curtain coating method, extrusion coating method or extrusion coating method involving the use of a hopper described in U.S. Pat. No. 2,681,294.

(Transparent Hard Coat Layer)

The film of the invention may comprise a transparent hard coat layer provided thereon. As a transparent hard coat layer there is preferably used an active ray-curing resin or thermosetting resin. The term “active ray-curing resin layer” as used herein is meant to indicate a layer mainly composed of a resin that undergoes crosslinking reaction to cure when irradiated with active rays such as ultraviolet ray and electron ray. Representative examples of the active ray-curing resin include ultraviolet-curing resins and electron ray-curing resins. However, resins that cure when irradiated with active rays other than ultraviolet ray and electron ray may be used. Examples of the ultraviolet-curing resins include ultraviolet-curing acrylurethane-based resins, ultraviolet-curing polyester acrylate-based resins, ultraviolet-curing epoxy acrylate-based resins, ultraviolet-curing polyol acrylate-based resins, and ultraviolet-curing epoxy resins. JP-A-2003-039014 discloses an invention which comprises drying a film thus coated while being gripped at the longitudinal or crosswise ends thereof to cure a coating solution containing an active ray-curing material, making it possible to provide a high flatness. The above cited invention can be used in the invention.

The ultraviolet-curing acrylurethane-based resin can be normally obtained with ease by reacting the production of reaction of a polyester polyol with an isocyanate monomer or prepolymer with an acrylate-based monomer having a hydroxyl group such as 2-hydroxyethyl acrylate, 2-hydroxyethyl methacrylate (hereinafter, only acrylate will be exemplified because acrylate includes methacrylate) and 2-hydroxypropyl acrylate. For the details of these ultraviolet-curing acrylurethane-based resins, reference can be made to JP-A-59-151110. These ultraviolet-curing acrylurethane-based resins can be used in the invention.

The ultraviolet-curing polyester acrylate resin can be normally obtained with ease by reacting a polyester polyol with a 2-hydroxyethyl acrylate- or 2-hydroxy acrylate-based monomer. For the details of the ultraviolet-curing polyester acrylate resin, reference can be made to JP-A-59-151112, and it can be used in the invention.

Specific examples of the ultraviolet-curing epoxy acrylate-based resins those obtained by the reaction of an epoxy acrylate as an oligomer in the presence of a reactive diluent and a photoreaction initiator. For the details of these ultraviolet-curing epoxy acrylate-based resins, reference can be made to JP-A-1-105738. These ultraviolet-curing epoxy acrylate-based resins can be used in the invention. As the photoreaction initiators there may be used one or more selected from the group consisting of benzoin derivatives, oxime ketone derivatives, benzophenone derivatives and thioxanthones.

Specific examples of the ultraviolet ray-curing polyol acrylate-based resins include trimethylol propane triacrylate, ditrimethylol propane tetraacrylate, pentaerythritol triacrylate, pentaerythritol tetraacrylate, dipentaerythritol hexaacrylate, and alkyl-modified dipentaerythritol pentaacrylate. These resins are normally used in combination with known photosensitizers.

The aforementioned photoreaction initiator, too, may be used as a photosensitizer. Specific examples of the photoreaction initiator employable herein include acetophenone, benzophenone, hydroxybenzophenone, Michler's ketone, α-amyloxime ester, thioxanthone, and derivatives thereof. When an epoxy acrylate-based photoreaction initiator is used, a sensitizer such as n-butylamine, triethylamine and tri-n-butylphosphine may be used.

The proportion of the photoreaction initiator or photosensitizer in the ultraviolet ray-curing resin composition excluding the solvent component that evaporates after spreading and drying is particularly preferably from 2.5 to 6% by mass based on the mass of the composition. When the proportion of the photoreaction initiator or photosensitizer falls below 2.5% by mass, the resulting optical film is subject to inhibition of curing due to plasticizer and/or ultraviolet absorber eluted from the resin film and hence deterioration of scratch resistance. On the contrary, when the proportion of the photoreaction initiator or photosensitizer exceeds 6% by mass, the amount of the ultraviolet ray-curing resin component is relatively reduced, deterioration scratch resistance and spreadability and hence the surface quality of the coat layer.

Examples of the resin monomer which is a monomer having one unsaturated double bond include ordinary monomers such as methyl acrylate, ethyl acrylate, butyl acrylate, vinyl acetate, benzyl acrylate, cyclohexyl acrylate and styrene. Examples of the resin monomer which is a monomer having two or more unsaturated double bonds include ethylene glycol diacrylate, propylene glycol diacrylate, divinyl benzene, 1,4-cyclohexane diacrylate, 1,4-cyclohexyl dimethyl diacrylate, and the aforementioned trimethylol propane triacrylate and pentaerythritol tetraacryl ester.

The solid content concentration of the coating composition for active ray-curing resin layer is preferably from 10 to 95% by mass. A proper solid content may be selected depending on the coating method used. As the light source for causing the photosetting reaction of the active ray-curing resin to form a curd film layer there may be used any light source that emits ultraviolet rays. Examples of the light source employable herein include low pressure mercury vapor lamp, middle pressure mercury vapor lamp, high pressure mercury vapor lamp, ultrahigh pressure mercury vapor lamp, carbon arc lamp, metal halide lamp, and xenon lamp. The emission conditions differ with the kind of the lamp used. The dose is preferably from 20 to 10,000 mJ/cm², more preferably from 50 to 2,000 mJ/cm². The photosetting reaction in the range of from near ultraviolet range to visible light range may be effected in the presence of a sensitizer having a maximal absorption in that range. The irradiation with ultraviolet rays may be effected once or two or more times.

As the solvent to be used in the spreading of the active ray-curing resin layer there may be used the aforementioned solvent for resin layer. For example, any solvents selected from the group consisting of hydrocarbons, alcohols, ketones, esters, glycol ethers and other solvents may be used optionally in admixture. Preferably, a solvent containing a propylene glycol monoalkyl ether (C₁-C₄) or propylene glycol monoalkyl ether ester (C₁-C₄) in an amount of 5% by mass or more, more preferably from 5 to 80% by mass is used.

As the device for spreading the ultraviolet ray-curing resin composition coating solution there may be used any known coating device such as gravure coater, spinner coater, wire bar coater, roll coater, reverse coater, extrusion coater and air doctor coater. The proper spread is from 0.1 to 200 μm, preferably from 0.5 to 100 μm as calculated in terms of wet film thickness. The spreading is preferably effected at a rate of from 5 to 200 m/min. In the case where the thickness of the coat layer is great, spreading may be effected two or more batches to form a transparent hard coat layer. The ultraviolet ray-curing resin composition which has been spread and dried is irradiated with ultraviolet rays from a light source. The time during which the coat layer is irradiated with ultraviolet rays is preferably from 0.5 seconds to 5 minutes, more preferably from 3 seconds to 2 minutes from the standpoint of curing efficiency and working efficiency of ultraviolet ray-curing resin. The dry thickness of the transparent hard coat layer thus obtained is preferably from 0.2 to 100 μm, more preferably from 1 to 50 μm, particularly from 2 to 45 μm.

In order to render such a coat layer slippery, the coat layer may comprise the aforementioned inorganic or organic particulate material. As such an inorganic or organic particulate material there may be used the aforementioned matting agent. Further, as previously mentioned, the active ray-curing resin layer may be provided on the resin layer such as antistatic layer. The antistatic layers or the transparent hard coat layers each may be provided singly or in lamination. In some detail, these layers may be provided on either side of the optical film with antistatic properties, protective film for polarizing plate or cellulose acylate film disclosed in JP-A-6-123806, JP-A-9-113728 and JP-A-9-203810 directly or with a subbing layer provided interposed therebetween.

(Anticurling Layer)

The optical film of the invention may be subjected to anticurling treatment. The anticurling treatment is adapted to render the material capable of curling with the surface thus treated inside. In this manner, even when the transparent resin film is subjected to different surface treatments to different degrees from one side to the other, the resulting optical film can be prevented from curling with the treated surface inside.

As the anticurling treatment there may be effected the provision of an anticurling layer. Examples of the provision of an anticurling layer include provision of an anticurling layer on the substrate on the side thereof opposite the anti-glare layer or anti-reflection layer, spreading of a bonding-aid layer on one side of the transparent resin film, and spreading of an anticurling treatment on the other side of the transparent resin film.

Specific examples of anticurling treatment include spreading of a solvent, and spreading of a solvent with a transparent resin such as cellulose triacetate, cellulose diacetate and cellulose acetate propionate. Referring further to spreading of a solvent, a composition containing a solvent capable of dissolving or swelling the cellulose acylate film used as protective film for polarizing plate is spread. Accordingly, the coating solution for the anticurling layer preferably comprises an organic solvent such as ketone-based and ester-based solvents. Preferred examples of the ketone-based organic solvents include acetone, methyl ethyl ketone, methyl isobutyl ketone, cyclohexanone, ethyl lactate, acetyl acetone, diacetone alcohol, isophorone, ethyl-n-butyl ketone, diisopropyl ketone, diethyl ketone, di-n-propyl ketone, methyl cyclohexanone, methyl-n-butyl ketone, methyl-n-propyl ketone, methyl-n-hexyl ketone, and methyl-n-heptyl ketone. Preferred examples of the ester-based organic solvents include methyl acetate, ethyl acetate, butyl acetate, methyl lactate, and ethyl lactate. However, the solvents employable herein may include solvents incapable of dissolving the cellulose acylate film besides solvents capable of dissolving and/or swelling the cellulose acylate film in admixture. A composition obtained by mixing these solvents at a proper ratio depending on the curling degree of the transparent resin film or the kind of the resin is spread in an amount depending on these factors. The anticurling function may be attained also by transparent hard coat treatment or antistatic treatment.

The optical film of the invention preferably comprises an anticurling layer provided on the substrate on the side thereof opposite the anti-glare layer or anti-reflection layer. The optical film thus produced preferably exhibits a curling degree of from not smaller than −10 to not greater than +10 at 23° C. and 60% RH.

For the measurement of curling degree, the following method may be employed. In some detail, the film sample to be measured is allowed to stand at 80° C. and 90% RH for 48 hours, and then cut into a size of 50 mm wide and 2 mm long. The film specimen thus sampled is moisture-conditioned at 23° C.±2° C. and 55% RH for 24 hours, and then measured for curling using a curvature radius scale.

Curling is represented by 1/R in which R is the radius of curvature the unit of which is m. Referring to curling, the optical film preferably has as small deformation as possible. The direction of deformation may be plus or minus. In other words, the absolute value of curling is preferably as small as possible. In some detail, when the absolute value of curling of the film is greater than 10, a polarizing plate or the like made of the optical film undergoes much deformation such as warping under high temperature and humidity conditions (e.g., when allowed to stand at 80° C. and 90% RH for 48 hours) to such an extent that it can no longer be used. When the curling of the film is not greater than 10, a polarizing plate or the like made of the film undergoes little deformation such as warping even under high temperature and humidity conditions (e.g., when allowed to stand at 80° C. and 90% RH for 48 hours) and thus can be used.

Regardless of provision of the curling layer and other layers, the optical film of the invention preferably exhibits a haze of 3% or more and a transmission of 90% or more at 550 nm. The outermost surface layer is used in such an arrangement that the bonding-aid layer is stuck to the polarizer or the surface of the anti-reflection layer is stuck to the surface of the protective film and thus needs to have some hydrophilicity. In particular, the contact angle of the bonding-aid layer with water at 23° C. and 60% RH is preferably 50 degrees or less.

(Bonding-Aid Layer)

The optical film of the invention may comprise a bonding-aid layer provided thereon. The term “bonding-aid layer” as used herein is meant to indicate a layer capable of rendering the protective film for polarizing plate capable of being easily bonded to its adjacent layer such as polarizing layer.

Examples of the bonding-aid layer which can be preferably used in the invention include a layer comprising a polymer compound having —COOM group (in which M represents a hydrogen atom or cation). In an even more desirable embodiment, a layer comprising a polymer compound having —COOM group is provided on the film substrate side of the optical film and a layer mainly composed of a hydrophilic polymer compound is provided adjacent to the former layer on the polarizing layer side of the optical film. The term “polymer compound having —COOM group” as used herein is meant to indicate a styrene-maleic acid copolymer having —COOM group, vinyl acetate-maleic acid copolymer having —COOM group or vinyl acetate-maleic acid-maleic anhydride copolymer. The vinyl acetate-maleic acid copolymer having —COOM group is particularly preferred. These polymer compounds may be used singly or in combination of two or more thereof. The mass-average molecular weight of these polymer compounds is preferably from about 500 to 500,000. For preferred examples of the polymer compounds having —COOM group, reference can be made to JP-A-6-094915 and JP-A-7-333436.

Preferred examples of the hydrophilic polymer compounds include hydrophilic cellulose derivatives (e.g., methyl cellulose, carboxymethyl cellulose, hydroxy cellulose), polyvinyl alcohol derivatives (e.g., polyvinyl alcohol, vinyl acetate-vinyl alcohol copolymer, polyvinyl acetal, polyvinyl formal, polyvinyl benzal), natural polymer compounds (e.g., gelatin, casein, gum arabic), hydrophilic polyester derivatives (e.g., partially-sulfonated polyethylene terephthalate), and hydrophilic polyvinyl derivatives (e.g., poly-N-vinypyrrolidone, polyacrylamide, polyvinyl indazole, polyvinyl pyrazole). These hydrophilic polymer compounds may be used singly or in combination of two or more thereof.

[Optical Compensation Layer]

The optical film of the invention may comprise an optical compensation layer made of a discotic compound provided on the transparent substrate. The invention will be further described with reference to the case where as the transparent substrate there is used a cellulose acylate film, but the invention is not limited thereto.

For the details of the discotic compound to be used herein, reference can be made to JP-A-7-267902, JP-A-7-281028 and JP-A-7-306317. These discotic compounds may be used also in the invention. In accordance with these references, the optical compensation layer is a layer formed by a compound having a discotic structural unit. In other words, the optical compensation layer is a liquid crystal discotic compound layer made of a low molecular compound such as monomer or a polymer layer obtained by the polymerization (curing) of a polymerizable liquid crystal discotic compound. Examples of such a discotic (disc-shaped) compound include benzene derivatives as disclosed in C. Destrade et al's study report and Mol. Cryst. vol. 71, page 111 (1981), truxene derivatives as disclosed in C. Destrade et al's study report, Mol. Cryst. vol. 122, page 141 (1985), and Physcs Lett, A, vol. 78, page 82 (1992), cyclohexane derivatives as disclosed in B. Kohne et al's study report and Angew. Chem. vol. 96, page 70 (1984), and azacrown-based or phenylacetylene-based macrocycles as disclosed in J. M. Lehn et al's study report, J. Chem. Commun., page 1,794 (1985), J. Zhang et al's study report, and J. Am. Chem. Soc., vol. 116, page 2,655 (1994). The aforementioned discotic (disc-shaped) compounds include those generally called discotic liquid crystal comprising these compounds as nucleus in the center of molecule and straight-chain alkyl group, alkoxy group, substituted benzoyloxy group, etc. radially substituted. However, the discotic compound is not limited to this configuration so far as the molecule aggregation exhibits a negative monoaxiality and can provide a predetermined alignment. The term “formed by a disc-shaped compound” as used in the above cited patent is meant to indicate that the final product doesn't need to be the aforementioned compound. For example, the aforementioned low molecular discotic liquid crystals include those having a group that, when heated or irradiated with light, reacts to cause the polymerization or crosslinking thereof, eventually giving a high molecular compound having no liquid crystal properties. Further, a compound containing at least one disc-shaped compound capable of forming a discotic nematic phase or monoaxial columnar phase and having optical anisotropy is preferably used. The disc-shaped compound is preferably a triphenylene derivative. The triphenylene derivative is preferably a compound represented by the general formula [ka-2] disclosed in JP-A-7-306317.

For the details of examples of the use of a cellulose acylate film as a support for alignment layer, reference can be made to JP-A-9-152509. These examples can be used also in the invention. In other words, the alignment layer is provided on the cellulose acylate film prepared according to the invention or the undercoat layer provided thereon. The alignment layer acts to define the direction of alignment of the liquid crystal discotic compound provided thereon. The alignment layer may be made of any material so far as it can render the optical compensation layer orientable.

Examples of the alignment layer include layer obtained by rubbing an organic compound (preferably polymer), obliquely vacuum-deposited inorganic compound, layer having microgrooves, accumulated layer formed by ω-tricosanic acid, dioctadecylmethyl ammonium chloride, methyl stearate, etc. using Langmuir-Blodgett method (LB membrane), and layer having a dielectric material aligned by providing an electric field or magnetic field.

Examples of the organic compound for alignment layer include polymers such as polymethyl methacrylate, acrylic acid-methacrylic acid copolymer, styrene-maleimide copolymer, polyvinyl alcohol, poly(N-methylol acrylamide), styrene-vinyltoluene copolymer, chlorosulfonated polyethylene, nitrocellulose, polyvinyl chloride, chlorinated polyolefin, polyester, polyimide, vinyl acetate-vinyl chloride copolymer, ethylene-vinyl acetate copolymer, carboxymethyl cellulose, polyethylenes, polypropylene and polycarbonate, and compounds such as silane coupling agent. Preferred examples of the polymers employable herein include polyimides, polystyrenes, styrene derivative polymers, gelatins, polyvinyl alcohols, and alkyl-modified polyvinyl alcohols having alkyl group (preferably having 6 or more carbon atoms).

Particularly preferred among these polymers are alkyl-modified polyvinyl alcohols, which are excellent in capability of uniformly aligning the liquid crystal discotic compound. This is probably attributed to strong mutual interaction of alkyl chain on the surface of the alignment layer with alkyl side chain in the discotic liquid crystal. The alkyl group preferably has from 6 to 14 carbon atoms. More preferably, the alkyl group is connected to a polyvinyl alcohol via —S—, —(CH₃)C(CN)— or —(C₂H₅)N—CS—S—. The aforementioned alkyl-modified polyvinyl alcohol is terminated by an alkyl group and preferably has a saponification degree of 80% or more and a polymerization degree of 200 or more. As the aforementioned polyvinyl alcohol having an alkyl group in its side chains there may be used any commercially available product such as MP103, MP203 and R1130 (produced by KURARAY CO., LTD.).

The polyimide membrane which is widely used as an alignment layer for LCD (preferably fluorine-containing polyimide) is preferably used as an organic alignment layer. This polyimide membrane can be obtained by spreading a polyamic acid (e.g., LQ/LX Series (produced by Hitachi Chemical Co., Ltd.), SE Series (produced by NISSAN CHEMICAL INDUSTRIES, LTD.) over the surface of a support, calcining the coat layer at a temperature of from 100° C. to 300° C. for 0.5 to 1 hour, and then rubbing the coat layer.

Further, the alignment layer which can be applied to the optical film of the invention is preferably a cured layer obtained by introducing a reactive group into the aforementioned polymer or using the aforementioned polymer in combination with a crosslinking agent such as isocyanate compound and epoxy compound to cure the polymer.

The polymer constituting the alignment layer and the liquid crystal compound constituting the optical compensation layer are preferably chemically connected to each other via the interface of these layers. The polymer constituting the alignment layer is preferably formed by a polyvinyl alcohol having at least one hydroxyl group substituted by a group having a vinyl moiety, oxylanyl moiety or aziridinyl moiety. The group having a vinyl moiety, oxylanyl moiety or aziridinyl moiety is preferably connected to the polymer chain of polyvinyl alcohol derivative via ether bond, urethane bond, acetal bond or ester bond. The group having a vinyl moiety, oxylanyl moiety or aziridinyl moiety is preferably free of aromatic ring. The aforementioned polyvinyl alcohol is preferably a compound represented by the general formula (ka-22) described in JP-A-9-152509.

As the aforementioned rubbing treatment there may be used one which is widely employed as liquid crystal alignment for LCD. In some detail, the surface of the alignment layer may be rubbed with paper, gauze, felt, rubber, nylon, polyester fiber or the like in a constant direction to attain alignment. In general, the surface of the alignment layer is rubbed with a cloth having fibers having uniform length and thickness planted uniformly thereon several times.

A representative example of the material to be obliquely vacuum-deposited is SiO. Further examples of the material to be obliquely vacuum-deposited include metal oxides such as TiO₂ and ZnO₂, fluorides such as MgF₂ and metals such as gold and aluminum. Any metal oxides having a high dielectric constant may be used as material to obliquely vacuum-deposited.

The invention is not limited to the above exemplified materials. An inorganic obliquely vacuum-deposited layer can be formed using a vacuum metallizer. By effecting vacuum deposition on a film (support) fixed or effecting continuous vacuum deposition on a moving film of continuous length, an inorganic obliquely vacuum-deposited layer can be formed. As a method of aligning the optical compensation layer without any alignment layer there may be used a method which comprises applying an electric field or magnetic field to the optical compensation layer on the support while being heated to a temperature at which a discotic liquid crystal layer can be formed.

Examples of the optical compensation layer which can be applied to the invention include optical compensation layers having a basic configuration as disclosed in JP-A-8-5837, JP-A-7-191217, JP-A-8-50206 and JP-A-7-281028.

The optical film having an optical compensation layer can be applied to LCD. For example, the aforementioned optical film having an optical compensation layer is preferably stuck to on one side of a polarizing plate with an adhesive. Alternatively, the aforementioned optical film having an optical compensation layer is preferably stuck as a protective film to one side of a polarizer with an adhesive. The optical compensation layer preferably has at least a discotic structure unit (discotic liquid crystal).

The disc surface (hereinafter occasionally simply referred to as “surface”) of the discotic structure unit is disposed obliquely to the surface of the cellulose acylate film used as a transparent substrate and the angle of the disc surface of the discotic structure unit with respect to the cellulose acylate film changes in the depth direction of the optical compensation layer.

Preferred embodiments of the aforementioned optical film having an optical compensation layer will be given below.

(b1) The average angle rises in the depth direction of the optical compensation layer with the rise of the distance from the bottom of the optical compensation layer.

(b2) The aforementioned angle varies from 5° to 85°.

(b3) The minimum value of the angle ranges from O₀ to 85° (preferably from 0 to 40°) and the maximum value of the angle ranges from 5° to 90° (preferably from 50° to 85°).

(b4) The difference between the maximum value and the minimum value of the angle ranges 5° to 70° (preferably 10° to 60°).

(b5) The aforementioned angle shows a continuous change (preferably rise) in the depth direction of the optical compensation layer with the rise of the distance of the bottom of the optical compensation layer.

(b6) The optical compensation layer further comprises a cellulose acylate.

(b7) The optical compensation layer further comprises a cellulose acetate butyrate.

(b8) An alignment layer (preferably a cured polymer layer) is formed interposed between the optical compensation layer and the transparent substrate.

(b9) An undercoat layer is formed interposed between the optical compensation layer and the alignment layer.

(b10) The optical compensation layer has a minimum absolute value of retardation other than 0 in the direction oblique to the line normal to the optical film having an optical compensation layer.

(b11) The alignment layer is an optical film having an optical compensation layer described in Clause (b8) which is a rubbed polymer layer. The optical film preferably comprises an organic compound that, when incorporated in the optical compensation layer, can change the alignment temperature of the optical compensation layer. The organic compound is preferably a monomer having a polymerizable group.

For the details of the method of preparing the optical film having an optical compensation layer of the invention, reference can be made to JP-A-9-73081, JP-A-8-160431 and JP-A-9-73016. However, the invention is not limited to these methods.

An example of these methods of preparing an optical film having an optical compensation layer will be given below.

(c1) A coating solution containing an alignment layer-forming resin is spread over a transparent substrate of continuous length (e.g., cellulose acylate film) which is being fed, and then dried to form a transparent resin layer.

(c2) The surface of the transparent resin layer is then rubbed with a rubbing roller to form an alignment layer on the transparent resin layer. The surface of the alignment layer on the film substrate is preferably continuously subjected to rubbing by conveying the film substrate while being lapped on a rotating rubbing roll disposed between two conveying rolls at a step of continuously conveying the film substrate. The rubbing roll may be disposed with its rotary axis oblique to the direction of conveyance of the film substrate. The roundness, cylindricality and deflection of the rubbing roll itself each are preferably 30 μm or less. The device employing the aforementioned rubbing method preferably comprises one or more spare sets o rubbing roll.

(c3) A coating solution containing a liquid crystal discotic compound is spread over the alignment layer. The rubbing of the surface of the transparent resin layer is preferably effected while dusting both the surface of the rubbing roller and the surface of the resin layer thus rubbed. As the liquid crystal discotic compound there may be used a liquid crystal discotic compound having a crosslinkable functional group. It is preferred that the solvent be evaporated under control with the surface of the coat layer thus coated sealed with a gas layer. The coat layer from which the majority of the solvent has been evaporated can be heated to form a discotic nematic optical compensation layer. The seal of gas layer is preferably moved along the surface of the coat layer at a velocity of from −0.1 to 0.1 m/sec relative to the moving velocity of the coat layer. The evaporation of the solvent under control is preferably effected within a period during which the rate of drop of the solvent content in the coat layer is proportional to time.

(c4) The coat layer thus formed is preferably dried, and then heated to form a discotic nematic optical compensation layer which is then continuously irradiated with light to cause the discotic liquid crystal to cure. The heating of the coat layer is preferably carried out by applying hot air or far infrared ray to the transparent resin film on the side thereof opposite the optical compensation layer or by bringing a hot roller into contact with the coat layer. The heating of the coat layer thus dried is preferably carried out by applying hot air or far infrared ray to the both sides of the transparent resin film.

(c5) The optical film having an alignment layer and an optical compensation layer formed thereon is preferably then wound.

[Image Display Device]

The anti-reflection film of the invention, if used as one of polarizing layer surface protective films, can be applied to various display devices (image display devices) such as cathode ray tube display device (CRT), plasma display (PDP), electroluminescence display (ELD) and liquid crystal display device (LCD). The anti-reflection film of the invention is preferably used in transmission type, reflection type or semi-transmission type liquid crystal display devices of mode such as twisted nematic (TN), supertwisted nematic (STN), vertical alignment (VA), in-plane switching (IPS) and optically compensated bend cell (OCB).

VA mode liquid crystal cells include (1) liquid crystal cell in VA mode in a narrow sense in which rod-shaped liquid crystal molecules are oriented substantially vertically when no voltage is applied but substantially horizontally when a voltage is applied (as disclosed in JP-A-2-176625). In addition to the VA mode liquid crystal cell (1), there have been provided (2) liquid crystal cell of VA mode which is multidomained to expand the viewing angle (MVA mode) (as disclosed in SID97, Digest of Tech. Papers (preprint) 28 (1997), 845), (3) liquid crystal cell of mode in which rod-shaped molecules are oriented substantially vertically when no voltage is applied but oriented in twisted multidomained mode when a voltage is applied (n-ASM mode) (as disclosed in Preprints of Symposium on Japanese Liquid Crystal Society Nos. 58 to 59, 1988 and (4) liquid crystal cell of SURVALVAL mode (as reported in LCD International 98).

For VA mode liquid crystal cells, a polarizing plate prepared by combining a biaxially-stretched triacetyl cellulose film with an anti-reflection film of the invention is preferably used. For the details of preferred method of preparing the biaxially-stretched triacetyl cellulose film, reference can be made to JP-A-2001-249223 and JP-A-2003-170492.

An OCB mode liquid crystal cell is a liquid crystal cell of bend alignment mode wherein rod-shaped liquid crystal molecules are oriented in substantially opposing directions (symmetrically) from the upper part to the lower part of the liquid crystal cell as disclosed in U.S. Pat. Nos. 4,583,825 and 5,410,422. In the OCB mode liquid crystal cell, rod-shaped liquid crystal molecules are oriented symmetrically with each other from the upper part to the lower part of the liquid crystal cell. Therefore, the bend alignment mode liquid crystal cell has a self optical compensation capacity. Accordingly, this liquid crystal mode is also called OCB (optically compensated bend) liquid crystal mode. The bend alignment mode liquid crystal display device is advantageous in that it has a high responce.

In TN mode liquid crystal cell, rod-shaped liquid crystal molecules are oriented substantially horizontal when no voltage is applied thereto. The OCB mode liquid crystal cell is used mostly as a color TFT liquid crystal display device. For details, reference can be made to many literatures, e.g., “EL, PDP, LCD Displays”, Toray Research Center, 2001.

For TN or IPS mode liquid crystal display devices in particular, the use of an optical compensation sheet having a viewing angle expanding effect as one of two sheets of polarizing layer protective film opposite the anti-reflection film of the invention makes it possible to obtain a polarizing plate having both anti-reflection effect and viewing angle expanding effect by the thickness of only one sheet of polarizing plate as disclosed in JP-A-2001-100043.

### EXAMPLE

The invention will be further described in the following examples, but the interpretation of the scope of the invention should not be limited thereto.

<Preparation of Anti-Reflection Film>

### Example 1

[Preparation of Coating Solution for Hard Coat Layer (HCL-1)]

The following compositions were put in a mixing tank wherein they were then stirred to prepare a hard coat layer coating solution.

To 750.0 parts by mass of trimethylolpropane triacrylate “Biscoat #295” (produced by OSAKA ORGANIC CHEMICAL INDUSTRY LTD.) were added 270.0 parts by mass of a poly (glycidylmethacrylate) having a mass-average molecular weight of 15,000, 730 parts by mass of methyl ethyl ketone, 500.0 parts by mass of cyclohexanone and 50.0 parts by mass of a photopolymerization initiator “Irgacure 184” (produced by Ciba Specialty Chemicals Inc.). The mixture was then stirred. The mixture was then filtered through a polypropylene filter having a pore diameter of 0.4 μm to prepare a coating solution for hard coat layer (HCL-1).

The poly(glycidylmethacrylate) was obtained by dissolving glycidyl methacrylate in methyl ethyl ketone (MEK), allowing the solution to react at 80° C. for 2 hours with a heat polymerization initiator “V-65” (produced by Wako Pure Chemical Industries, Ltd.) added dropwise thereto, dropping the resulting reaction solution to hexane, and then drying the precipitate under reduced pressure.

[Preparation of Coating Solution for Middle Refractive Layer (MLL-1)]

{Preparation of Fine Dispersion of Titanium Dioxide (TL-1)}

As particulate titanium dioxide there was used cobalt-containing particulate titanium dioxide surface-treated with aluminum hydroxide and zirconium hydroxide “MPT-129C” {produced by ISHIHARA SANGYO KAISHA, LTD.; TiO₂:CO₃O₄:Al₂O₃:ZrO₂=90.5:3.0:4.0:0.5 (by mass)}.

To 257.1 parts by mass of the particulate titanium dioxide were then added 41.1 parts by mass of the following dispersant and 701.8 parts by mass of cyclohexanone. The mixture was then subjected to dispersion using a dinomill to prepare a dispersion of titanium dioxide having a mass-average particle diameter of 70 nm (TL-1). 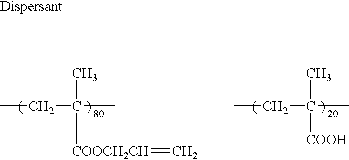
{Preparation of Coating Solution for Middle Refractive Layer (MLL-1)}

To 99.1 parts by mass of the aforementioned titanium dioxide dispersion were added 68.0 parts by mass of a mixture of dipentaerythritol pentaacrylate and dipentaerythritol hexaacrylate “DPHA” (produced by NIPPON KAYAKU CO., LTD.), 3.6 parts by mass of a photopolymerization initiator “Irgacure 907” (produced by Ciba Specialty Chemicals Co., Ltd.), 1.2 parts by mass of a photosensitizer “Kayacure DETX” (produced by NIPPON KAYAKU CO., LTD.), 279.6 parts by mass of methyl ethyl ketone and 1,049.0 parts by mass of cyclohexanone. The mixture was then thoroughly stirred. The mixture was then filtered through a polypropylene filter having a pore diameter of 0.4 μm to prepare a coating solution for middle refractive layer (MLL-1).

[Preparation of Coating Solution for High Refractive Layer (HLL-1)]

To 469.8 parts by mass of the aforementioned titanium dioxide dispersion (TL-1) were added 40.0 parts by mass of a mixture of dipentaerythritol pentaacrylate and dipentaerythritol hexaacrylate “DPHA” (produced by NIPPON KAYAKU CO., LTD.), 8.3 parts by mass of a photopolymerization initiator “Irgacure 907” (produced by Ciba Specialty Chemicals Inc.), 526.2 parts by mass of methyl ethyl ketone and 459.6 parts by mass of cyclohexanone. The mixture was then stirred. The mixture was then filtered through a polypropylene filter having a pore diameter of 0.4 μm to prepare a coating solution for high refractive layer (HLL-1).

[Preparation of Coating Solution for Low Refractive Layer (LLL-1)]

A fluorine-containing polymer P-3 according to the invention set forth in Table 1 was dissolved in methyl isobutyl ketone in such an arrangement that a concentration of 7% by mass was reached. To the solution were then added a methacrylate group-terminated silicone resin “X-22-164C” {produced by Shin-Etsu Chemical Co., Ltd.} and the aforementioned polymerization initiator sensitive to ultraviolet range “Irgacure 907” (trade name) in an amount of 3% by mass and 5% by mass based on the solid content of the solution, respectively, to prepare a low refractive layer coating solution.

### Comparative Example 1-1

[Preparation of Anti-Reflection Film (101)]

The coating solution for hard coat layer (HCL-1) was spread over a triacetyl cellulose film having a thickness of 80 μm “FUJITAC” (produced by Fuji Photo Film Co., Ltd.) using a gravure coater. The coat layer was dried at 100° C., and then irradiated with ultraviolet rays at an illuminance of 400 mW/cm² and a dose of 300 mJ/cm² using a 160 W/cm air-cooled metal halide lamp (produced by EYE GRAPHICS CO., LTD.) while the air in the system was being purged with nitrogen such that the oxygen concentration of the atmosphere reached 1.0 vol-% or less to form a hard coat layer (HCL-1) to a thickness of 8 μm.

The coating solution for middle refractive layer (MLL-1), the coating solution for high refractive layer (HLL-1) and the coating solution for low refractive layer (LLL-1) were then successively spread over the hard coat layer (HC-1) using a gravure coater having three coating stations.

In order to form the middle refractive layer, the coating solution for middle refractive layer thus spread was dried at 90° C. for 30 seconds, and then cured by irradiating with ultraviolet rays at an illuminance of 400 mW/cm² and a dose of 400 mJ/cm² using a 180 W/cm air-cooled metal halide lamp (produced by EYE GRAPHICS CO., LTD.) while the air in the system was being purged with nitrogen such that the oxygen concentration of the atmosphere reached 1.0 vol-% or less.

The middle refractive layer (ML-1) thus cured had a refractive index of 1.630 and a thickness of 67 nm.

In order to form the high refractive layer, the coating solution for high refractive layer thus spread was dried at 90° C. for 30 seconds, and then cured by irradiating with ultraviolet rays at an illuminance of 600 mW/cm² and a dose of 400 mJ/cm² using a 240 W/cm air-cooled metal halide lamp (produced by EYE GRAPHICS CO., LTD.) while the air in the system was being purged with nitrogen such that the oxygen concentration of the atmosphere reached 1.0 vol-% or less.

The high refractive layer (HL-1) thus cured had a refractive index of 1.905 and a thickness of 107 nm.

In order to form the low refractive layer, the coating solution for low refractive layer thus spread was dried at 90° C. for 30 seconds, and then cured by irradiating with ultraviolet rays at an illuminance of 600 mW/cm² and a dose of 600 mJ/cm² using a 240 W/cm air-cooled metal halide lamp (produced by EYE GRAPHICS CO., LTD.) while the air in the system was being purged with nitrogen such that the oxygen concentration of the atmosphere reached 0.1 vol-% or less.

The low refractive layer (LL-1) thus cured had a refractive index of 1.440 and a thickness of 85 nm. In this manner, an anti-reflection film 101 was prepared.

### Examples 1-1 to 1-6 and 2-1 and Comparative Examples 1-2 to 1-8 and 2-1

An anti-reflection film (102) was prepared in the same manner as in the anti-reflection film (101) of Comparative Example 1-1 except that a high refractive layer coating solution (HLL-2) prepared by adding to the high refractive layer coating solution (HLL-1) 8.3 parts by mass of a polymerization initiator sensitive to near ultraviolet range “Irgacure 819” (produced by Ciba Specialty Chemicals Co., Ltd.) and the curing of the high refractive layer (HL-2) was carried out by irradiating the high refractive layer (HL-2) with ultraviolet rays with a short wavelength cut filter having a transmission of 50% with respect to ultraviolet rays having a wavelength of 393 nm (1% or less with respect to ultraviolet rays having a wavelength of 380 nm or less) disposed in front of the light source such that the dose was 400 mJ/cm².

Anti-reflection films (103) to (114) and (201) to (202) were prepared from high refractive layer coating solutions (HLL-3) to (HLL-11) comprising different polymerization initiators at different curing wavelengths using or without using a short wavelength cut filter.

TABLE 7

| | Anti- | Hard | Middle | High refractive layer | | | | Low refractive layer | | | | |
|---|---|---|---|---|---|---|---|---|---|---|---|---|
| | re- | coat | refractive | | Polymerization | | | | Polymerization | | | |
| | flection | layer | layer | | initiator | | Short | | initiator | | Short | |
| | film | coating | coating | Coating | | Amount | wavelength | Coating | | Amount | wavelength | |
| | sample | solution | solution | solution | | used^{*2} | cut filter | solution | | used | cut filter | |
| | No. | No. | No. | No. | Kind^{*1} | (parts by mass) | used? | No. | Kind^{*1} | (wt-%) | used? | Remarks |
| Comparative | 101 | HCL-1 | MLL-1 | HLL-1 | 907 | 8.3 | No | LLL-1 | 907 | 5.0 | No | |
| Example 1-1 | | | | | | | | | | | | |
| Example 1-1 | 102 | HCL-1 | MLL-1 | HLL-2 | 907 | 8.3 | Yes | LLL-1 | ″ | ″ | ″ | |
| | | | | | 819 | 8.3 | | | | | | |
| Comparative | 103 | HCL-1 | MLL-1 | HLL-3 | 907 | 4.2 | No | LLL-1 | ″ | ″ | ″ | |
| Example 1-2 | | | | | | | | | | | | |
| Comparative | 104 | HCL-1 | MLL-1 | HLL-4 | 907 | 16.3 | No | LLL-1 | ″ | ″ | ″ | |
| Example 1-3 | | | | | | | | | | | | |
| Comparative | 105 | HCL-1 | MLL-1 | HLL-1 | 907 | 8.3 | Yes | LLL-1 | ″ | ″ | ″ | High |
| Example 1-4 | | | | | | | | | | | | refractive |
| | | | | | | | | | | | | layer not |
| | | | | | | | | | | | | cured |
| Comparative | 106 | HCL-1 | MLL-1 | HLL-5 | 819 | 8.3 | Yes | LLL-1 | ″ | ″ | ″ | |
| Example 1-5 | | | | | | | | | | | | |
| Comparative | 107 | HCL-1 | MLL-1 | HLL-5 | 819 | 8.3 | No | LLL-1 | ″ | ″ | ″ | |
| Example 1-6 | | | | | | | | | | | | |
| Example 1-2 | 108 | HCL-1 | MLL-1 | HLL-6 | 907 | 8.3 | Yes | LLL-1 | ″ | ″ | ″ | |
| | | | | | 819 | 4.2 | | | | | | |
| Example 1-3 | 109 | HCL-1 | MLL-1 | HLL-7 | 907 | 8.3 | Yes | LLL-1 | 907 | 5.0 | No | |
| | | | | | 819 | 16.3 | | | | | | |
| Example 1-4 | 110 | HCL-1 | MLL-1 | HLL-8 | 907 | 1.0 | Yes | LLL-1 | ″ | ″ | ″ | |
| | | | | | 819 | 8.3 | | | | | | |
| Example 1-5 | 111 | HCL-1 | MLL-1 | HLL-9 | 907 | 4.2 | Yes | LLL-1 | ″ | ″ | ″ | |
| | | | | | 819 | 8.3 | | | | | | |
| Example 1-6 | 112 | HCL-1 | MLL-1 | HLL-10 | 907 | 16.3 | Yes | LLL-1 | ″ | ″ | ″ | |
| | | | | | 819 | 8.3 | | | | | | |
| Comparative | 113 | HCL-1 | MLL-1 | HLL-2 | 907 | 8.3 | No | LLL-1 | ″ | ″ | ″ | |
| Example 1-7 | | | | | 819 | 8.3 | | | | | | |
| Comparative | 114 | HCL-1 | MLL-1 | HLL-2 | 907 | 8.3 | Yes | LLL-1 | ″ | ″ | Yes | Low |
| Example 1-8 | | | | | 819 | 8.3 | | | | | | refractive |
| | | | | | | | | | | | | layer not |
| | | | | | | | | | | | | cured |
| Example 2-1 | 201 | HCL-1 | MLL-1 | HLL-11 | MP | 8.3 | Yes | LLL-1 | MP | ″ | No | |
| | | | | | 819 | 8.3 | | | | | | |
| Comparative | 202 | HCL-1 | MLL-1 | HLL-11 | MP | 8.3 | No | LLL-1 | ″ | ″ | ″ | |
| Example 2-1 | | | | | 819 | 8.3 | | | | | | |

Kind^{*1}: The term “907” indicates “Irgacure 907”. The term “819” indicates “Irgacure 819”. The term “MP” indicates “MP-Triazine” (produced by Sanwa Chemical Co., Ltd).
Amount used^{*2}: Based on 100 parts by mass of DPHA

<Evaluation of Anti-Reflection Film>

The films thus obtained were then evaluated for the following properties. The results are set forth in Table 8 below.

[Specular Reflectance]

Using a Type V-550 spectrophotometer (produced by JASCO) equipped with an adapter “ARV-474”, the film samples were each measured for specular reflectance at an incidence angle of 5° and an emission angle of −5° in the wavelength range of from 380 nm to 780 nm. The measurements of specular reflectance were then averaged over the range of from 450 nm to 650 nm to evaluate the anti-reflection properties.

[Pencil Hardness]

The anti-reflection films were each evaluated for pencil hardness according to JIS K5400. In some detail, the anti-reflection films were each moisture-conditioned at a temperature of 25° C. and a humidity of 60% RH for 2 hours, and then evaluated for hardness with a testing pencil having a hardness of from H to 5H specified according to JIS S6006 at a load of 500 g according to the following criterion. The highest hardness at which the anti-reflection film is acceptable was defined to be the hardness of the sample.

Zero to one scratch (n=5): acceptable

Three or more scratches (n=5): Unacceptable

[Resistance to Rubbing with Steel Wool]

#0000 steel wool was allowed to move back and forth over the anti-reflection film sample 30 times at a load of 1.96 N/cm². The surface of the anti-reflection film sample was then observed for scratch. The results were then evaluated according to the following 5-step criterion.

E (excellent): No scratches

G (good): Little or no visible scratches

F (fair): Definitely visible scratches

P (poor): Definitely visible remarkable scratches

VP (very poor): Film exfoliated

TABLE 8

| | Anti-reflection film | % Average | | Steel |
|---|---|---|---|---|
| | sample No. | reflectance | Pencil hardness | wool resistance |
| Comparative | 101 | 0.32 | 2H˜3H | P |
| Example 1-1 | | | | |
| Example 1-1 | 102 | 0.32 | 3H | F˜G |
| Comparative | 103 | 0.32 | 2H˜3H | P |
| Example 1-2 | | | | |
| Comparative | 104 | 0.32 | 2H˜3H | P |
| Example 1-3 | | | | |
| Comparative | 105 | Nonevaluatable | Nonevaluatable | Nonevaluatable |
| Example 1-4 | | | | |
| Comparative | 106 | 0.32 | 2H˜3H | P |
| Example 1-5 | | | | |
| Comparative | 107 | 0.32 | 2H˜3H | P |
| Example 1-6 | | | | |
| Example 1-2 | 108 | 0.32 | 3H | F˜G |
| Example 1-3 | 109 | 0.32 | 3H | F˜G |
| Example 1-4 | 110 | 0.32 | 3H | F˜G |
| Example 1-5 | 111 | 0.32 | 3H | F˜G |
| Example 1-6 | 112 | 0.32 | 3H | F˜G |
| Comparative | 113 | 0.32 | 2H˜3H | P |
| Example 1-7 | | | | |
| Comparative | 114 | Nonevaluatable | Nonevaluatable | Nonevaluatable |
| Example 1-8 | | | | |
| Example 2-1 | 201 | 0.32 | 3H | G |
| Comparative | 202 | 0.32 | 2H˜3H | P |
| Example 2-1 | | | | |

As can be seen in Table 8 above, the anti-reflection film prepared by the method of the invention which comprises irradiating a high refractive layer comprising “Irgacure 907” or “MP-Triazine” and “Irgacure 819” or “MP-Triazine” with near ultraviolet rays to which only “Irgacure 819” is sensitive so that it is cure, spreading a low refractive layer coating solution comprising “Irgacure 907” or “MP-Triazine” over the high refractive layer, and then irradiating the coat layer with ultraviolet rays to which “Irgacure 907” contained in the high refractive layer and the low refractive layer is sensitive exhibits a low reflectance and an excellent scratch resistance.

### Examples 1-7 to 1-9 and Comparative Examples 1-9 to 1-11

Anti-reflection film samples (115) to (120) were prepared in the same manner as in the anti-reflection film (102) of Examples 1-1 and the anti-reflection film (101) of Comparative Example 1-1 except that the film temperature during the irradiation of the low refractive layer with ultraviolet rays. These anti-reflection films were each then evaluated in the same manner as in Example 1. The results are set forth in Table 9. The film surface temperature was adjusted by changing the temperature of the metal plate in contact with the back side of the film.

TABLE 9

| | Anti-reflection | Temperature during | | | Steel |
|---|---|---|---|---|---|
| | film | irradiation with | % Average | Pencil | wool |
| | sample No. | ultraviolet rays | reflectance | hardness | resistance |
| Comparative | 101 | Not heated | 0.32 | 2H˜3H | P |
| Example 1-1 | | | | | |
| Comparative | 115 | 40° C. | 0.32 | 2H˜3H | P |
| Example 1-9 | | | | | |
| Comparative | 116 | 60° C. | 0.32 | 2H˜3H | P˜F |
| Example 1-10 | | | | | |
| Comparative | 117 | 100° C. | 0.32 | 2H˜3H | F |
| Example 1-11 | | | | | |
| Example 1-1 | 102 | Not heated | 0.32 | 3H | F˜G |
| Example 1-7 | 118 | 40° C. | 0.32 | 3H | F˜G |
| Example 1-8 | 119 | 60° C. | 0.32 | 3H˜4H | G˜E |
| Example 1-9 | 120 | 100° C. | 0.32 | 3H˜4H | E |

The scratch resistance was further improved by additionally performing an operation of raising the temperature during ultraviolet irradiation to 60° C. or more.

### Examples 1-10 to 1-12

Anti-reflection films (121) to (123) were prepared in the same manner as in the anti-reflection film (102) of Example 1-1 except that the conditions after ultraviolet irradiation were as set forth in Table 10. These anti-reflection films were each evaluated in the same manner as in Example 1. The results are set forth in Table 10.

TABLE 10

| | | Conditions after ultraviolet irradiation | | | | | | |
|---|---|---|---|---|---|---|---|---|
| | Anti-reflection | | Oxygen | Film | | | | Steel |
| | film sample | | concentration | temp. | Heating | % Average | Pencil | wool |
| | No. | Heated? | (vol-%) | (° C.) | time (sec) | reflectance | hardness | resistance |
| Example 1-1 | 102 | No | 21 | 30 | — | 0.32 | 3H | F˜G |
| Example 1-10 | 121 | Yes | 21 | 100 | 10 | 0.32 | 2H˜3H | F˜G |
| Example 1-11 | 122 | Yes | 1.0 | 100 | 10 | 0.32 | 3H | G |
| Example 1-12 | 123 | Yes | 0.1 | 100 | 10 | 0.32 | 3H˜4H | G˜E |

As can be seen in Table 10 above, when the anti-reflection film which has been irradiated with ultraviolet rays is subsequently passed through a low oxygen zone having an oxygen concentration of 3% or less where it is then heated, the scratch resistance of the anti-reflection film can be further enhanced.

### Example 2

An anti-reflection film was prepared in the same manner as in Examples 1 to 3 except that the fluorine-containing polymer P-3 to be contained in the coating solution (LLL-1) for low refractive layer was replaced by the fluorine-containing polymers P-1 and P-2 set forth in Table 1 (in equal part) to prepare coating solutions (LLL-2) and (LLL-3) which were then used to form low refractive layers (LL-2) and (LL-3), respectively. These anti-reflection films were each then evaluated in the same manner as in Examples 1 to 3. As a result, the same effect as exerted in Example 1 was obtained.

### Example 3

[Preparation of Coating Solution for Hard Coat Layer (HCL-2)]

The compositions described below were charged into a mixing tank and stirred to form a coating solution for hard coat layer.

{Formulation of coating solution for hard coat layer (HCL-2)}

| | |
|---|---|
| Ultraviolet-curing resin | 91 parts by mass |
| “DPHA” (produced by NIPPON KAYAKU CO., | |
| LTD.) | |
| Photopolymerization initiator | 5.0 parts by mass |
| “Irgacure 819” (produce by Ciba | |
| Specialty Chemicals Co., Ltd.) | |
| Silane coupling agent | 10 parts by mass |
| “KBM-5103” (produced by Shin-Etsu Chemical Co., | |
| Ltd.) | |
| Particulate silica | 8.9 parts by mass |
| “KE-P150” (1.5 μm) (produced by | |
| NIPPON SHOKUBAI CO., LTD.) | |
| Particulate crosslinked PMMA | 3.4 parts by mass |
| “MXS-300” (3 μm) (produced by Soken | |
| Chemical & Engineering Co., Ltd.) | |
| Methyl ethyl ketone | 29 parts by mass |
| Methyl isobutyl ketone | 13 parts by mass |

[Preparation of Anti-Reflection Film]

### Comparative Example 3-1

The aforementioned coating solution for hard coat layer (HCL-2) was spread over a triacetyl cellulose film (Fujitac TD80U, produced by Fuji Photo Film Co., Ltd.) as a transparent substrate which was being unwound from a roll at a conveying speed of 10 m/min using a mircogravure roll with a diameter of 50 mm having 135 lines/inch and a depth of 60 μm and a doctor blade. The coated film was dried at 60° C. for 150 seconds, irradiated with ultraviolet rays at an illuminance of 400 mW/cm² and a dose of 250 mJ/cm² from an air-cooled metal halide lamp having an output of 160 W/cm (produced by EYE GRAPHICS CO., LTD.) in an atmosphere in which the air within had been purged with nitrogen so that the coat layer was cured to form a hard coat layer (HC-2). The film was then wound. After curing, the rotary speed of the gravure roll was adjusted such that the thickness of the hard coat layer reached 3.6 μm.

The aforementioned coating solution for low refractive layer (LLL-1) was spread over the transparent substrate having a hard coat layer (HC-2) provided thereon which was being unwound at a conveying speed of 10 m/min using a mircogravure roll with a diameter of 50 mm having 200 lines/inch and a depth of 30 μm and a doctor blade. The coated film was dried at 90° C. for 30 seconds. The film was irradiated with ultraviolet rays at an illuminance of 600 mW/cm² and a dose of 400 mJ/cm² from an air-cooled metal halide lamp having an output of 240 W/cm (produced by EYE GRAPHICS CO., LTD.) to form a low refractive layer, and then wound. The rotary speed of the aforementioned gravure roll was adjusted such that the low refractive layer thus cured reached 100 nm. In the case where heating was effected after irradiation with ultraviolet rays, the film which had been irradiated with ultraviolet rays was brought into contact with a rotary metal roll which had been passed through hot water or compressed vapor. In this manner, anti-reflection film (301) was prepared.

### Examples 3-1 to 3-7 and Comparative Examples 3-2 to 3-9

An anti-reflection film (302) was prepared in the same manner as in the anti-reflection film (301) of Comparative Example 3-1 except that a coating solution (HCL-3) prepared by adding to the hard coat layer coating solution (HCL-2) 4.6 parts by mass of a polymerization initiator sensitive to near ultraviolet range “Irgacure 819” (produced by Ciba Specialty Chemicals Co., Ltd.) was used and the curing of the hard coat layer was carried out by irradiating the hard coat layer with ultraviolet rays with a short wavelength cut filter having a transmission of 50% with respect to ultraviolet rays having a wavelength of 393 nm (1% with respect to ultraviolet rays having a wavelength of 380 nm or less) disposed in front of the light source such that the dose was 400 mJ/cm².

Anti-reflection films (303) to (314) were prepared from hard coat layer coating solutions (HCL-4) to (HCL-10) comprising different polymerization initiators at different curing wavelengths using or without using a short wavelength cut filter. Further, anti-reflection films (315) to (316) were prepared from the following coating solution (HCL-11) at different curing wavelengths using or without using a short wavelength cut filter.

[Preparation of Hard Coat Layer Coating Solution (HCL-11)]

The following components were charged into a mixing tank where they were then stirred to prepare a hard coat layer coating solution.

{Formulation of hard coat layer coating solution (HCL-11)}

| | |
|---|---|
| UV-curing resin | 91 parts by mass |
| “DPHA” (produced by NIPPON KAYAKU CO., | |
| LTD.) | |
| Photopolymerization initiator | |
| “Irgacure 819” (produce by Ciba Specialty Chemicals | 5.0 parts by mass |
| Co., Ltd.) | |
| “MP-Triazine” (produce by Sanwa Chemical | 5.0 parts by mass |
| Co., Ltd.) | |
| Silane coupling agent | 10 parts by mass |
| “Sol a-1” | |
| Particulate silica | 8.9 parts by mass |
| “KE-P150” (1.5 μm) (produced by NIPPON | |
| SHOKUBAI CO., LTD.) | |
| Particulate crosslinked PMMA | 3.4 parts by mass |
| “MXS-300” (3 μm) (produced by Soken Chemical | |
| & Engineering Co., Ltd.) | |
| Methyl ethyl ketone | 29 parts by mass |
| Methyl isobutyl ketone | 13 parts by mass |

(Preparation of Sol a-1)

Into a 1,000 ml reaction vessel equipped with a thermometer, a nitrogen intake pipe and a dropping funnel were charged 187 g (0.80 mol) of acryloxyoxypropyl trimethoxy silane, 27.2 g (0.20 mol) of methyl trimethoxy silane, 320 g (10 mol) of methanol and 0.06 g (0.001 mol) of KF. To the mixture was then slowly added dropwise 15.1 g (0.86 mol) of water at room temperature with stirring. After dropwise addition, the mixture was stirred at room temperature for 3 hours, and then heated under reflux of methanol for 2 hours. Thereafter, the low boiling content was distilled off under reduced pressure. The residue was then filtered to obtain 120 g of a sol a-1. The material thus obtained was then subjected to GPC. As a result, it was found that the sol a-1 has a mass-average molecular weight of 1,500. The proportion of components having a molecular weight of from 1,000 to 20,000 in the oligomer components or high components was 30%.

The results of ¹H-NMR of the sol a-1 showed that the material thus obtained has a structure represented by the following general formula.

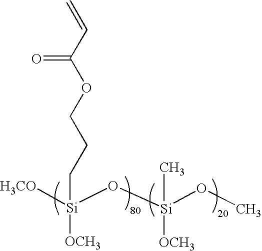

(The Ratio 80:20 is by Mol.)

Further, the condensation α determined by ²⁹Si-NMR was 0.56. The results of this analysis showed that the present silane coupling agent sol is mainly composed of a straight-chain structure moiety.

Moreover, the results of gas chromatography showed that the percent residue of acryloxypropyl trimethoxy silane as a raw material is 5% or less.

TABLE 11

| | | Hard coat layer | | | | Low refractive layer | | | | |
|---|---|---|---|---|---|---|---|---|---|---|
| | | | Polymerization | | | | Polymerization | | | |
| | Anti- | | initiator | | Short | | initiator | | Short | |
| | reflection | Coating | | Amount | wavelength | Coating | | Amount | wavelength | |
| | film sample | solution | | used^{*2} | cut filter | solution | | used | cut filter | |
| | No. | No. | Kind^{*1} | (parts by mass) | used? | No. | Kind^{*1} | (wt-%) | used? | Remarks |
| Comparative | 301 | HCL-2 | 907 | 5.0 | No | LLL-1 | 907 | 5.0 | No | |
| Example 3-1 | | | | | | | | | | |
| Example 3-1 | 302 | HCL-3 | 907 | 5.0 | Yes | LLL-1 | ″ | ″ | ″ | |
| | | | 819 | 5.0 | | | | | | |
| Comparative | 303 | HCL-4 | 907 | 2.5 | No | LLL-1 | ″ | ″ | ″ | |
| Example 3-2 | | | | | | | | | | |
| Comparative | 304 | HCL-5 | 907 | 10.0 | No | LLL-1 | ″ | ″ | ″ | |
| Example 3-3 | | | | | | | | | | |
| Comparative | 305 | HCL-2 | 907 | 5.0 | Yes | LLL-1 | ″ | ″ | ″ | Hard coat |
| Example 3-4 | | | | | | | | | | layer not |
| | | | | | | | | | | cured |
| Comparative | 306 | HCL-6 | 819 | 5.0 | Yes | LLL-1 | ″ | ″ | ″ | |
| Example 3-5 | | | | | | | | | | |
| Comparative | 307 | HCL-6 | 819 | 5.0 | No | LLL-1 | ″ | ″ | ″ | |
| Example 3-6 | | | | | | | | | | |
| Example 3-2 | 308 | HCL-3 | 907 | 5.0 | Yes | LLL-1 | ″ | ″ | ″ | |
| | | | 819 | 5.0 | | | | | | |
| Example 3-3 | 309 | HCL-7 | 907 | 5.0 | Yes | LLL-1 | ″ | ″ | ″ | |
| | | | 819 | 10.0 | | | | | | |
| Example 3-4 | 310 | HCL-8 | 907 | 1.0 | Yes | LLL-1 | ″ | ″ | ″ | |
| | | | 819 | 5.0 | | | | | | |
| Example 3-5 | 311 | HCL-9 | 907 | 2.5 | Yes | LLL-1 | 907 | 5.0 | No | |
| | | | 819 | 5.0 | | | | | | |
| Example 3-6 | 312 | HCL-10 | 907 | 10.0 | Yes | LLL-1 | ″ | ″ | ″ | |
| | | | 819 | 5.0 | | | | | | |
| Comparative | 313 | HCL-3 | 907 | 5.0 | No | LLL-1 | ″ | ″ | ″ | |
| Example 3-7 | | | 819 | 5.0 | | | | | | |
| Comparative | 314 | HCL-3 | 907 | 5.0 | Yes | LLL-1 | ″ | ″ | Yes | Low |
| Example 3-8 | | | 819 | 5.0 | | | | | | refractive |
| | | | | | | | | | | layer not |
| | | | | | | | | | | cured |
| Example 3-7 | 315 | HCL-11 | MP | 5.0 | Yes | LLL-1 | MP | ″ | No | |
| | | | 819 | 5.0 | | | | | | |
| Comparative | 316 | HCL-11 | MP | 5.0 | No | LLL-1 | ″ | ″ | ″ | |
| Example 3-9 | | | 819 | 5.0 | | | | | | |

Kind^{*1}: The term “907” indicates “Irgacure 907”. The term “819” indicates “Irgacure 819”. The term “MP” indicates “MP-Triazine” (produced by Sanwa Chemical Co., Ltd).
Amount used^{*2}: Based on 100 parts by mass of DPHA

The anti-reflection films thus prepared were each then evaluated in the same manner as in Example 1. The results are set forth in Table 12. As can be seen in the results of Table 12, the curing method of the invention makes it possible to obtain an excellent scratch resistance while maintaining the desired anti-reflection properties.

TABLE 12

| | Anti- | | | |
|---|---|---|---|---|
| | reflec- | | | |
| | tion | | | |
| | film | | | |
| | sample | % Average | | Steel wool |
| | No. | reflectance | Pencil hardness | resistance |
| Comparative | 301 | 1.9 | 2H˜3H | P |
| Example 3-1 | | | | |
| Example 3-1 | 302 | 1.9 | 3H | F˜G |
| Comparative | 303 | 1.9 | 2H˜3H | P |
| Example 3-2 | | | | |
| Comparative | 304 | 1.9 | 2H˜3H | P |
| Example 3-3 | | | | |
| Comparative | 305 | Nonevaluatable | Nonevaluatable | Nonevaluatable |
| Example 3-4 | | | | |
| Comparative | 306 | 1.9 | 2H˜3H | P |
| Example 3-5 | | | | |
| Comparative | 307 | 1.9 | 2H˜3H | P |
| Example 3-6 | | | | |
| Example 3-2 | 308 | 1.9 | 3H | F˜G |
| Example 3-3 | 309 | 1.9 | 3H | F˜G |
| Example 3-4 | 310 | 1.9 | 3H | F˜G |
| Example 3-5 | 311 | 1.9 | 3H | F˜G |
| Example 3-6 | 312 | 1.9 | 3H | F˜G |
| Comparative | 313 | 1.9 | 2H˜3H | P |
| Example 3-7 | | | | |
| Comparative | 314 | Nonevaluatable | Nonevaluatable | Nonevaluatable |
| Example 3-8 | | | | |
| Example 3-7 | 315 | 1.9 | 3H | G |
| Comparative | 316 | 1.9 | 2H˜3H | P |
| Example 3-9 | | | | |

### Example 4

[Preparation of Coating Solution for Low Refractive Layer]

Anti-reflection films were prepared in the same manner as in Examples 1 to 3 except that the coating solution for low refractive layer was replaced by the following coating solutions for low refractive layer (LLL-4) and (LLL-5), respectively. These anti-reflection films were each then evaluated. As a result, the same effect of the invention as exerted in Examples 1 to 3 were confirmed.

The use of a particulate hollow silica made it possible to prepare an anti-reflection film having an excellent scratch resistance and a low reflectance.

(Preparation of Sol a)

Into a reaction vessel equipped with an agitator and a reflux condenser were charged 120 parts by mass of methyl ethyl ketone, 100 parts by mass of acryloyl oxypropyl trimethoxysilane “KBM-5103” (produced by Shin-Etsu Chemical Co., Ltd.) and 3 parts by mass of diisopropoxy aluminum ethyl acetoacetate (trade name: Kelope EP-12, produced by Hope Chemical Co., Ltd.). The mixture was then stirred. To the mixture were then added 30 parts by mass of deionized water. The reaction mixture was allowed to undergo reaction at 60° C. for 4 hours, and then allowed to cool to room temperature to obtain a sol a. The compound thus obtained had a mass-average molecular weight of 1,600. The proportion of components having a molecular weight of from 1,000 to 20,000 in the oligomer components or high components was 100%. The gas chromatography of the reaction product showed that none of the acryloyloxy propyl trimethoxysilane as raw material remained.

(Preparation of Fine Dispersion of Hollow Silica)

To 500 parts by mass of a hollow silica dispersion a {particle size: approx. 40 to 50 nm; shell thickness: 6 to 8 nm; refractive index: 1.31; solid concentration: 20%; main solvent: isopropyl alcohol; prepared according to Preparation Example 4 of JP-A-2002-79616 except that the particle size was varied} were added 30 parts by mass of acryloyloxy propyl trimethoxysilane “KBM-5103” {produced by Shin-Etsu Chemical Co., Ltd.} and 1.5 parts by mass of diisopropoxy aluminum ethyl acetoacetate (trade name: Kelope EP-12, produced by Hope Chemical Co., Ltd.). The mixture was then stirred. To the mixture were then added 9 parts by mass of deionized water. The reaction mixture was allowed to undergo reaction at 60° C. for 8 hours, and then allowed to cool to room temperature. To the mixture were then added 1.8 parts by mass of acetyl acetone to obtain a dispersion. The resulting hollow silica dispersion had a solid concentration of 18% by mass and a refractive index of 1.31 after dried remove solvent.

{Preparation of coating solution for low refractive layer (LLL-4)}

| | |
|---|---|
| “DPHA” | 3.3 parts by mass |
| Fine dispersion of hollow silica | 40.0 parts by mass |
| “RMS-033” | 0.7 parts by mass |
| “Irgacure 907” | 0.2 parts by mass |
| Sol a | 6.2 parts by mass |
| Methyl ethyl ketone | 290.6 parts by mass |
| Cyclohexanone | 9.0 parts by mass |

{Preparation of coating solution for low refractive layer (LLL-5)}

| | |
|---|---|
| “DPHA” | 1.4 parts by mass |
| Copolymer P-3 | 5.6 parts by mass |
| Fine dispersion of hollow silica | 20.0 parts by mass |
| “RMS-033” | 0.7 parts by mass |
| “Irgacure 907” | 0.2 parts by mass |
| Sol a | 6.2 parts by mass |
| Methyl ethyl ketone | 306.9 parts by mass |
| Cyclohexanone | 9.0 parts by mass |

The compounds used above will be further described hereinafter.

“KBM-5103”: Silane coupling agent (produced by Shin-Etsu Chemical Co., Ltd.)

“DPHA”: Mixture of dipentaerythritol pentaacrylate and dipentaerythritol hexaacrylate (produced by NIPPON KAYAKU CO., LTD.)

“RMS-033”: Reactive silicone (produced by Gelest Inc.)

“Irgacure 907”: Photopoloymerization initiator (produced by Ciba Specialty Chemicals Co., Ltd.)

### Example 5

<Preparation of Protective Film for Polarizing Plate>

A 1.5 mol/l aqueous solution of sodium hydroxide was kept at 50° C. to prepare a saponifying solution. Further, a 0.005 mol/l diluted aqueous solution of sulfuric acid was prepared.

The anti-reflection films prepared in Examples 1 to 4 were each subjected to saponification on the surface of the transparent substrate opposite the anti-reflection film of the invention with the aforementioned saponifying solution. Subsequently, the saponified surface of the transparent substrate was thoroughly washed with water to remove the aqueous solution of sodium hydroxide, washed with the aforementioned diluted aqueous solution of sulfuric acid, thoroughly washed with water to remove the diluted aqueous solution of sulfuric acid, and then thoroughly dried at 100° C.

The saponfied transparent substrate was then evaluated for contact angle with respect to water on the side thereof opposite the anti-reflection layer of the anti-reflection film. The result was 40° or less. In this manner, a protective film for polarizing plate with an anti-reflection layer was prepared.

### Example 15

<Preparation of Polarizing Plate>

[Preparation of Polarizing Layer]

A polyvinyl alcohol film having a thickness of 75 μm (produced by Kuraray Co., Ltd.) was dipped in an aqueous solution composed of 1,000 parts by mass of water, 7 parts by mass of iodine and 105 parts by mass of potassium iodide for 5 minutes so that iodine was adsorbed thereto. Subsequently, this film was monoaxially stretched longitudinally by a factor of 4.4 in a 4 wt-% aqueous solution of aqueous solution of boric acid, and then dried under tension to prepare a polarizing layer.

[Preparation of Polarizing Plate]

The saponified triacetyl cellulose surface of an anti-reflection film (protective film for polarizing plate) of the invention was stuck to one side of the polarizing layer with a polyvinyl alcohol-based adhesive as an adhesive. Further, another saponified triacetyl cellulose film was stuck to the other side of the polarizing layer as a protective film with the same polyvinyl alcohol-based adhesive as mentioned above.

### Example 25

[Preparation and Evaluation of Image Display Device]

TN, STN, IPS, VA and OCB mode transmission type, reflection type and semi-transmission type liquid crystal display devices comprising the polarizing plate thus prepared mounted in such an arrangement that the anti-reflection film is disposed as an outermost surface of display exhibited excellent anti-reflection properties and an extremely excellent viewability. This effect was remarkable particularly in VA mode.

### Example 6

[Preparation of Polarizing Plate]

An optical compensation film having an optical compensation layer “Wide View Film SA 12B” (produced by Fuji Photo Film Co., Ltd.) was saponified on the side thereof opposite the optical compensation layer in the same manner as in Example 5.

The saponified triacetyl cellulose surface of the anti-reflection films (protective film for polarizing plate) prepared in Examples 1 to 4 were each stuck to one side of the polarizing layer prepared in Example 15 with a polyvinyl alcohol-based adhesive as an adhesive. Further, the triacetyl cellulose surface of the saponfied optical compensation film was stuck to the other side of the polarizing layer with the same polyvinyl alcohol-based adhesive as mentioned above.

### Example 16

<Preparation and Evaluation of Image Display Device>

TN, STN, IPS, VA and OCB mode transmission type, reflection type and semi-transmission type liquid crystal display devices comprising the polarizing plate thus prepared mounted in such an arrangement that the anti-reflection film is disposed as an outermost surface of display exhibited an excellent contrast in the daylight, very wide horizontal and vertical viewing angles, excellent anti-reflection properties and an extremely excellent viewability and display quality as compared with liquid crystal display devices comprising a polarizing plate free of optical compensation film mounted thereon.

This effect was remarkable particularly in VA mode.

### Examples 7-1 to 7-3 and Reference Examples 7-1 to 7-2

[Preparation of Anti-Reflection Film]

An anti-reflection film (701) was prepared in the same manner as in the anti-reflection film (102) of Example 1-1 except for the following procedures. In some detail, the low refractive layer coating solution (LLL-1) was replaced by the following low refractive layer coating solution (LLL-6). The low refractive layer coating solution (LLL-6) was spread at a rate of 25 m/sec using the following die coater (slot die). Subsequently, coat layer was dried at 90° C. for 30 seconds, and then cured by irradiating with ultraviolet rays at an illuminance of 600 mW/cm² and a dose of 400 mJ/cm² using a 240 W/cm air-cooled metal halide lamp (produced by EYE GRAPHICS CO., LTD.) while the air in the system was being purged with nitrogen such that the oxygen concentration of the atmosphere reached 0.1 vol-% or less to form a low refractive layer (refractive index: 1.45; layer thickness: 83 nm). Anti-reflection films (702) to (705) were prepared in the same manner as mentioned above except that the low refractive layer coating solution (LLL-1) was replaced by the following low refractive layer coating solutions (LLL-7) to (LLL-10), respectively.

[Configuration of Die Coater]

As die coaters there may be used those having configurations shown in FIGS. 2, 3A, 4 and 5. As the slot die 13 there was used one having an upstream lip land length I_{UP} of 0.5 mm, a downstream lip land length I_{LO} of 50 μm, a slot 16 opening length of 150 μm in the web running direction and a slot 16 length of 50 mm. The gap between the upstream lip land 18a and the web W was predetermined to be 50 μm longer than the gap between the downstream lip land 18b and the web 12 (hereinafter referred to as “overbite length of 50 μm”) and the gap G_{L} between the downstream lip land 18b and the web W was predetermined to be 50 μm. The gap G_{S} between the side plate 40b of the pressure reducing chamber 40 and the gap G_{B} between the back plate 40a and the web W were each predetermined to be 200 μm.

[Preparation of Coating Solution for Low Refractive Layer (LLL-6)]

152.4 parts by mass of a solution obtained by dissolving the following fluorine-based copolymer FP-1 in methyl ethyl ketone in an amount such that a concentration of 23.7% by mass was reached, 1.1 parts by mass of a methacrylate group-terminated silicone resin “X-22-164C” {produced by Shin-Etsu Chemical Co., Ltd.}, 1.8 parts by mass of a photopolymerization initiator “Irgacure 907” (trade name), 815.9 parts by mass of methyl ethyl ketone and 28.8 parts by mass of cyclohexanone were mixed with stirring. The mixture was then filtered through a polytetrafluoroethylne (PTFE) filter having a pore diameter of 0.45 μm to prepare a coating solution for low refractive layer (LLL-6). The coating solution thus prepared exhibited a viscosity of 0.61 mPa·sec and a surface tension of 24 mN/m. The spread of the coating solution over the transparent substrate was 2.8 ml/m². 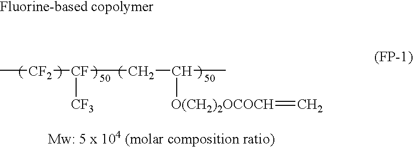
[Preparation of Coating Solution for Low Refractive Layer (LLL-7)]

426.6 parts by mass of a solution obtained by dissolving the aforementioned fluorine-based copolymer FP-1 in methyl ethyl ketone in an amount such that a concentration of 23.7% by mass was reached, 3.0 parts by mass of a methacrylate group-terminated silicone resin “X-22-164C” {produced by Shin-Etsu Chemical Co., Ltd.}, 5.1 parts by mass of a photopolymerization initiator “Irgacure 907” (trade name), 538.6 parts by mass of methyl ethyl ketone and 26.7 parts by mass of cyclohexanone were mixed with stirring. The mixture was then filtered through a PTFE filter having a pore diameter of 0.45 μm to prepare a coating solution for low refractive layer (LLL-7). The coating solution thus prepared exhibited a viscosity of 1.0 mPa·sec and a surface tension of 24 mN/m. The spread of the coating solution over the transparent substrate was 1.5 ml/m².

[Preparation of Coating Solution for Low Refractive Layer (LLL-8)]

213.3 parts by mass of a solution obtained by dissolving the aforementioned fluorine-based copolymer FP-1 in methyl ethyl ketone in an amount such that a concentration of 23.7% by mass was reached, 1.5 parts by mass of a methacrylate group-terminated silicone resin “X-22-164C” {produced by Shin-Etsu Chemical Co., Ltd.}, 2.5 parts by mass of a photopolymerization initiator “Irgacure 907” (trade name), 754.3 parts by mass of methyl ethyl ketone and 28.4 parts by mass of cyclohexanone were mixed with stirring. The mixture was then filtered through a PTFE filter having a pore diameter of 0.45 μm to prepare a coating solution for low refractive layer (LLL-8). The coating solution thus prepared exhibited a viscosity of 0.76 mPa·sec and a surface tension of 24 mN/m. The spread of the coating solution over the transparent substrate was 2.0 ml/m².

[Preparation of Coating Solution for Low Refractive Layer (LLL-9)]

85.3 parts by mass of a solution obtained by dissolving the aforementioned fluorine-based copolymer FP-1 in methyl ethyl ketone in an amount such that a concentration of 23.7% by mass was reached, 0.6 parts by mass of a methacrylate group-terminated silicone resin “X-22-164C” {produced by Shin-Etsu Chemical Co., Ltd.}, 1.0 parts by mass of a photopolymerization initiator “Irgacure 907” (trade name), 883.7 parts by mass of methyl ethyl ketone and 29.3 parts by mass of cyclohexanone were mixed with stirring. The mixture was then filtered through a PTFE filter having a pore diameter of 0.45 μm to prepare a coating solution for low refractive layer (LLL-9). The coating solution thus prepared exhibited a viscosity of 0.49 mPa·sec and a surface tension of 24 mN/m. The spread of the coating solution over the transparent substrate was 5.0 ml/m².

[Preparation of Coating Solution for Low Refractive Layer (LLL-10)]

71.1 parts by mass of a solution obtained by dissolving the aforementioned fluorine-based copolymer FP-1 in methyl ethyl ketone in an amount such that a concentration of 23.7% by mass was reached, 0.5 parts by mass of a methacrylate group-terminated silicone resin “X-22-164C” {produced by Shin-Etsu Chemical Co., Ltd.}, 0.8 parts by mass of a photopolymerization initiator “Irgacure 907” (trade name), 898.1 parts by mass of methyl ethyl ketone and 29.5 parts by mass of cyclohexanone were mixed with stirring. The mixture was then filtered through a PTFE filter having a pore diameter of 0.45 μm to prepare a coating solution for low refractive layer (LLL-10). The coating solution thus prepared exhibited a viscosity of 0.46 mPa·sec and a surface tension of 24 mN/m. The spread of the coating solution over the transparent substrate was 6.0 ml/m².

[Evaluation of Anti-Reflection Films (701) to (705)]

The anti-reflection films (701) to (705) thus obtained were each then evaluated for spread condition by coating conditions of die coater during the spreading of the low refractive layer coating solution and surface condition. These anti-reflection films were also measured for average reflectance in the same manner as in Example 1. The results are set forth in Table 13 below.

(Surface Condition)

The back surface of the film having all the layers formed thereon was painted black with magic black ink on an area of 1 m². The black-painted surface of the film was then visually evaluated for uniformity in density.

G (good): No remarkable difference in density

P (poor): Remarkable difference in density

TABLE 13

| | | | Middle | High | | | | | | | | |
|---|---|---|---|---|---|---|---|---|---|---|---|---|
| | | Hard | re- | re- | | | | | | | | |
| | Anti- | coat | fractive | fractive | | | | | | | | |
| | reflection | layer | layer | layer | Low refractive layer | | | | Anti-reflection film | | | |
| | film | coating | coating | coating | Coating | Viscosity | | Spread condition | | % | | Steel |
| | sample | solution | solution | solution | solution | (mPa · | Spread | of coating | Surface | Average | Pencil | wool |
| | No. | No. | No. | No. | No. | sec) | (ml/m²) | solution | condition | reflectance | hardness | resistance |
| Example | 701 | HCL-1 | MLL-1 | HLL-2 | LLL-6 | 0.61 | 2.8 | G | G | 0.32 | 3H | F˜G |
| 7-1 | | | | | | | | | | | | |
| Reference | 702 | HCL-1 | MLL-1 | HLL-2 | LLL-7 | 1.00 | 1.5 | P | P | * | 3H | F˜G |
| Example | | | | | | | | | | | | |
| 7-1 | | | | | | | | | | | | |
| Example | 703 | HCL-1 | MLL-1 | HLL-2 | LLL-8 | 0.76 | 2.0 | G | G | 0.32 | 3H | F˜G |
| 7-2 | | | | | | | | | | | | |
| Example | 704 | HCL-1 | MLL-1 | HLL-2 | LLL-9 | 0.49 | 5.0 | G | G | 0.32 | 3H | F˜G |
| 7-3 | | | | | | | | | | | | |
| Reference | 705 | HCL-1 | MLL-1 | HLL-2 | LLL-10 | 0.46 | 6.0 | G | P | * | 3H | F˜G |
| Example | | | | | | | | | | | | |
| 7-2 | | | | | | | | | | | | |

As can be seen in the results of Table 13, the anti-reflection films (701) to (705) each are excellent in scratch resistance. The anti-reflection films (701), (703) and (704), which had been obtained by spreading the coating solution over the transparent substrate in an amount of 2 ml/m² or more, showed a good uniformity in spread of coating solution (evaluated as G in the spread condition and surface condition in Table 13). Referring to the anti-reflection film (702), which had been obtained by spreading the coating solution over the transparent substrate in an amount of 1.5 ml/m², the coating solution could not be uniformly spread all over the surface of the transparent substrate. Thus, there occurred a great dispersion of spread from point of measurement to point of measurement, making it impossible to calculate the average reflectance (evaluated as P in the spread condition and surface condition and as * in the average reflectance in Table 13). Referring to the anti-reflection film (705), which had been obtained by spreading the coating solution over the transparent substrate in an amount of 6 ml/m², the coating solution could be uniformly spread all over the surface of the transparent substrate. However, since the amount of the coating solution was too much, the coat layer could not be fully dried, causing the occurrence of longitudinal streak-like unevenness due to wind and hence great dispersion of spread from point of measurement to point of measurement and thus making it impossible to calculate the average reflectance (evaluated as G in the spread condition, as P in the surface condition and as * in the average reflectance in Table 13).

### Examples 17-1 to 17-3

<Preparation of Protective Film for Polarizing Plate with Anti-Reflection Layer and Polarizing Plate and Preparation and Evaluation of Image Display Device>

The anti-reflection films (701), (703) and (704) thus obtained were each then used to prepare protective films for polarizing plate with anti-reflection layer in the same manner as in Example 5. These protective films were each then used to prepare polarizing plates with anti-reflection layer in the same manner as in Example 15. Further, display devices were prepared in the same manner as in Example 25. As a result, the display devices thus prepared exhibited less color unevenness and hence a higher image quality than the display device of Example 25 prepared using a gravure coater, e.g., display device comprising a polarizing plate with anti-reflection layer having the anti-reflection film (102).

### Examples 7-4 to 7-6 and Reference Examples 7-3 to 7-4

Anti-reflection films (706) to (709) were prepared in the same manner as in the anti-reflection film (701) of Example 7 except that the downstream lip land length I_{LO} was 10 μm, 30 μm, 70 μm, 100 μm and 120 μm, respectively. The anti-reflection films (706) to (710) thus obtained were each then evaluated in the same manner as in the anti-reflection film (701). The results are set forth in Table 14.

TABLE 14

| | | Hard | Middle | High | | | | | | | |
|---|---|---|---|---|---|---|---|---|---|---|---|
| | | coat | refractive | refractive | | | | | | | |
| | Anti- | layer | layer | layer | low refractive layer | | | Anti-reflection film | | | |
| | reflection | coating | coating | coating | Coating | Downstream lip | Overbite | | | | Steel |
| | film | solution | solution | solution | solution | land length | length | Surface | % Average | Pencil | wool |
| | sample No. | No. | No. | No. | No. | I_{LO} (μm) | LO (μm) | condition | reflectance | hardness | resistance |
| Example | 701 | HCL-1 | MLL-1 | HLL-2 | LLL-6 | 50 | 50 | G | 0.32 | 3H | F˜G |
| 7-1 | | | | | | | | | | | |
| Reference | 706 | HCL-1 | MLL-1 | HLL-2 | LLL-6 | 10 | 50 | P | * | 3H | F˜G |
| Example | | | | | | | | | | | |
| 7-3 | | | | | | | | | | | |
| Example | 707 | HCL-1 | MLL-1 | HLL-2 | LLL-6 | 30 | 50 | G | 0.32 | 3H | F˜G |
| 7-4 | | | | | | | | | | | |
| Example | 708 | HCL-1 | MLL-1 | HLL-2 | LLL-6 | 70 | 50 | G | 0.32 | 3H | F˜G |
| 7-5 | | | | | | | | | | | |
| Example | 709 | HCL-1 | MLL-1 | HLL-2 | LLL-6 | 100 | 50 | G | 0.32 | 3H | F˜G |
| 7-6 | | | | | | | | | | | |
| Reference | 710 | HCL-1 | MLL-1 | HLL-2 | LLL-6 | 120 | 50 | P | * | 3H | F˜G |
| Example | | | | | | | | | | | |
| 7-4 | | | | | | | | | | | |

As can be seen in the results of Table 14, the anti-reflection films (706) to (710) each are excellent in scratch resistance. When the downstream lip lap length was from 30 μm to 100 μm, anti-reflection films (707) to (709) free from surface condition defects were obtained. The anti-reflection film (706) showed some streak-like unevenness in the base longitudinal direction and hence a great dispersion of spread from point of measurement to point of measurement, making it impossible to calculate the average reflectance. Referring to the anti-reflection film (710), when spreading was effected at the same speed as in the anti-reflection film (706), the coating solution 14 could not form a bead 14a as shown in FIG. 3A and thus could not be spread. When the coating speed was halved (to 12.5 m/min), the coating solution could be spread. However, there occurred some streak-like unevenness in the base longitudinal direction and hence a great dispersion of spread from point of measurement to point of measurement, making it impossible to calculate the average reflectance.

### Examples 17-4 to 17-6

<Preparation of Protective Film for Polarizing Plate with Anti-Reflection Layer and Polarizing Plate and Preparation and Evaluation of Image Display Device>

The anti-reflection films (707), (708) and (709) thus obtained were each then used to prepare protective films for polarizing plate with anti-reflection layer in the same manner as in Example 5. These protective films were each then used to prepare polarizing plates with anti-reflection layer in the same manner as in Example 15. Further, display devices were prepared in the same manner as in Example 25. As a result, display devices having a very high display quality with extremely little reflection of background, remarkably reduced tint of reflected light and assured uniformity in surface condition were obtained.

### Examples 7-7 to 7-9 and Reference Examples 7-5 to 7-6

Anti-reflection films (711) to (715) were prepared in the same manner as in the anti-reflection film (701) of Example 7 except that the die coater overbite length LO was 0 μm, 30 μm, 70 μm, 120 μm and 150 μm, respectively. The anti-reflection films (711) to (715) thus obtained were each then evaluated in the same manner as in the anti-reflection film (701). The results are set forth in Table 15.

TABLE 15

| | | Hard | Middle | High | | | | | | | |
|---|---|---|---|---|---|---|---|---|---|---|---|
| | | coat | refractive | refractive | | | | | | | |
| | Anti- | layer | layer | layer | low refractive layer | | | Anti-reflection film | | | |
| | reflection | coating | coating | coating | Coating | Downstream lip | Overbite | | | | Steel |
| | film | solution | solution | solution | solution | land length | length | Surface | % Average | Pencil | wool |
| | sample No. | No. | No. | No. | No. | I_{LO} (μm) | LO (μm) | condition | reflectance | hardness | resistance |
| Example | 701 | HCL-1 | MLL-1 | HLL-2 | LLL-6 | 50 | 50 | G | 0.32 | 3H | F˜G |
| 7-1 | | | | | | | | | | | |
| Reference | 711 | HCL-1 | MLL-1 | HLL-2 | LLL-6 | 50 | 0 | P | * | 3H | F˜G |
| Example | | | | | | | | | | | |
| 7-5 | | | | | | | | | | | |
| Example | 712 | HCL-1 | MLL-1 | HLL-2 | LLL-6 | 50 | 30 | G | 0.32 | 3H | F˜G |
| 7-7 | | | | | | | | | | | |
| Example | 713 | HCL-1 | MLL-1 | HLL-2 | LLL-6 | 50 | 70 | G | 0.32 | 3H | F˜G |
| 7-8 | | | | | | | | | | | |
| Example | 714 | HCL-1 | MLL-1 | HLL-2 | LLL-6 | 50 | 120 | G | 0.32 | 3H | F˜G |
| 7-9 | | | | | | | | | | | |
| Reference | 715 | HCL-1 | MLL-1 | HLL-2 | LLL-6 | 50 | 150 | P | * | 3H | F˜G |
| Example | | | | | | | | | | | |
| 7-6 | | | | | | | | | | | |

As can be seen in the results of Table 15, the anti-reflection films (711) to (715) each are excellent in scratch resistance. When the overbite length LO was from 30 μm to 120 μm, anti-reflection films (712) to (714) free from surface condition defects were obtained. Referring to the anti-reflection film (711), the coating solution could be spread. However, when the surface condition of the anti-reflection film (711) was observed, some stepwise unevenness was recognized in the base crosswise direction, causing the occurrence of a great dispersion of spread from point of measurement to point of measurement and hence making it impossible to calculate the average reflectance. Referring to the anti-reflection film (715), when spreading was effected at the same speed as in the anti-reflection film (701), the coating solution 14 could not form a bead 14a as shown in FIG. 3A and thus could not be spread. When the coating speed was halved (to 12.5 m/min), the coating solution could be spread. However, there occurred some streak-like unevenness in the base longitudinal direction and hence a great dispersion of spread from point of measurement to point of measurement, making it impossible to calculate the average reflectance.

### Examples 17-7 to 17-9

<Preparation of Protective Film for Polarizing Plate with Anti-Reflection Layer and Polarizing Plate and Preparation and Evaluation of Image Display Device>

The anti-reflection films (712), (713) and (714) thus obtained were each then used to prepare protective films for polarizing plate with anti-reflection layer in the same manner as in Example 5. These protective films were each then used to prepare polarizing plates with anti-reflection layer in the same manner as in Example 15. Further, display devices were prepared in the same manner as in Example 25. As a result, display devices having a very high display quality with extremely little reflection of background, remarkably reduced tint of reflected light and assured uniformity in surface condition were obtained.

### INDUSTRIAL APPLICABILITY

An image display device comprising an anti-reflection film produced according to the invention which is an optical film or a polarizing plate comprising the anti-reflection film as one of protective films therefor shows little reflection of external light or background and thus exhibits an extremely high viewability and scratch resistance.

The entire disclosure of each and every foreign patent application from which the benefit of foreign priority has been claimed in the present application is incorporated herein by reference, as if fully set forth.

1. A method of producing an optical film comprising at least two ionizing radiation-curing layers on a transparent substrate, the method comprising:
Step 1 of irradiating a layer A, which comprises two or more kinds of polymerization initiators having different absorption ends at a longer wavelength side in wavelength range of sensitivity to which they are sensitive, with an ionizing radiation having a wavelength to which at least one kind (a) of the polymerization initiators is not substantially sensitive and at least one kind (b) of the polymerization initiators is sensitive; and
Step 2 of spreading a coating solution for layer B comprising at least one polymerization initiator (c) over the layer A after Step A and then irradiating the coating solution for layer B with an ionizing radiation having a wavelength to which the polymerization initiators (a) and (c) are sensitive.

2. The method of producing an optical film as defined in claim 1,
wherein the irradiation with ionizing radiation at Steps 1 and 2 is effected in an oxygen concentration of 3% by volume or less.

3. The method of producing an optical film as defined in claim 1,
wherein the irradiation with ionizing radiation at Step 2 is effected in an oxygen concentration of 3% by volume or less at a membrane surface temperature of 60° C. or more.

4. The method of producing an optical film as defined in claim 1,
wherein the irradiation with ionizing radiation of the Step 2 is effected in an oxygen concentration of 3% by volume or less, and simultaneously or continuously, heating is performed at in an oxygen concentration of 3% by volume or less.

5. The method of producing an optical film which is an anti-reflection film comprising at least one low refractive layer, as defined in claim 1,
wherein the layer B is one of said at least one low refractive layer.

6. An optical film obtainable by a method defined in claim 1.

7. An anti-reflection film which is the optical film defined in claim 6

8. A polarizing plate comprising two protective films,
wherein one of the two protective films is an anti-reflection film defined in claim 7.

9. An image display device comprising an anti-reflection film defined in claim 7 as an outermost surface of display.

10. An image display device comprising a polarizing plate defined in claim 8 as an outermost surface of display.
